(19) United States
(12) Patent Application Publication
(10) Pub. No.: US 2026/0220241 A1
(43) Pub. Date: Jul. 30, 2026

(54) TECHNIQUES FOR AUTHENTICATION

(71) Applicant: Apple Inc., Cupertino, CA (US)

(72) Inventors: Vincenzo O. GIULIANI, Thousand Oaks, CA (US); Joshua D. DEITEL, San Francisco, CA (US); Mischa K. MCLACHLAN, San Francisco, CA (US); Sung Min K. ARENA, Mill Valley, CA (US); William N. DANNER, Santa Cruz, CA (US)

(21) Appl. No.: 19/462,382

(22) Filed: Jan. 28, 2026

Related U.S. Application Data
(60) Provisional application No. 63/751,254, filed on Jan. 29, 2025.
(60) Provisional application No. 63/754,561, filed on Feb. 6, 2025.
(60) Provisional application No. 63/969,921, filed on Jan. 28, 2026.

(51) Int. Cl. G06F 21/32; G10L 15/22

(52) U.S. Cl. CPC G06F 21/32; G10L 15/22

(57) ABSTRACT

The present disclosure generally relates to authenticating subjects Some techniques are for outputting a tone based on authentication in accordance with some embodiments. Other techniques are for sending reminders based on time in accordance with some embodiments. Other techniques are for outputting a request based on subjects in environment in accordance with some embodiments. Other techniques are for displaying a control based on a subject in accordance with some embodiments. Other techniques are for identifying a subject based on one or more characteristics in accordance with some embodiments. Other techniques are for outputting audio in accordance with some embodiments. Other techniques are for assisting with authentication in accordance with some embodiments. Other techniques are for outputting a request to authenticate in accordance with some embodiments.

### CROSS-REFERENCE TO RELATED APPLICATIONS

This application claims priority to U.S. Provisional Patent Application No. 63/969,921, entitled “Techniques for Authentication,” filed Jan. 28, 2026, to U.S. Provisional Patent Application No. 63/754,561, entitled “Techniques for Authentication,” filed Feb. 6, 2025, and to U.S. Provisional Patent Application No. 63/751,254, entitled “Techniques for Authentication,” filed Jan. 29, 2025. The content of these applications is hereby incorporated by reference in their entirety.

### BACKGROUND

Computer systems are often used to authenticate individuals. Such authentications can be performed in a variety of ways. A computer system can perform a number of operations based on a successful authentication of an individual.

### SUMMARY

Existing techniques for authenticating subjects are generally cumbersome and inefficient. For example, some existing techniques use a complex and time-consuming user interface, which may include multiple key presses or keystrokes. Some existing techniques require more time than necessary, wasting user time and device energy. This latter consideration is particularly important in battery-operated devices.

Accordingly, the present technique provides electronic devices with faster, more efficient processes and interfaces for authenticating subjects. Such processes and interfaces optionally complement or replace other processes for authenticating subjects. Such processes and interfaces reduce the cognitive burden on a user and produce a more efficient human-machine interface. For battery-operated computing devices, such processes and interfaces conserve power and increase the time between battery charges.

In some embodiments, a method that is performed at a computer system that is in communication with one or more output devices is described. In some embodiments, the method comprises: detecting an identity of a subject; and in response to detecting the identity of the subject: in accordance with a determination that the subject is not automatically authenticated: outputting, via the one or more output devices, an indication corresponding to the identity of the subject; and outputting, via the one or more output devices, a request to authenticate the subject; and in accordance with a determination that that the subject is automatically authenticated, outputting, via the one or more output devices, an identification of the identity of the subject without outputting the request to authenticate the subject.

In some embodiments, a non-transitory computer-readable storage medium storing one or more programs configured to be executed by one or more processors of a computer system that is in communication with one or more output devices is described. In some embodiments, the one or more programs includes instructions for: detecting an identity of a subject; and in response to detecting the identity of the subject: in accordance with a determination that the subject is not automatically authenticated: outputting, via the one or more output devices, an indication corresponding to the identity of the subject; and outputting, via the one or more output devices, a request to authenticate the subject; and in accordance with a determination that that the subject is automatically authenticated, outputting, via the one or more output devices, an identification of the identity of the subject without outputting the request to authenticate the subject.

In some embodiments, a transitory computer-readable storage medium storing one or more programs configured to be executed by one or more processors of a computer system that is in communication with one or more output devices is described. In some embodiments, the one or more programs includes instructions for: detecting an identity of a subject; and in response to detecting the identity of the subject: in accordance with a determination that the subject is not automatically authenticated: outputting, via the one or more output devices, an indication corresponding to the identity of the subject; and outputting, via the one or more output devices, a request to authenticate the subject; and in accordance with a determination that that the subject is automatically authenticated, outputting, via the one or more output devices, an identification of the identity of the subject without outputting the request to authenticate the subject.

In some embodiments, a computer system configured to communicate with one or more output devices is described. In some embodiments, the computer system comprises one or more processors and memory storing one or more programs configured to be executed by the one or more processors. In some embodiments, the one or more programs includes instructions for: detecting an identity of a subject; and in response to detecting the identity of the subject: in accordance with a determination that the subject is not automatically authenticated: outputting, via the one or more output devices, an indication corresponding to the identity of the subject; and outputting, via the one or more output devices, a request to authenticate the subject; and in accordance with a determination that that the subject is automatically authenticated, outputting, via the one or more output devices, an identification of the identity of the subject without outputting the request to authenticate the subject.

In some embodiments, a computer system configured to communicate with one or more output devices is described. In some embodiments, the computer system comprises means for performing each of the following steps: detecting an identity of a subject; and in response to detecting the identity of the subject: in accordance with a determination that the subject is not automatically authenticated: outputting, via the one or more output devices, an indication corresponding to the identity of the subject; and outputting, via the one or more output devices, a request to authenticate the subject; and in accordance with a determination that that the subject is automatically authenticated, outputting, via the one or more output devices, an identification of the identity of the subject without outputting the request to authenticate the subject.

In some embodiments, a computer program product is described. In some embodiments, the computer program product comprises one or more programs configured to be executed by one or more processors of a computer system that is in communication with one or more output devices. In some embodiments, the one or more programs include instructions for: detecting an identity of a subject; and in response to detecting the identity of the subject: in accordance with a determination that the subject is not automatically authenticated: outputting, via the one or more output devices, an indication corresponding to the identity of the subject; and outputting, via the one or more output devices, a request to authenticate the subject; and in accordance with a determination that that the subject is automatically authenticated, outputting, via the one or more output devices, an identification of the identity of the subject without outputting the request to authenticate the subject.

In some embodiments, a method that is performed at a first computer system that is in communication with one or more display components and one or more input devices is described. In some embodiments, the method comprises: detecting a subject in an environment; and in response to detecting the subject in the environment: in accordance with a determination that the subject is not recognized, displaying, via the one or more display components, a control for initiating a communication with another computer system; and in accordance with a determination that the subject is recognized, forgoing display of, via the one or more display components, the control for initiating a communication with another computer system; while displaying the control for initiating a communication with another computer system, detecting, via the one or more input devices, an input corresponding to the control for initiating a communication with another computer system; and in response to detecting the input corresponding to the control for initiating a communication with another computer system, sending, to a second computer system external to the first computer system, a request to initiate the communication, wherein the second computer system is different from the first computer system.

In some embodiments, a non-transitory computer-readable storage medium storing one or more programs configured to be executed by one or more processors of a first computer system that is in communication with one or more display components and one or more input devices is described. In some embodiments, the one or more programs includes instructions for: detecting a subject in an environment; and in response to detecting the subject in the environment: in accordance with a determination that the subject is not recognized, displaying, via the one or more display components, a control for initiating a communication with another computer system; and in accordance with a determination that the subject is recognized, forgoing display of, via the one or more display components, the control for initiating a communication with another computer system; while displaying the control for initiating a communication with another computer system, detecting, via the one or more input devices, an input corresponding to the control for initiating a communication with another computer system; and in response to detecting the input corresponding to the control for initiating a communication with another computer system, sending, to a second computer system external to the first computer system, a request to initiate the communication, wherein the second computer system is different from the first computer system.

In some embodiments, a transitory computer-readable storage medium storing one or more programs configured to be executed by one or more processors of a first computer system that is in communication with one or more display components and one or more input devices is described. In some embodiments, the one or more programs includes instructions for: detecting a subject in an environment; and in response to detecting the subject in the environment: in accordance with a determination that the subject is not recognized, displaying, via the one or more display components, a control for initiating a communication with another computer system; and in accordance with a determination that the subject is recognized, forgoing display of, via the one or more display components, the control for initiating a communication with another computer system; while displaying the control for initiating a communication with another computer system, detecting, via the one or more input devices, an input corresponding to the control for initiating a communication with another computer system; and in response to detecting the input corresponding to the control for initiating a communication with another computer system, sending, to a second computer system external to the first computer system, a request to initiate the communication, wherein the second computer system is different from the first computer system.

In some embodiments, a first computer system configured to communicate with one or more display components and one or more input devices is described. In some embodiments, the first computer system comprises one or more processors and memory storing one or more programs configured to be executed by the one or more processors. In some embodiments, the one or more programs includes instructions for: detecting a subject in an environment; and in response to detecting the subject in the environment: in accordance with a determination that the subject is not recognized, displaying, via the one or more display components, a control for initiating a communication with another computer system; and in accordance with a determination that the subject is recognized, forgoing display of, via the one or more display components, the control for initiating a communication with another computer system; while displaying the control for initiating a communication with another computer system, detecting, via the one or more input devices, an input corresponding to the control for initiating a communication with another computer system; and in response to detecting the input corresponding to the control for initiating a communication with another computer system, sending, to a second computer system external to the first computer system, a request to initiate the communication, wherein the second computer system is different from the first computer system.

In some embodiments, a first computer system configured to communicate with one or more display components and one or more input devices is described. In some embodiments, the first computer system comprises means for performing each of the following steps: detecting a subject in an environment; and in response to detecting the subject in the environment: in accordance with a determination that the subject is not recognized, displaying, via the one or more display components, a control for initiating a communication with another computer system; and in accordance with a determination that the subject is recognized, forgoing display of, via the one or more display components, the control for initiating a communication with another computer system; while displaying the control for initiating a communication with another computer system, detecting, via the one or more input devices, an input corresponding to the control for initiating a communication with another computer system; and in response to detecting the input corresponding to the control for initiating a communication with another computer system, sending, to a second computer system external to the first computer system, a request to initiate the communication, wherein the second computer system is different from the first computer system.

In some embodiments, a computer program product is described. In some embodiments, the computer program product comprises one or more programs configured to be executed by one or more processors of a first computer system that is in communication with one or more display components and one or more input devices. In some embodiments, the one or more programs include instructions for: detecting a subject in an environment; and in response to detecting the subject in the environment: in accordance with a determination that the subject is not recognized, displaying, via the one or more display components, a control for initiating a communication with another computer system; and in accordance with a determination that the subject is recognized, forgoing display of, via the one or more display components, the control for initiating a communication with another computer system; while displaying the control for initiating a communication with another computer system, detecting, via the one or more input devices, an input corresponding to the control for initiating a communication with another computer system; and in response to detecting the input corresponding to the control for initiating a communication with another computer system, sending, to a second computer system external to the first computer system, a request to initiate the communication, wherein the second computer system is different from the first computer system.

In some embodiments, a method that is performed at a computer system that is in communication with one or more output devices that includes one or more display components is described. In some embodiments, the method comprises: in conjunction with recognizing, using a first set of one or more features corresponding to a subject, the subject, detecting, via the one or more input devices, a second set of one or more features corresponding to the subject, wherein the second set of one or more features is different from the first set of one or more features; after detecting the second set of one more feature, detecting, via the one or more input devices, the subject using the second set of one or more features; and in response to detecting the subject using the second set of one or more features: in accordance with a determination that the subject is detected using the second set of one or more features within a predetermined threshold of time since the computer system recognized the subject using the first set of one or more features, displaying, via the one or more display components, an indication that the subject is recognized; and in accordance with a determination that the subject is detected using the second set of one or more features after the predetermined threshold of time since the computer system recognized the subject using the first set of one or more features, forgoing display of, via the one or more display components, the indication that the subject is recognized.

In some embodiments, a non-transitory computer-readable storage medium storing one or more programs configured to be executed by one or more processors of a computer system that is in communication with one or more output devices that includes one or more display components is described. In some embodiments, the one or more programs includes instructions for: in conjunction with recognizing, using a first set of one or more features corresponding to a subject, the subject, detecting, via the one or more input devices, a second set of one or more features corresponding to the subject, wherein the second set of one or more features is different from the first set of one or more features; after detecting the second set of one more feature, detecting, via the one or more input devices, the subject using the second set of one or more features; and in response to detecting the subject using the second set of one or more features: in accordance with a determination that the subject is detected using the second set of one or more features within a predetermined threshold of time since the computer system recognized the subject using the first set of one or more features, displaying, via the one or more display components, an indication that the subject is recognized; and in accordance with a determination that the subject is detected using the second set of one or more features after the predetermined threshold of time since the computer system recognized the subject using the first set of one or more features, forgoing display of, via the one or more display components, the indication that the subject is recognized.

In some embodiments, a transitory computer-readable storage medium storing one or more programs configured to be executed by one or more processors of a computer system that is in communication with one or more output devices that includes one or more display components is described. In some embodiments, the one or more programs includes instructions for: in conjunction with recognizing, using a first set of one or more features corresponding to a subject, the subject, detecting, via the one or more input devices, a second set of one or more features corresponding to the subject, wherein the second set of one or more features is different from the first set of one or more features; after detecting the second set of one more feature, detecting, via the one or more input devices, the subject using the second set of one or more features; and in response to detecting the subject using the second set of one or more features: in accordance with a determination that the subject is detected using the second set of one or more features within a predetermined threshold of time since the computer system recognized the subject using the first set of one or more features, displaying, via the one or more display components, an indication that the subject is recognized; and in accordance with a determination that the subject is detected using the second set of one or more features after the predetermined threshold of time since the computer system recognized the subject using the first set of one or more features, forgoing display of, via the one or more display components, the indication that the subject is recognized.

In some embodiments, a computer system configured to communicate with one or more output devices that includes one or more display components is described. In some embodiments, the computer system comprises one or more processors and memory storing one or more programs configured to be executed by the one or more processors. In some embodiments, the one or more programs includes instructions for: in conjunction with recognizing, using a first set of one or more features corresponding to a subject, the subject, detecting, via the one or more input devices, a second set of one or more features corresponding to the subject, wherein the second set of one or more features is different from the first set of one or more features; after detecting the second set of one more feature, detecting, via the one or more input devices, the subject using the second set of one or more features; and in response to detecting the subject using the second set of one or more features: in accordance with a determination that the subject is detected using the second set of one or more features within a predetermined threshold of time since the computer system recognized the subject using the first set of one or more features, displaying, via the one or more display components, an indication that the subject is recognized; and in accordance with a determination that the subject is detected using the second set of one or more features after the predetermined threshold of time since the computer system recognized the subject using the first set of one or more features, forgoing display of, via the one or more display components, the indication that the subject is recognized.

In some embodiments, a computer system configured to communicate with one or more output devices that includes one or more display components is described. In some embodiments, the computer system comprises means for performing each of the following steps: in conjunction with recognizing, using a first set of one or more features corresponding to a subject, the subject, detecting, via the one or more input devices, a second set of one or more features corresponding to the subject, wherein the second set of one or more features is different from the first set of one or more features; after detecting the second set of one more feature, detecting, via the one or more input devices, the subject using the second set of one or more features; and in response to detecting the subject using the second set of one or more features: in accordance with a determination that the subject is detected using the second set of one or more features within a predetermined threshold of time since the computer system recognized the subject using the first set of one or more features, displaying, via the one or more display components, an indication that the subject is recognized; and in accordance with a determination that the subject is detected using the second set of one or more features after the predetermined threshold of time since the computer system recognized the subject using the first set of one or more features, forgoing display of, via the one or more display components, the indication that the subject is recognized.

In some embodiments, a computer program product is described. In some embodiments, the computer program product comprises one or more programs configured to be executed by one or more processors of a computer system that is in communication with one or more output devices that includes one or more display components. In some embodiments, the one or more programs include instructions for: in conjunction with recognizing, using a first set of one or more features corresponding to a subject, the subject, detecting, via the one or more input devices, a second set of one or more features corresponding to the subject, wherein the second set of one or more features is different from the first set of one or more features; after detecting the second set of one more feature, detecting, via the one or more input devices, the subject using the second set of one or more features; and in response to detecting the subject using the second set of one or more features: in accordance with a determination that the subject is detected using the second set of one or more features within a predetermined threshold of time since the computer system recognized the subject using the first set of one or more features, displaying, via the one or more display components, an indication that the subject is recognized; and in accordance with a determination that the subject is detected using the second set of one or more features after the predetermined threshold of time since the computer system recognized the subject using the first set of one or more features, forgoing display of, via the one or more display components, the indication that the subject is recognized.

In some embodiments, a method that is performed at a computer system that is in communication with one or more audio components is described. In some embodiments, the method comprises: receiving an indication that a subject has entered an environment; in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a non-transitory computer-readable storage medium storing one or more programs configured to be executed by one or more processors of a computer system that is in communication with one or more audio components is described. In some embodiments, the one or more programs includes instructions for: receiving an indication that a subject has entered an environment; in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a transitory computer-readable storage medium storing one or more programs configured to be executed by one or more processors of a computer system that is in communication with one or more audio components is described. In some embodiments, the one or more programs includes instructions for: receiving an indication that a subject has entered an environment; in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a computer system configured to communicate with one or more audio components is described. In some embodiments, the computer system comprises one or more processors and memory storing one or more programs configured to be executed by the one or more processors. In some embodiments, the one or more programs includes instructions for: receiving an indication that a subject has entered an environment; in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a computer system configured to communicate with one or more audio components is described. In some embodiments, the computer system comprises means for performing each of the following steps: receiving an indication that a subject has entered an environment; in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a computer program product is described. In some embodiments, the computer program product comprises one or more programs configured to be executed by one or more processors of a computer system that is in communication with one or more audio components. In some embodiments, the one or more programs include instructions for: receiving an indication that a subject has entered an environment; in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a method that is performed at a computer system that is in communication with one or more display components is described. In some embodiments, the method comprises: detecting an identity of a subject in an environment; and after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a non-transitory computer-readable storage medium storing one or more programs configured to be executed by one or more processors of a computer system that is in communication with one or more display components is described. In some embodiments, the one or more programs includes instructions for: detecting an identity of a subject in an environment; and after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a transitory computer-readable storage medium storing one or more programs configured to be executed by one or more processors of a computer system that is in communication with one or more display components is described. In some embodiments, the one or more programs includes instructions for: detecting an identity of a subject in an environment; and after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a computer system configured to communicate with one or more display components is described. In some embodiments, the computer system comprises one or more processors and memory storing one or more programs configured to be executed by the one or more processors. In some embodiments, the one or more programs includes instructions for: detecting an identity of a subject in an environment; and after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a computer system configured to communicate with one or more display components is described. In some embodiments, the computer system comprises means for performing each of the following steps: detecting an identity of a subject in an environment; and after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a computer program product is described. In some embodiments, the computer program product comprises one or more programs configured to be executed by one or more processors of a computer system that is in communication with one or more display components. In some embodiments, the one or more programs include instructions for: detecting an identity of a subject in an environment; and after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a method that is performed at a computer system that is in communication with one or more display components is described. In some embodiments, the method comprises: detecting an identity of a new subject in an environment; in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a non-transitory computer-readable storage medium storing one or more programs configured to be executed by one or more processors of a computer system that is in communication with one or more display components is described. In some embodiments, the one or more programs includes instructions for: detecting an identity of a new subject in an environment; in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a transitory computer-readable storage medium storing one or more programs configured to be executed by one or more processors of a computer system that is in communication with one or more display components is described. In some embodiments, the one or more programs includes instructions for: detecting an identity of a new subject in an environment; in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a computer system configured to communicate with one or more display components is described. In some embodiments, the computer system comprises one or more processors and memory storing one or more programs configured to be executed by the one or more processors. In some embodiments, the one or more programs includes instructions for: detecting an identity of a new subject in an environment; in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a computer system configured to communicate with one or more display components is described. In some embodiments, the computer system comprises means for performing each of the following steps: detecting an identity of a new subject in an environment; in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a computer program product is described. In some embodiments, the computer program product comprises one or more programs configured to be executed by one or more processors of a computer system that is in communication with one or more display components. In some embodiments, the one or more programs include instructions for: detecting an identity of a new subject in an environment; in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a method that is performed at a computer system that is in communication with one or more audio components is described. In some embodiments, the method comprises: receiving an indication that a subject has entered an environment; and, in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a non-transitory computer-readable storage medium storing one or more programs configured to be executed by one or more processors of a computer system that is in communication with one or more audio components is described. In some embodiments, the one or more programs includes instructions for: receiving an indication that a subject has entered an environment; and, in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a transitory computer-readable storage medium storing one or more programs configured to be executed by one or more processors of a computer system that is in communication with one or more audio components is described. In some embodiments, the one or more programs includes instructions for: receiving an indication that a subject has entered an environment; and, in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a computer system that is configured to communicate with one or more audio components is described. In some embodiments, the computer system comprises one or more processors and memory storing one or more programs configured to be executed by the one or more processors. In some embodiments, the one or more programs includes instructions for: receiving an indication that a subject has entered an environment; and, in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a computer system that is configured to communicate with one or more audio components is described. In some embodiments, the computer system comprises means for performing each of the following steps: receiving an indication that a subject has entered an environment; and, in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a computer program product is described. In some embodiments, the computer program product comprises one or more programs configured to be executed by one or more processors of a computer system that is in communication with one or more audio components. In some embodiments, the one or more programs include instructions for: receiving an indication that a subject has entered an environment; and, in response to receiving the indication that the subject has entered the environment: in accordance with a determination that a first set of one or more criteria is satisfied, outputting, via the one or more audio components, a first tone; and in accordance with a determination that a second set of one or more criteria is satisfied, outputting, via the one or more audio components, a second tone different from the first tone, wherein the second set of one or more criteria is different from the first set of one or more criteria.

In some embodiments, a method that is performed at a computer system that is in communication with one or more display components is described. In some embodiments, the method comprises: detecting an identity of a subject in an environment; and, after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a non-transitory computer-readable storage medium storing one or more programs configured to be executed by one or more processors of a computer system that is in communication with one or more display components is described. In some embodiments, the one or more programs includes instructions for: detecting an identity of a subject in an environment; and, after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a transitory computer-readable storage medium storing one or more programs configured to be executed by one or more processors of a computer system that is in communication with one or more display components is described. In some embodiments, the one or more programs includes instructions for: detecting an identity of a subject in an environment; and, after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a computer system that is configured to communicate with one or more display components is described. In some embodiments, the computer system comprises one or more processors and memory storing one or more programs configured to be executed by the one or more processors. In some embodiments, the one or more programs includes instructions for: detecting an identity of a subject in an environment; and, after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a computer system that is configured to communicate with one or more display components is described. In some embodiments, the computer system comprises means for performing each of the following steps: detecting an identity of a subject in an environment; and, after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a computer program product is described. In some embodiments, the computer program product comprises one or more programs configured to be executed by one or more processors of a computer system that is in communication with one or more display components. In some embodiments, the one or more programs include instructions for: detecting an identity of a subject in an environment; and, after detecting the identity of the subject in the environment: in accordance with a determination that a non-zero period of time has expired since detecting the identity of the subject in the environment without authenticating the subject, sending, to a personal device of the subject, a notification to authenticate the subject; and in accordance with a determination that the non-zero period of time has not expired since detecting the identity of the subject in the environment without authenticating the subject, forgoing sending, to the personal device of the subject, the notification to authenticate the subject.

In some embodiments, a method that is performed at a computer system that is in communication with one or more display components is described. In some embodiments, the method comprises: detecting an identity of a new subject in an environment; and, in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a non-transitory computer-readable storage medium storing one or more programs configured to be executed by one or more processors of a computer system that is in communication with one or more display components is described. In some embodiments, the one or more programs includes instructions for: detecting an identity of a new subject in an environment; and, in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a transitory computer-readable storage medium storing one or more programs configured to be executed by one or more processors of a computer system that is in communication with one or more display components is described. In some embodiments, the one or more programs includes instructions for: detecting an identity of a new subject in an environment; and, in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a computer system that is configured to communicate with one or more display components is described. In some embodiments, the computer system comprises one or more processors and memory storing one or more programs configured to be executed by the one or more processors. In some embodiments, the one or more programs includes instructions for: detecting an identity of a new subject in an environment; and, in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a computer system that is configured to communicate with one or more display components is described. In some embodiments, the computer system comprises means for performing each of the following steps: detecting an identity of a new subject in an environment; and, in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

In some embodiments, a computer program product is described. In some embodiments, the computer program product comprises one or more programs configured to be executed by one or more processors of a computer system that is in communication with one or more display components. In some embodiments, the one or more programs include instructions for: detecting an identity of a new subject in an environment; and, in response to detecting the identity of the new subject in the environment: in accordance with a determination that an authenticated subject is not already in the environment, outputting a request to authenticate the new subject; and in accordance with a determination that an authenticated subject is already in the environment, forgoing output of the request to authenticate the new subject.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a computer system in accordance with some embodiments.

FIG. 2A is a block diagram illustrating a device and a system in accordance with some embodiments.

FIG. 2B illustrates a computer system with a touch screen in accordance with some embodiments.

FIG. 3 is a block diagram illustrating an ecosystem including a computer system with other accessory devices in accordance with some embodiments.

FIGS. 4A-4N illustrate exemplary user interfaces for authenticating subjects in accordance with some embodiments.

FIG. 5 is a flow diagram illustrating a process for outputting an indication based on a subject in accordance with some embodiments.

FIG. 6 is a flow diagram illustrating a process for displaying a control based on a subject in accordance with some embodiments.

FIGS. 7A-7F illustrate exemplary user interfaces for identifying a subject based on one or more characteristics in accordance with some embodiments.

FIG. 8 is a flow diagram illustrating a process for identifying a subject based on one or more characteristics in accordance with some embodiments.

FIGS. 9A-9V illustrate exemplary user interfaces for notifying subjects to authenticate in accordance with some embodiments.

FIG. 10 is a flow diagram illustrating a process for outputting a tone based on authentication in accordance with some embodiments.

FIG. 11 is a flow diagram illustrating a process for sending reminders based on time in accordance with some embodiments.

FIG. 12 is a flow diagram illustrating a process for outputting a request based on subjects in environment in accordance with some embodiments.

FIGS. 13A-13K illustrate exemplary user interfaces for authenticating subjects in accordance with some embodiments.

FIG. 14 is a flow diagram illustrating a process for outputting audio in accordance with some embodiments.

FIG. 15 is a flow diagram illustrating a process for assisting with authentication in accordance with some embodiments.

FIGS. 16A-16I illustrate exemplary user interfaces for authenticating subjects in accordance with some embodiments.

FIG. 17 is a flow diagram illustrating a process for outputting a request to authenticate in accordance with some embodiments.

### DETAILED DESCRIPTION

The description that follows covers exemplary embodiments and examples. However, it should be acknowledged that this description is given as an explanation and is not meant to restrict the scope of the current disclosure. For example, terms used to describe different embodiments and different examples are not meant to be restrictive unless explicitly stated.

In some embodiments, one or more steps of a process can be contingent upon fulfillment of one or more conditions. To fulfill the one or more conditions, a process can be repeated multiple times. In such embodiments, different conditions can be satisfied in different repetitions. For example, steps can be repeated until all conditions have been satisfied. In some embodiments, electronic devices, computer systems, and/or computer readable mediums include instructions for performing one or more steps that are contingent upon one or more conditions being satisfied. Such instructions can include logic that determines whether the one or more conditions have been fulfilled without repetition of a step.

Although terms such as “first”, “second”, and so forth are used with different elements in the following description, these elements should not be constrained by the terms unless explicitly stated otherwise. In some embodiments, the terms are used to differentiate one element from another. For example, a “first” input can be different from a “second” input, though the terms “first” and “second” can be switched without changing the meaning of either input. In some embodiments, the “first” input and the “second” input are two different references to the same input unless explicitly stated otherwise.

Unless context makes it apparent otherwise, singular forms of “a”, “an”, and “the” are meant to cover plural forms. Additionally, the term “and/or” is meant to be interpreted to apply to and include any and all potential combinations of one or more of the related mentioned things. The terms “has”, “having”, “includes”, “including”, “comprises”, and/or “comprising” are meant to cover the presence of different elements; however, they do not preclude the presence or addition of one or more additional elements. The term “if” is meant to be interpreted to indicate “when”, “upon”, “in response to determining”, or “in response to detecting”. Accordingly, depending on the context, the expressions “if it is determined” or “if [a stated condition] is detected” can be interpreted as meaning “upon determining”, “in response to determining”, “upon detecting [the stated condition]”, or “in response to detecting [the stated condition]”.

Some processes described below enhance the operability of devices and make interfaces better, such as by helping a user provide proper inputs and/or reduce mistakes when using devices, through various techniques. For example, some processes perform an operation when a set of conditions has been met without requiring further input, such as input by a user. For another example, some processes provide additional control options without cluttering user interfaces with additional displayed controls. For another example, some processes reduce the number of inputs needed to perform an operation. For another example, some processes provide improved feedback (e.g., visual, haptic, acoustic, and/or tactile feedback) to a user. Additional techniques include increasing the security and/or privacy of the device and/or reducing burn-in. These techniques also reduce power usage and/or improve battery life of devices, such as by enabling a user to use devices better, more quickly, and/or efficiently.

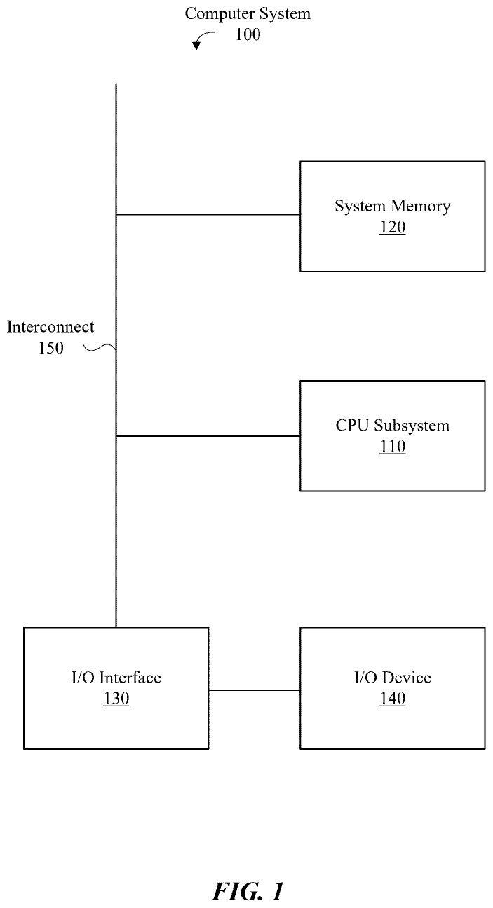

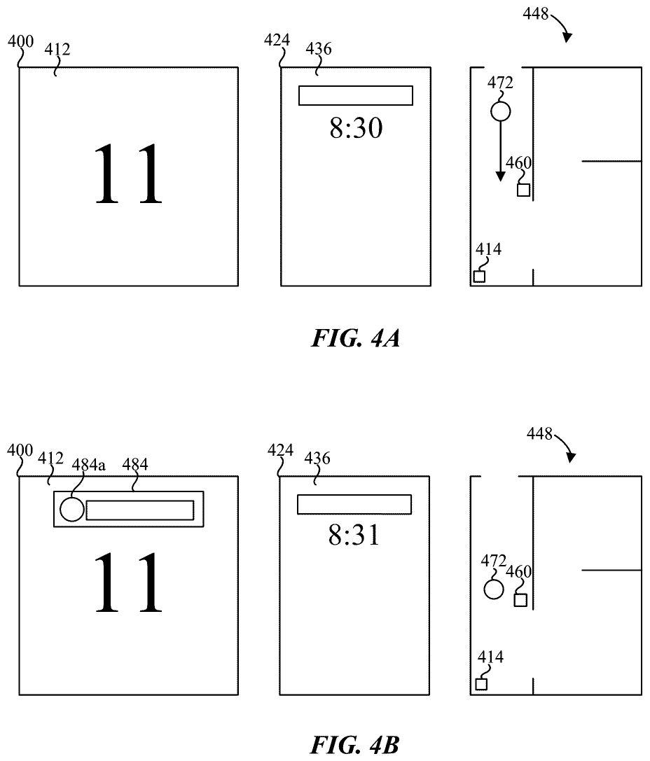

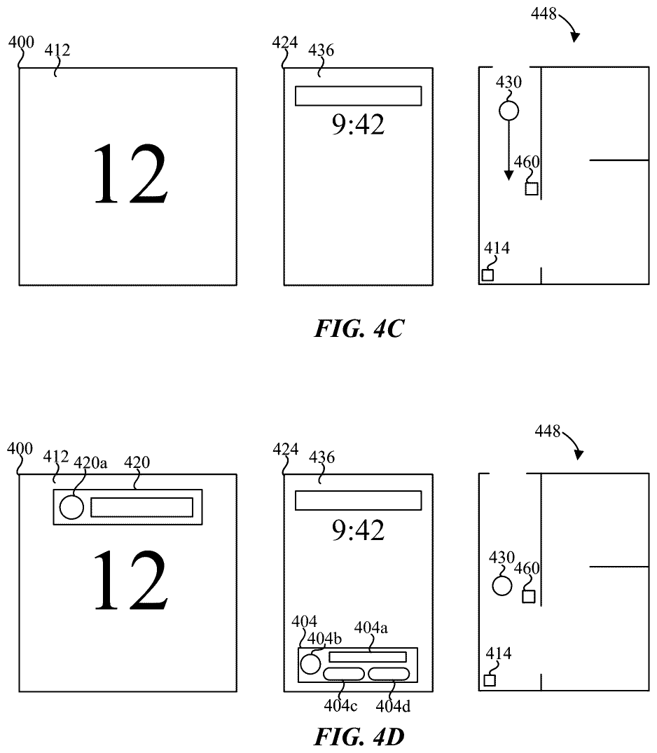

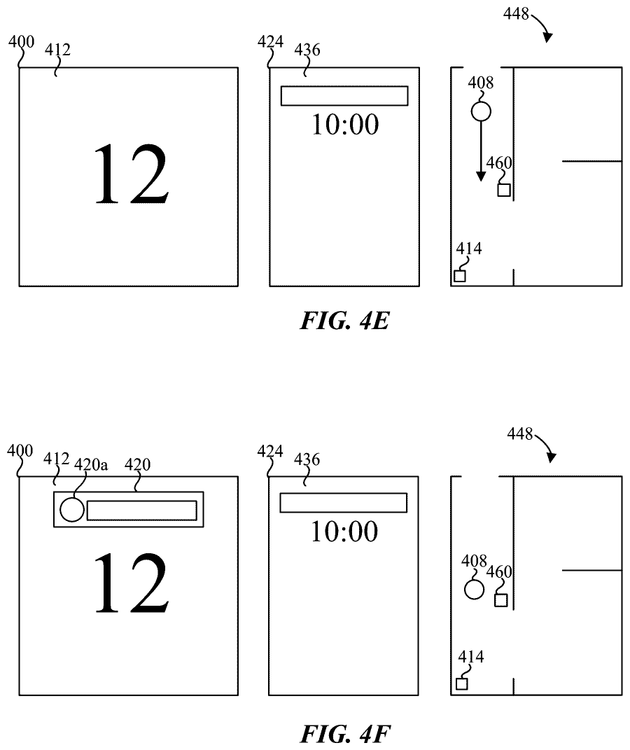

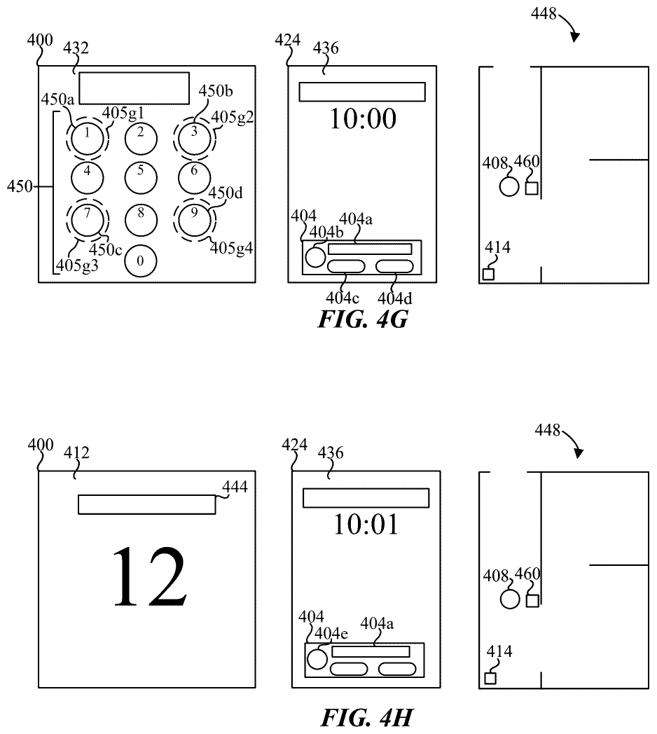

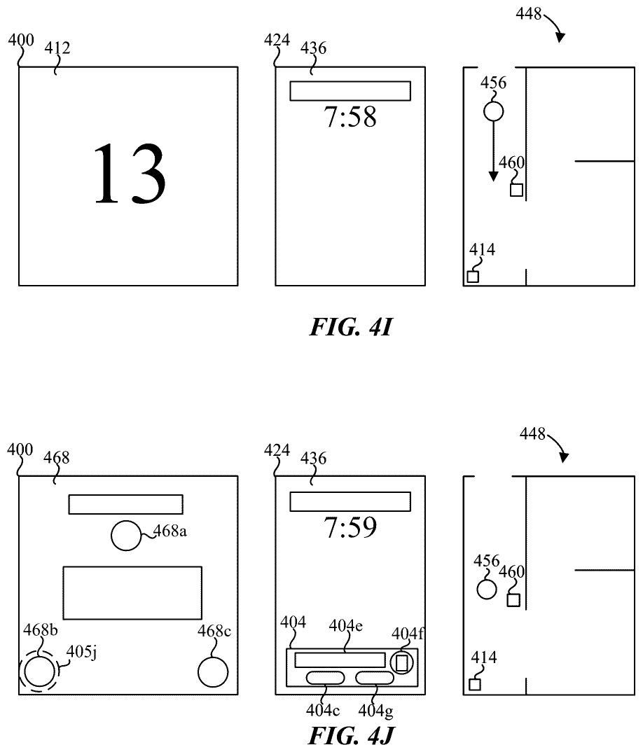

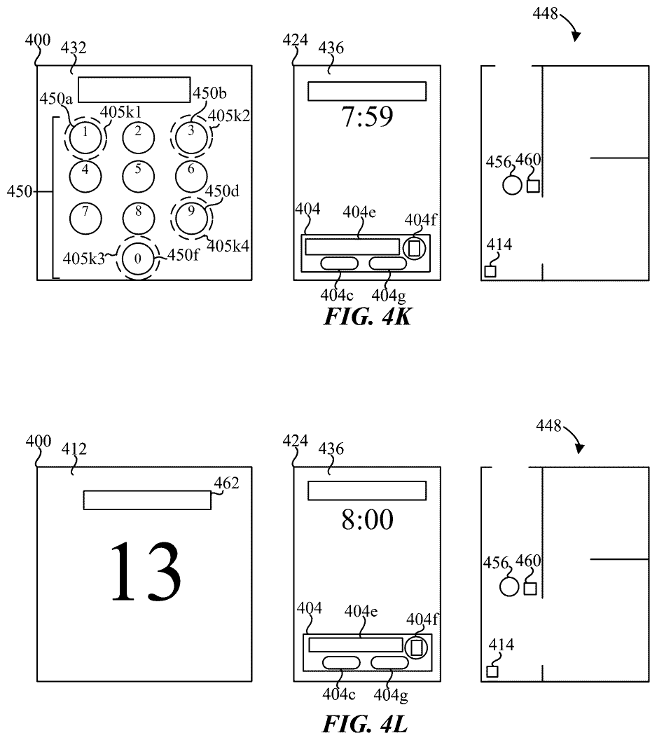

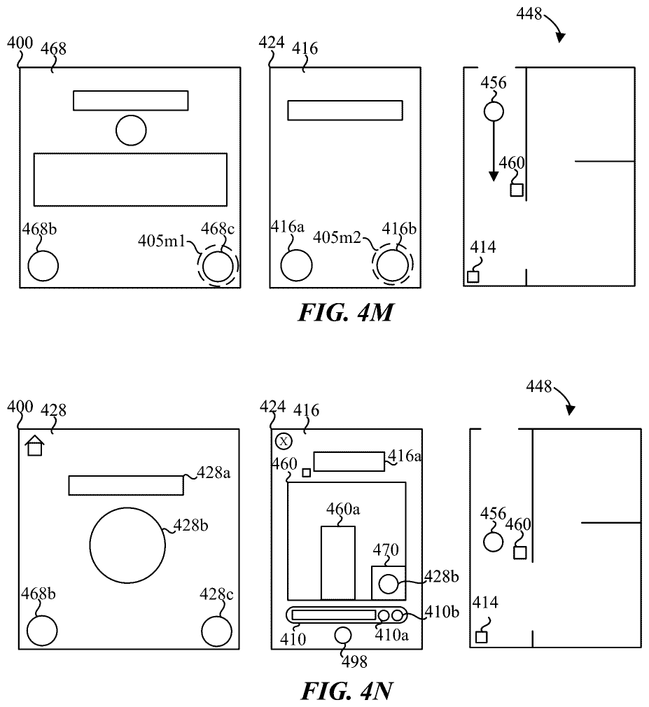

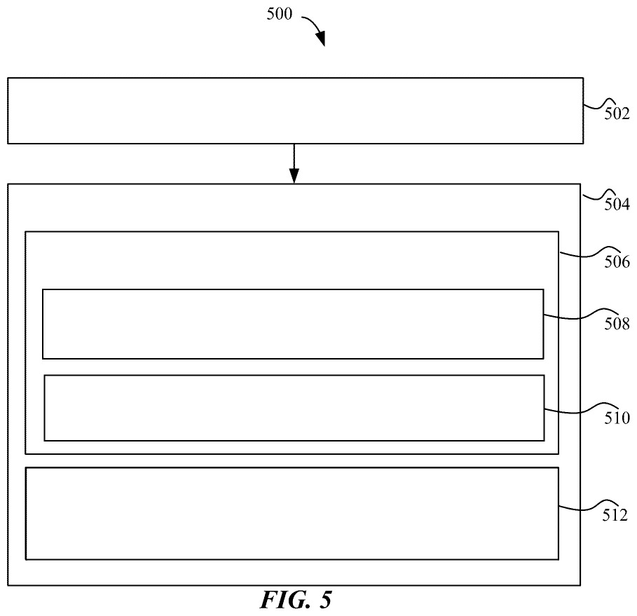

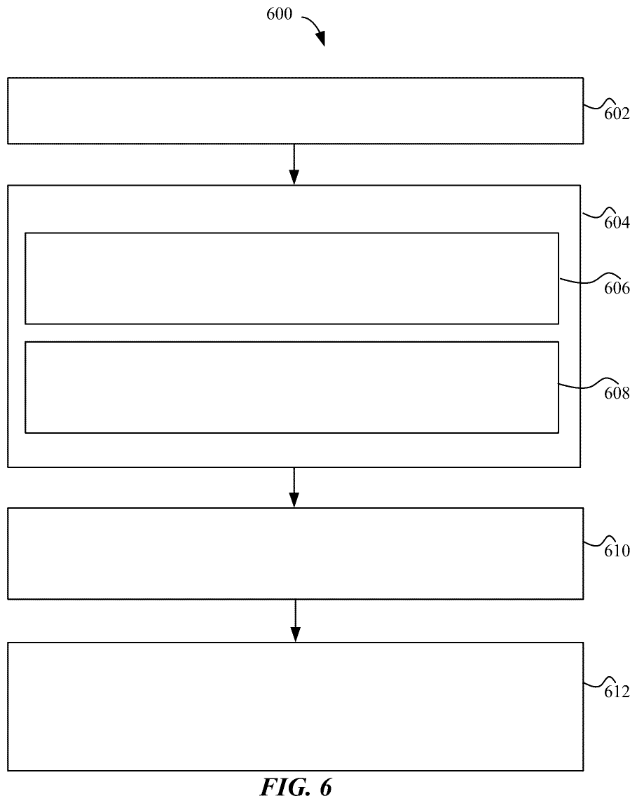

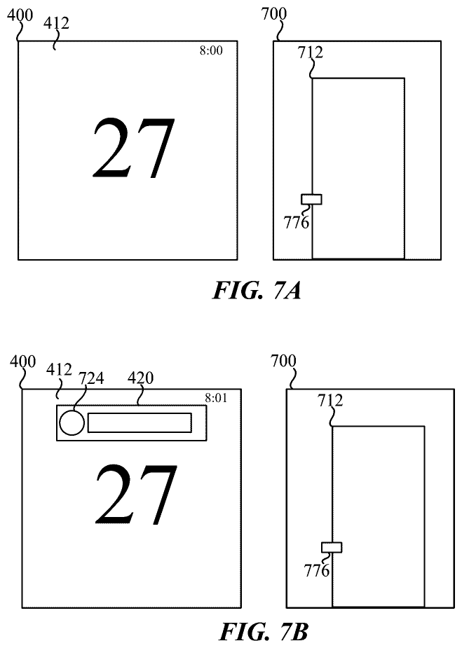

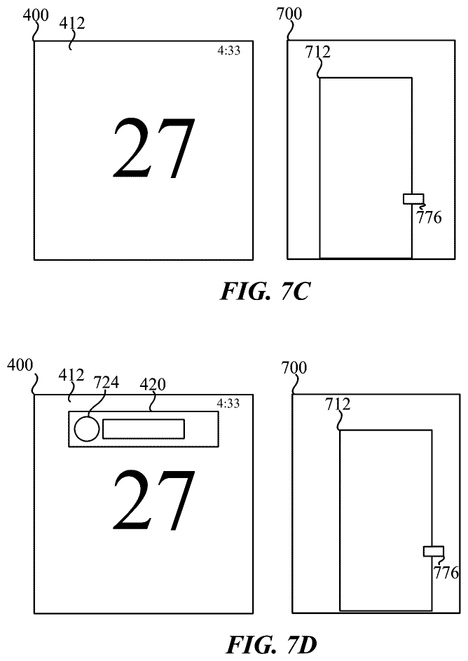

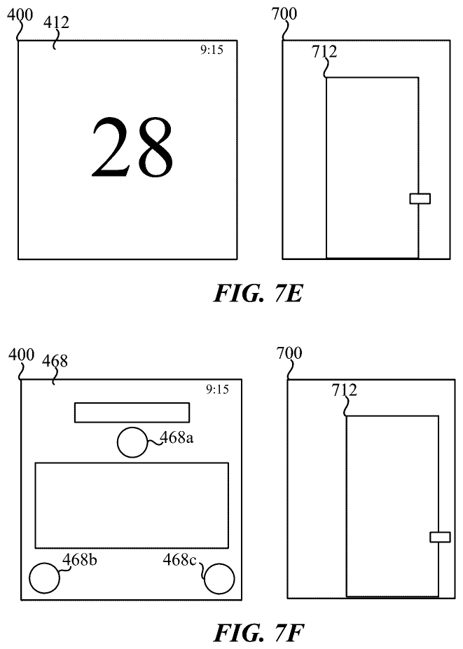

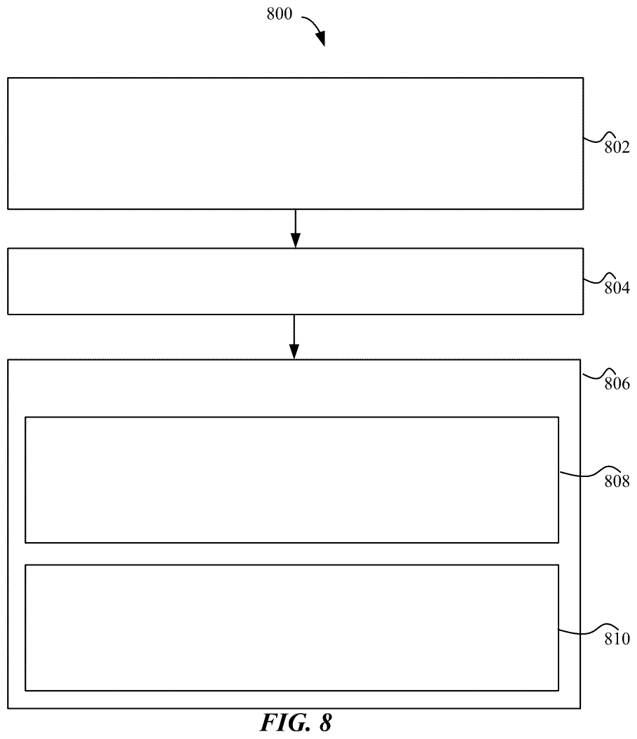

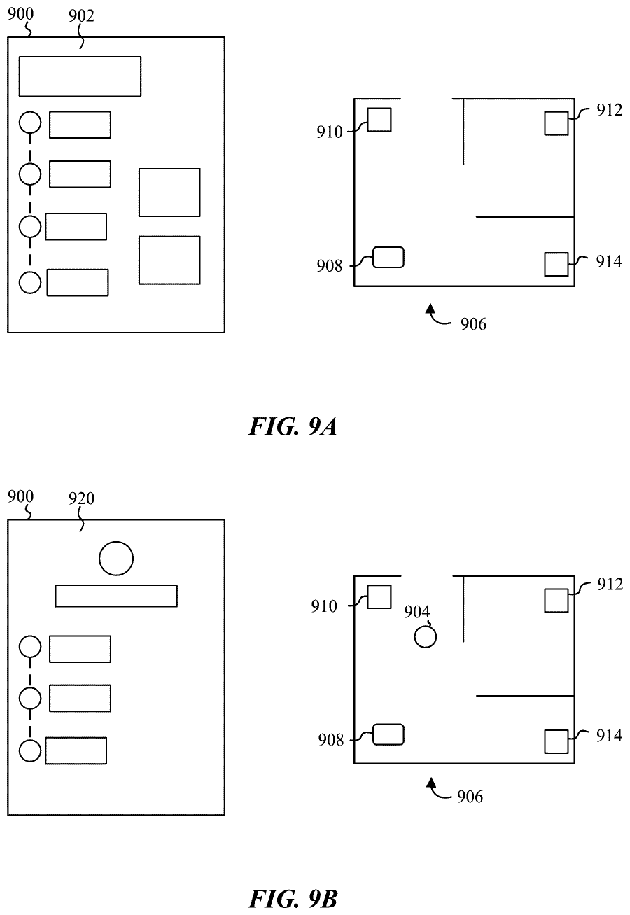

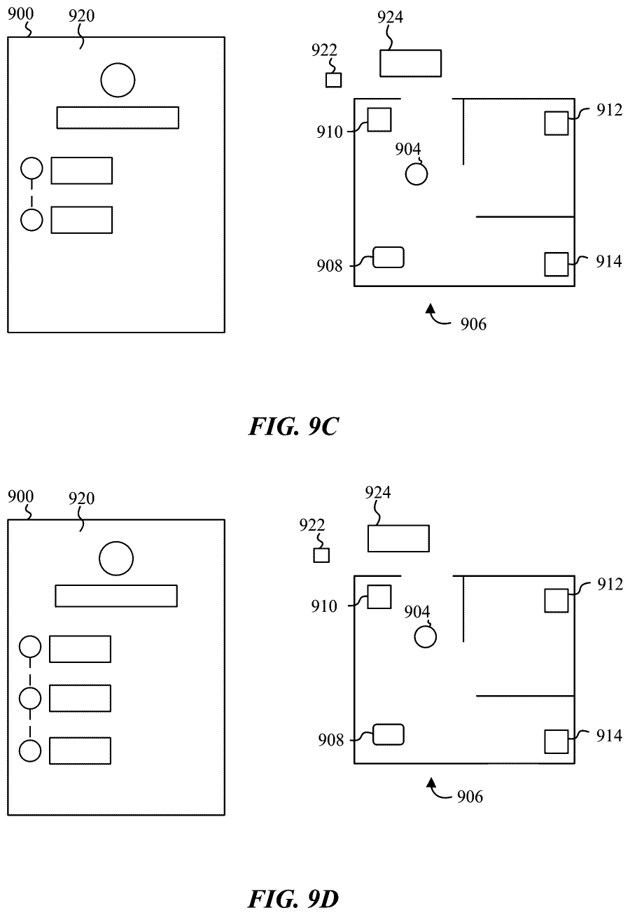

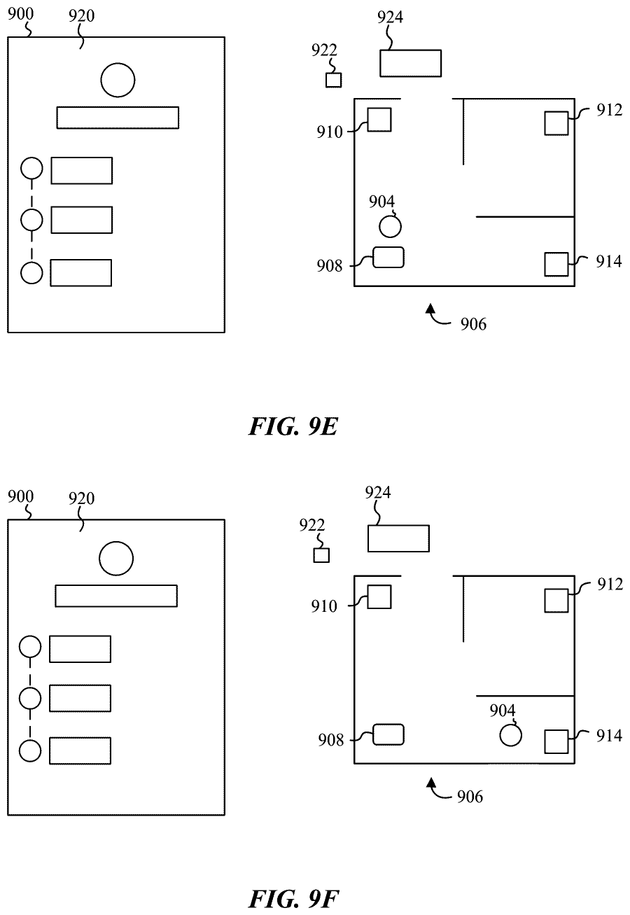

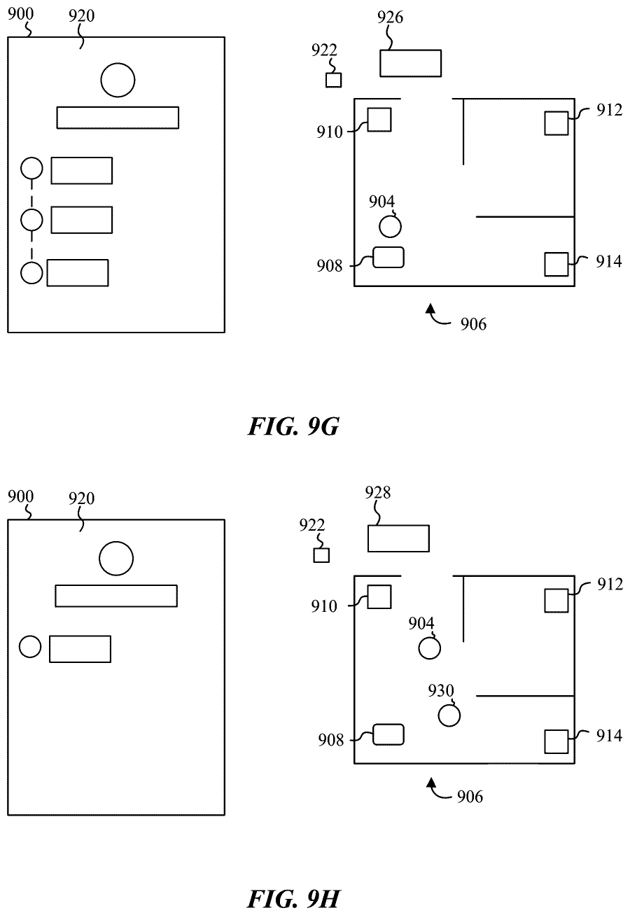

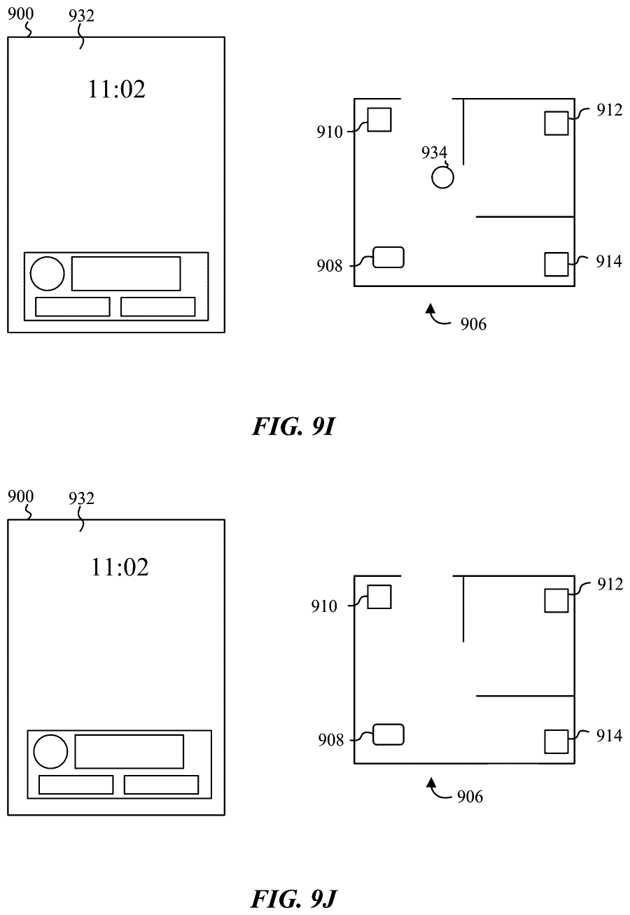

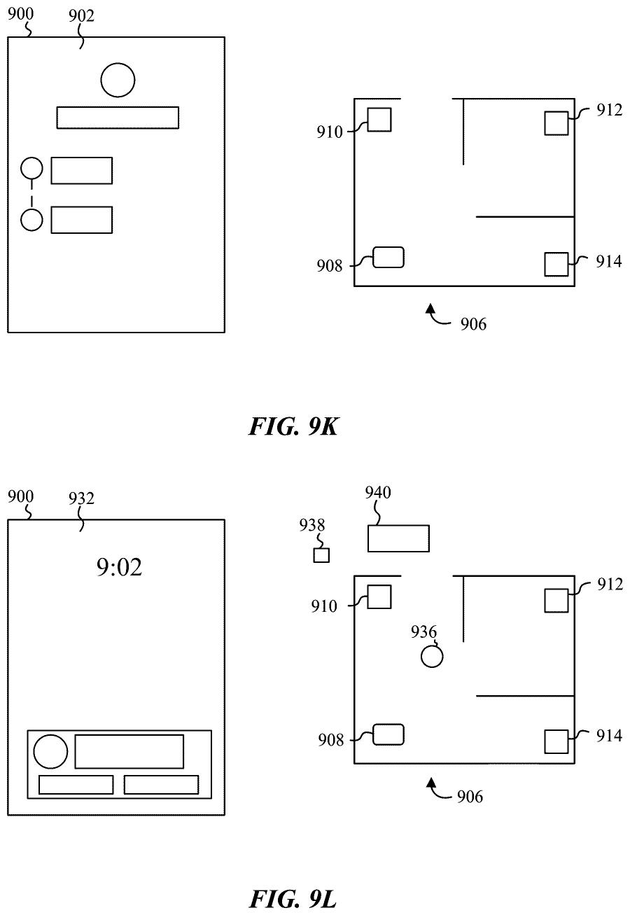

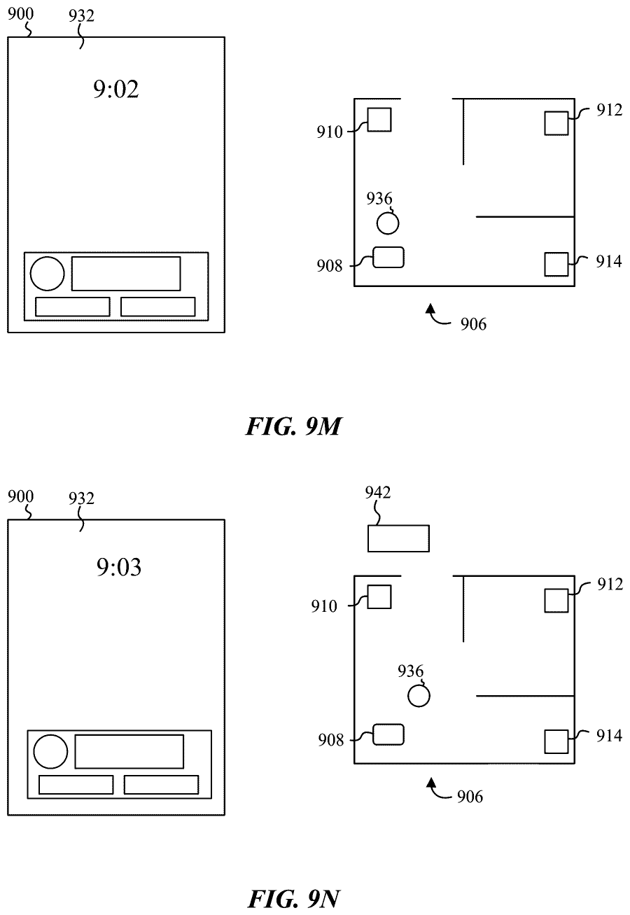

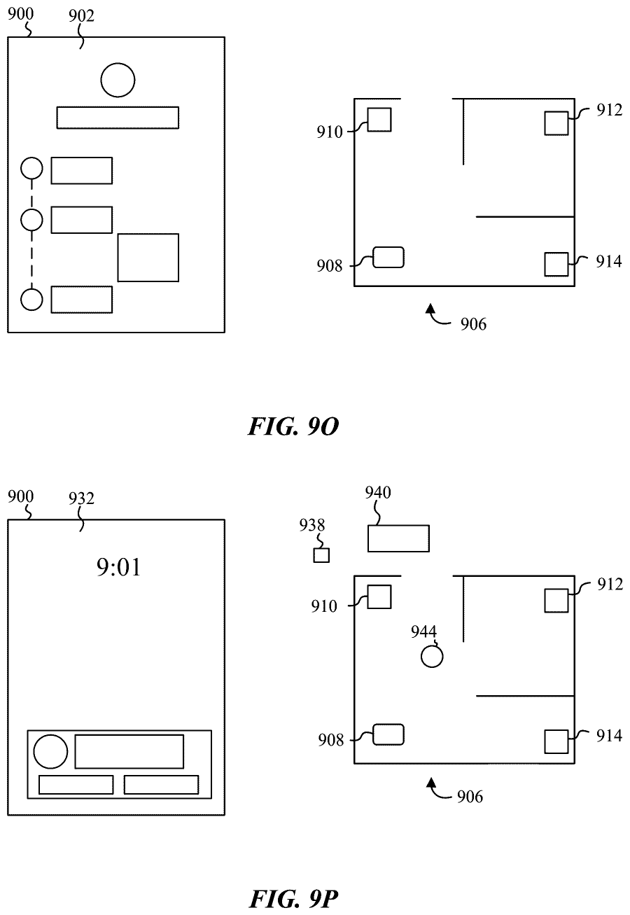

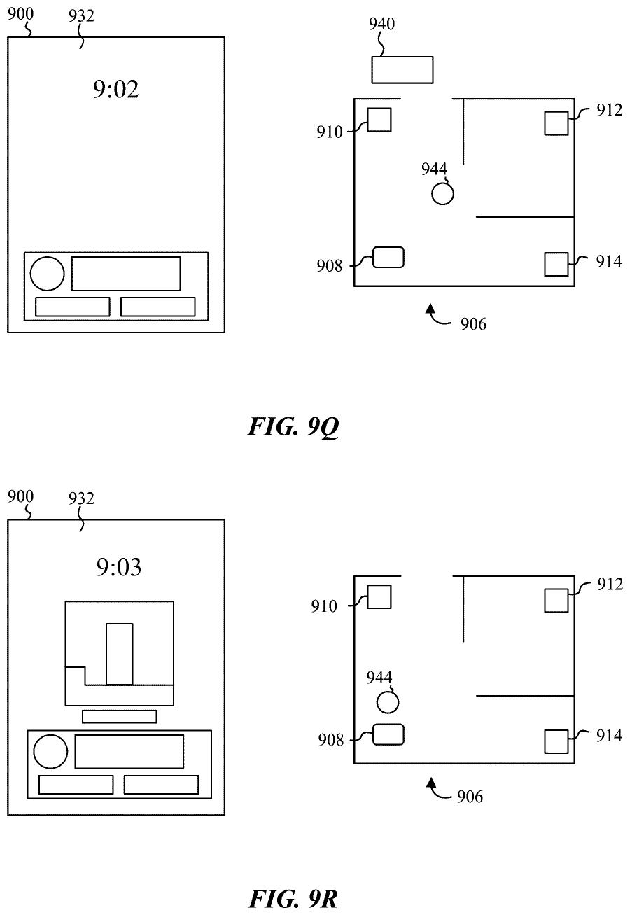

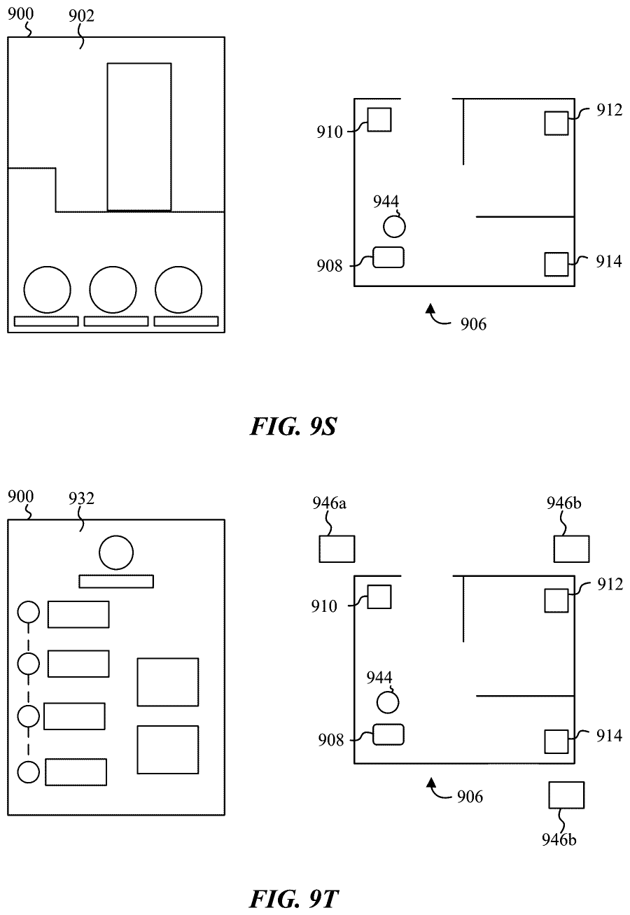

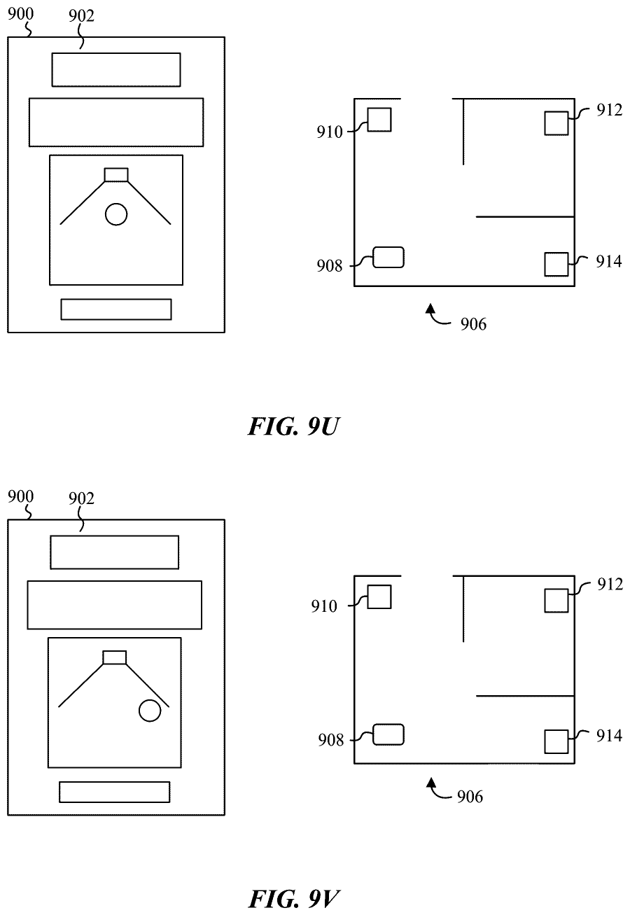

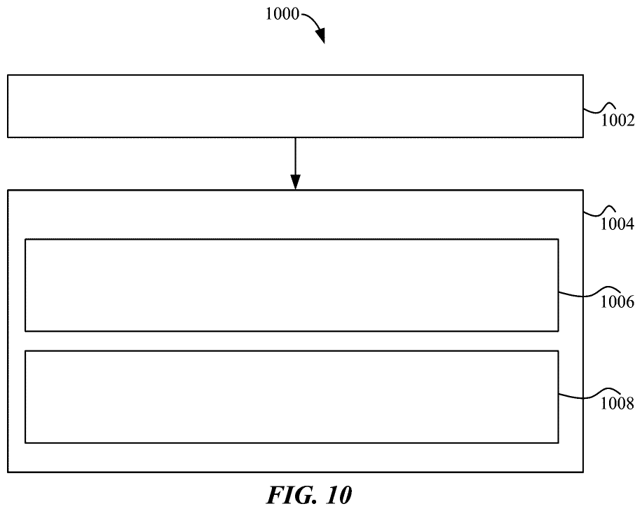

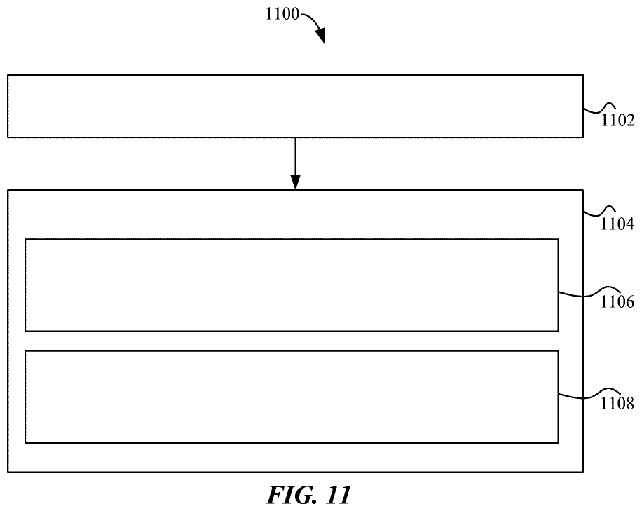

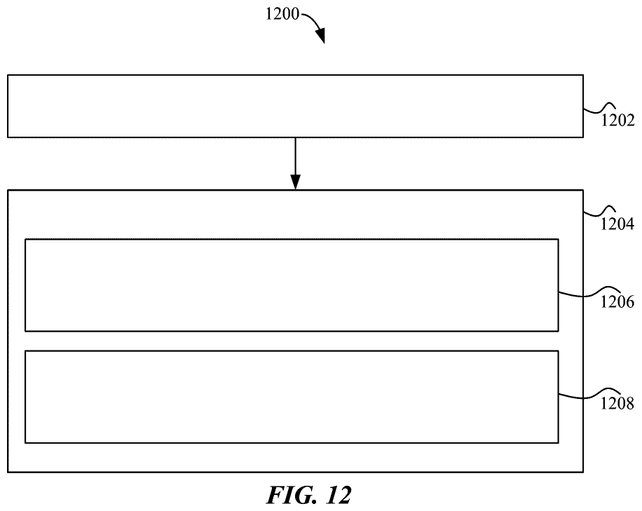

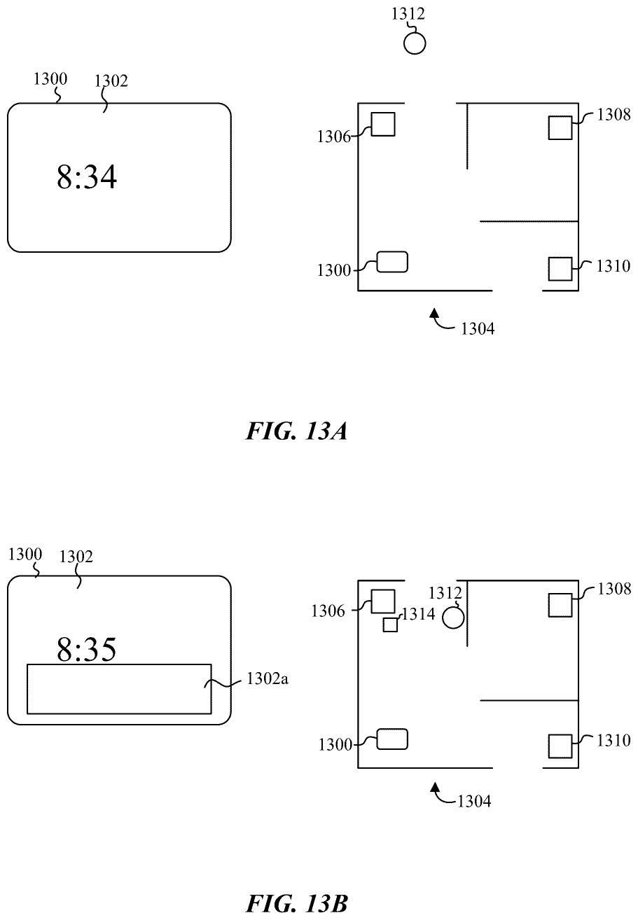

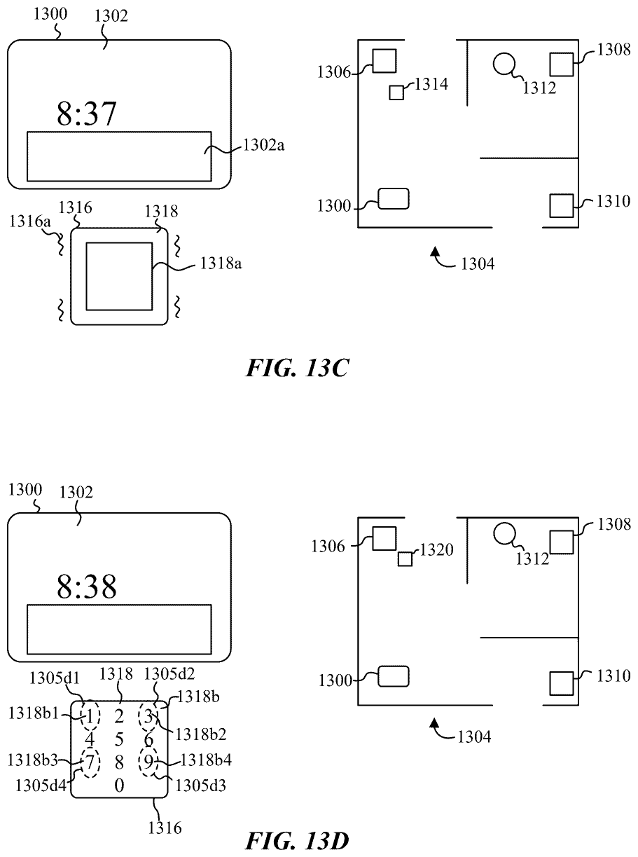

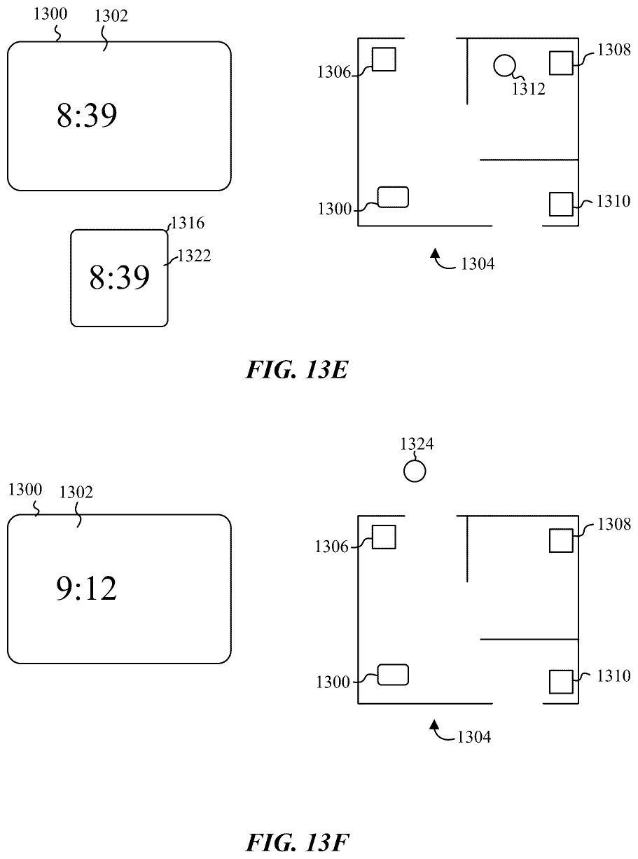

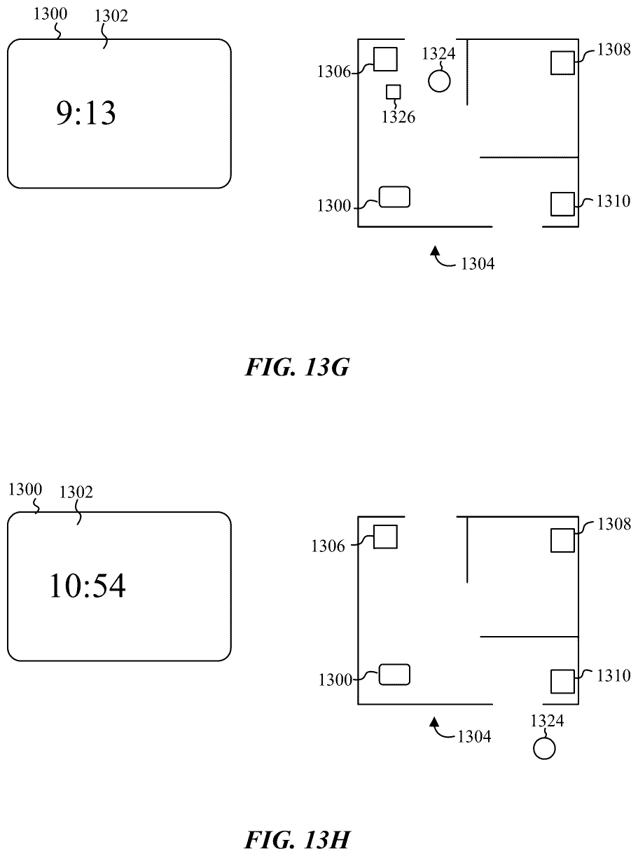

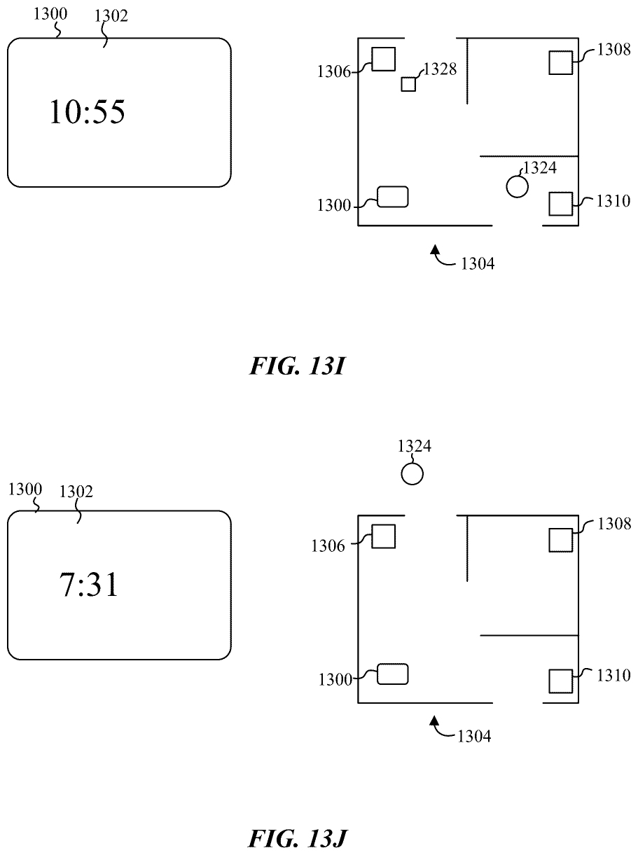

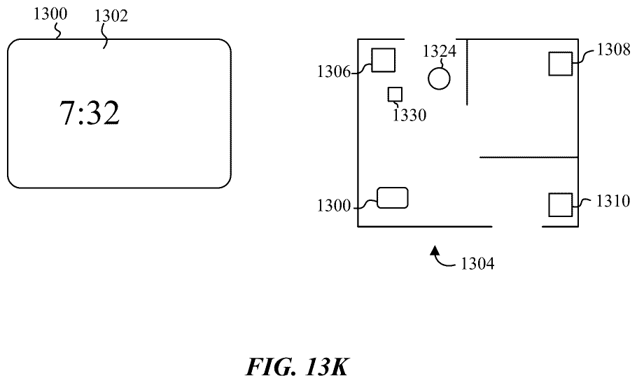

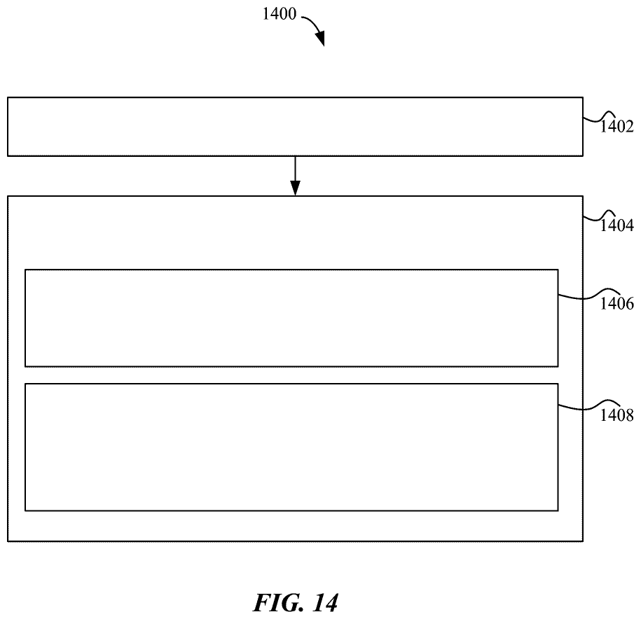

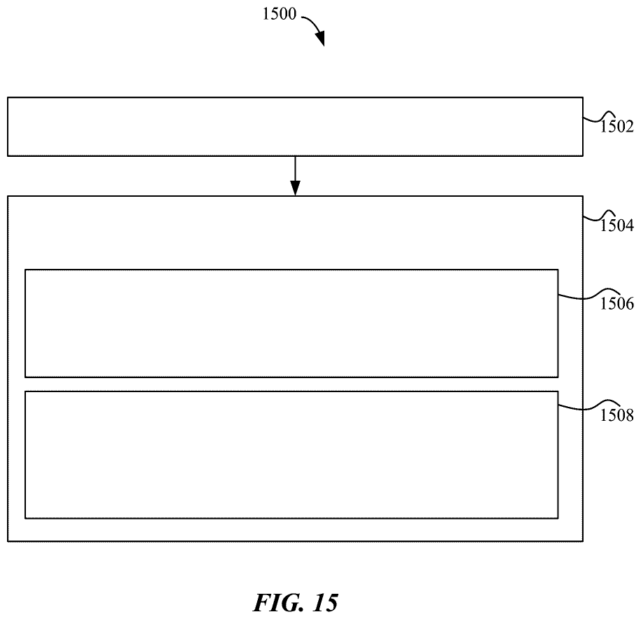

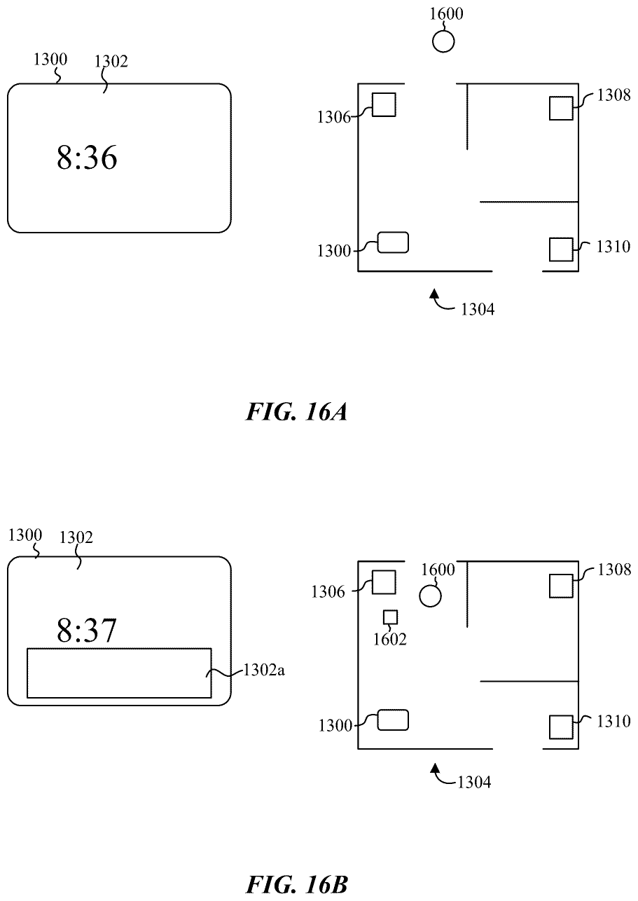

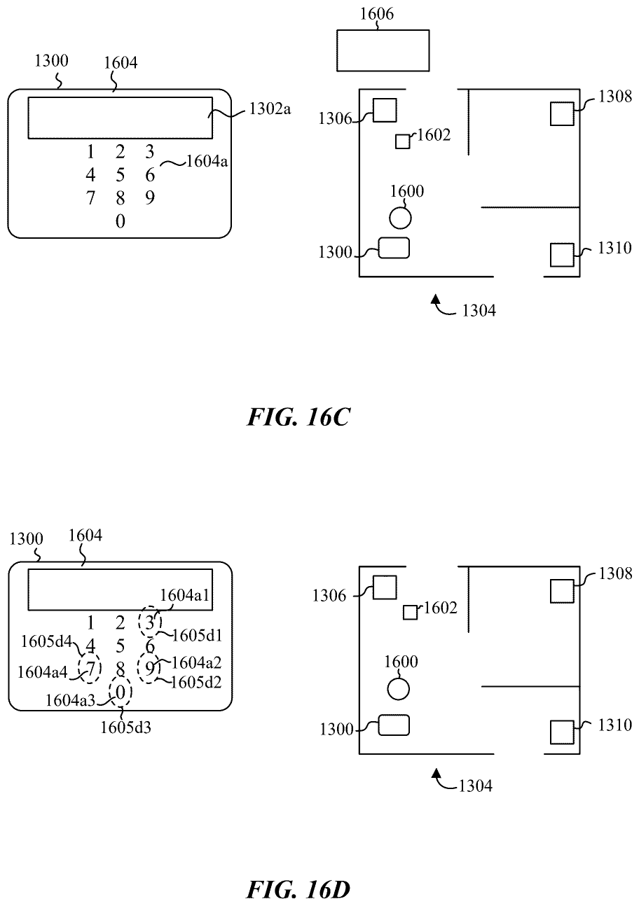

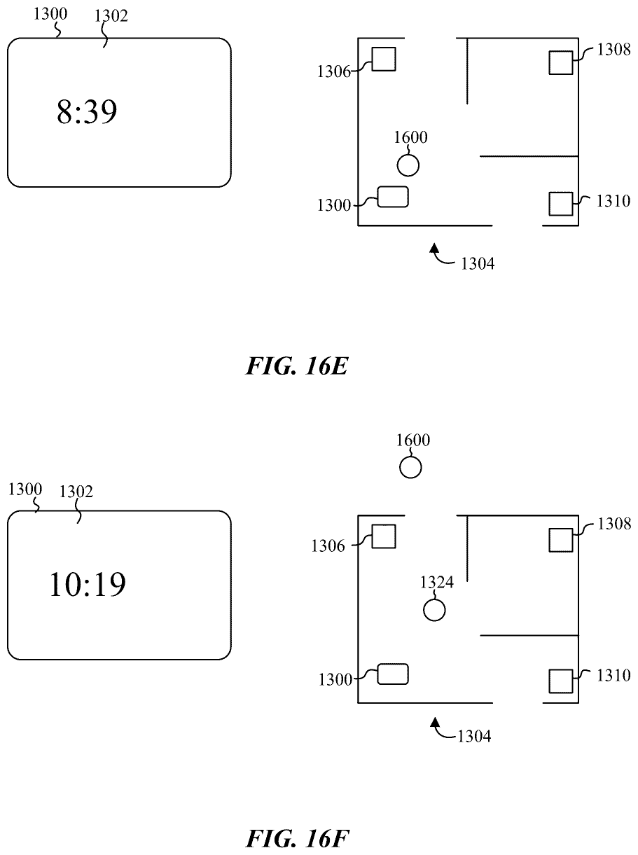

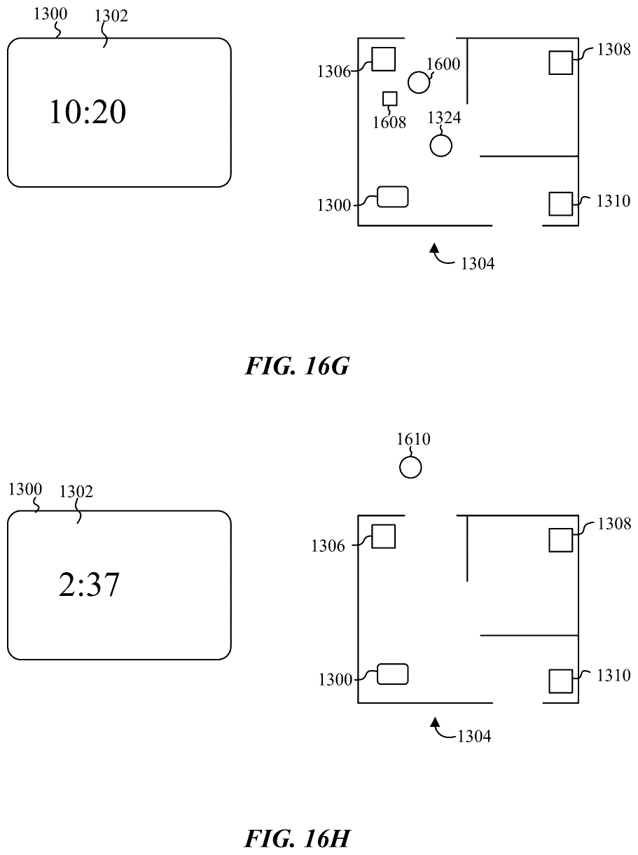

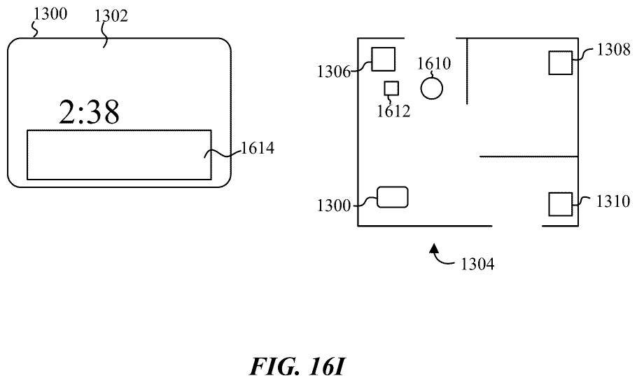

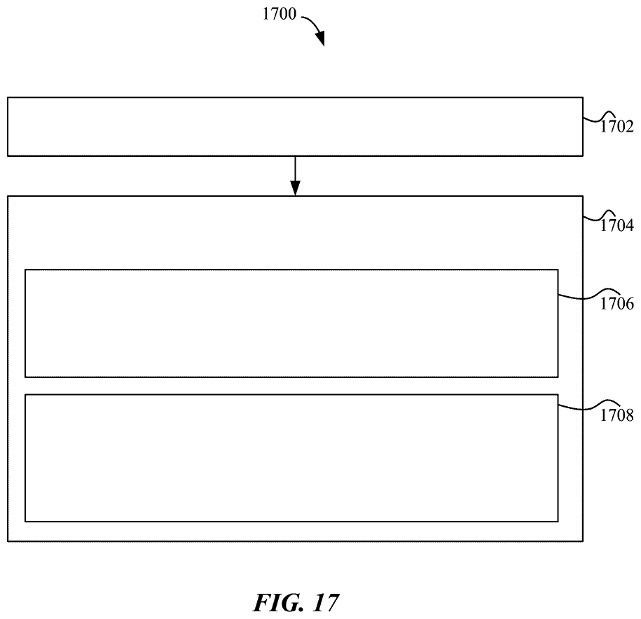

Below, FIGS. 1, 2A-2B, and 3 provide description of exemplary devices for implementing techniques described below. FIGS. 4A-4N illustrate exemplary user interfaces for authenticating subjects in accordance with some embodiments. FIG. 5 is a flow diagram illustrating a process for outputting an indication based on a subject in accordance with some embodiments. The user interfaces in FIGS. 4A-4N are used to illustrate the processes described below, including the processes in FIG. 5. FIG. 6 is a flow diagram illustrating a process for displaying a control based on a subject in accordance with some embodiments. The user interfaces in FIGS. 4A-4N are used to illustrate the processes described below, including the processes in FIG. 6. FIGS. 7A-7F illustrate exemplary user interfaces for identifying a subject based on one or more characteristics in accordance with some embodiments. FIG. 8 is a flow diagram illustrating a process for identifying a subject based on one or more characteristics in accordance with some embodiments. The user interfaces in FIGS. 7A-7F are used to illustrate the processes described below, including the processes in FIG. 8. FIGS. 9A-9V illustrate exemplary user interfaces for notifying subjects to authenticate in accordance with some embodiments. FIG. 10 is a flow diagram illustrating a process for outputting a tone based on authentication in accordance with some embodiments. FIG. 11 is a flow diagram illustrating a process for sending reminders based on time in accordance with some embodiments. 11. FIG. 12 is a flow diagram illustrating a process for outputting a request based on subjects in environment in accordance with some embodiments. The user interfaces in FIGS. 9A-9V are used to illustrate the processes described below, including the processes in FIGS. 10-12. FIGS. 13A-13K illustrate exemplary user interfaces for authenticating subjects in accordance with some embodiments. FIG. 14 is a flow diagram illustrating a process for outputting audio in accordance with some embodiments. The user interfaces in FIGS. 13A-13K are used to illustrate the processes described below, including the processes in FIG. 14. FIG. 15 is a flow diagram illustrating a process for assisting with authentication in accordance with some embodiments. The user interfaces in FIGS. 13A-13K are used to illustrate the processes described below, including the processes in FIG. 15. FIGS. 16A-16I illustrate exemplary user interfaces for authenticating subjects in accordance with some embodiments. FIG. 17 is a flow diagram illustrating a process for outputting a request to authenticate in accordance with some embodiments. The user interfaces in FIGS. 16A-16I are used to illustrate the processes described below, including the processes in FIG. 17.

FIG. 1 is a block diagram illustrating a computer system in accordance with some embodiments. While FIG. 1 illustrates one computer system, two or more computer systems working together can implement techniques described herein. It should be acknowledged that the computer system (e.g., computer system 100) is sometimes referred to as a device, an electronic device, an electronic system, a compute system, and/or a system. In some embodiments, computer system 100 is a personal computer system, a server system, a smart phone, a system on a chip, a smart watch, a wearable device, a tablet, a laptop computer, a fitness tracking device, a head-mounted display (HMD) device, a desktop computer, a communal device (e.g., a smart speaker, connected thermostat, and/or other home-based computer systems), an accessory (e.g., a switch, light, speaker, air conditioner, heater, window cover, fan, lock, media playback device, and/or television), a controller, a hub device, or a sensor.

As illustrated in FIG. 1, computer system 100 includes CPU subsystem 110, system memory 120, and I/O interface 130. Such components are able to communicate with one another through interconnect 150. In some embodiments, interconnect 150 is an electrical means of communication such as a system bus, one or more memory locations, and/or additional electrical channels for connecting multiple components of computer system 100.

It should be acknowledged that computer system 100 is only one example of a computer system to carry out techniques described below and that one or more other computer systems can carry out such techniques. Furthermore, while FIG. 1 illustrates a particular computer architecture of computer system 100, techniques described herein can be carried out by other computer architectures, such as by incorporating more, less, similar, and/or different components than the components illustrated.

In some embodiments, CPU subsystem 110 includes one or more processing units that can carry out techniques described herein. For example, CPU subsystem 110 can execute system-level and/or application-level instructions to perform an operation. In some embodiments, computer system 100 has several processing subsystems (e.g., multiple instances of CPU subsystem 110).

In some embodiments, CPU subsystem 110 is capable of carrying out instructions stored on a storage medium, such as a non-transitory or transitory computer-readable medium. A computer-readable storage medium (or many physical computer-readable storage media of one or more types) including one or more computer-readable instructions can be used to realize implementations falling partially or fully under the purview of the current disclosure. It should be acknowledged that computer-readable instructions can be arranged in any way, such as components, software, processes, widgets, and/or applications.

It should be acknowledged that the storage medium can be any medium that can physically include or store computer-executable instructions. For example, the storage medium can be temporary or non-temporary. Examples of storage medium include magnetic (e.g., hard drives and/or magnetic disks), optical (e.g., optical drives and/or optical discs based on CD, DVD, and Blu-ray technologies), solid state (e.g., solid state drives and/or flash drives), and/or semiconductor (e.g., random access memory) storages. In some embodiments, the storage medium is system memory 120. In such embodiments, each instruction stored by system memory 120 and executed by CPU subsystem 110 corresponds to an operation for completing functionality described herein. For example, instructions for processes 500, 600, 800, 1000, 1100, 1200, 1400, 1500, and 1700 (FIGS. 5, 6, 8, 10, 11, 12, 14, 15, and 17) can be stored in system memory 120.

In some embodiments, system memory 120 implements a range of distinct physical, non-transitory memory media. Examples of system memory 120 include a storage array, a storage area network (SAN), a removable flash drive, flash memory, hard disk storage, optical drive storage, floppy disk storage, removable disk storage, random access memory (such as SDRAM, DDR SDRAM, RAM-SRAM, EDO RAM, and/or RAMBUS RAM), and/or read-only memory (such as PROM and/or EEPROM). In some embodiments, computer system 100 has several memory components coupled, either directly or via interconnect 150, to CPU subsystem 110.

In some embodiments, computer system 100 communicates with external devices through I/O interface 130, which can be one or more types of interfaces. For example, I/O interface 130 can include a bridge chip that connects a front-side bus to one or more back-side buses. In some embodiments, I/O interface 130 allows communication through one or more appropriate buses or other interfaces with one or more I/O devices, such as I/O device 140. For example, I/O device 140 can include one or more: physical user-interface devices (e.g., a physical keyboard, a mouse, a button, a touch-sensitive surface, a rotatable component, and/or a joystick), storage devices (e.g., as described above with respect to system memory 120), network interface devices (e.g., to a local and/or wide-area network), sensor devices (e.g., a camera, a microphone, a motion detector, and/or a temperature sensor), audio output devices (e.g., speaker, audio jacks, and/or hearing loops), and/or visual output devices (e.g., screen, light, and/or projector). In some embodiments, I/O device 140 includes a network interface device that enables computer system 100 to establish a wired or wireless connection to a network or other computer systems. Examples of network interface devices include Ethernet, USB, Bluetooth, NFC, Wi-Fi, and/or Thunderbolt communication devices. In some embodiments, I/O device 140 is wired or wirelessly connected to I/O interface 130.

In some embodiments, a component of computer system 100 incorporates I/O device 140 with other components. For example, a single component can include I/O interface 130 and I/O device 140. In some embodiments, I/O device 140 is a discrete component, meaning it is not incorporated into another part of computer system 100. In some embodiments, functionality of different components is integrated into a component of computer system 100 that is composed of I/O interface 130 and I/O device 140. Additionally, it should be acknowledged that computer system 100 can include one or more I/O interfaces that connect to one or more I/O devices.

In some embodiments, I/O device 140 can be used to detect a subject (e.g., a user, a person, an animal, another computer system different from computer system 100, and/or an object) and/or an input (e.g., a verbal input, a tap input, a swipe input, a hold-and-drag input, a gaze input, an air-gesture input, a physical input and/or a passive input) from a detected subject. In some embodiments, a user has an account enabled by and/or linked to computer system 100, and computer system 100 can determine if a detected subject is a user with an account (e.g., a known user). Determining if a detected subject has an account includes identifying and/or authenticating the detected subject. In some embodiments, identifying and/or authenticating the detected subject includes comparing detected information to stored information about known users. For example, comparing detected information can include comparing biometric data (e.g., facial scans, iris scans, fingerprint scans, and/or voice recognition data) of detected subjects to stored biometric data of known users. For another example, comparing detected information can include comparing detected identification (e.g., MAC address and/or IP address) of a computer system of a detected subject to known identifications of computer systems of known users. For yet another example, comparing detected information can include comparing detected passcodes (e.g., usernames, passwords, passphrases, and/or PINs). In another example, computer system 100 can detect a known user (e.g., a user that corresponds to an account) and allow access to an environment when the user is identified. In some embodiments, computer system 100 detects unknown subjects and enables guest accounts for the unknown subjects to utilize computer system 100.

In some embodiments, computer system 100 collects information without the need for physical inputs via a sensor of I/O device 140. For example, computer system 100 can recognize subject inputs, including air-gesture inputs and/or passive inputs via a camera. In some embodiments, an air-gesture input is that is a detected intentional motion of a portion of the subject's body without the subject touching an input element in communication with or of the device. In some embodiments, a passive input is a detected input that is not purposefully directed at computer system 100 and/or a component in communication with computer system 100. Examples of passive inputs that can be detected by a camera include, but are not limited to, the subject entering an environment, the motion of the subject through an environment, the location of the subject in the environment, the direction the subject is looking and/or facing, and/or light levels of the environment. In some embodiments, computer system 100 can send visual and/or video data to an application from one or more cameras. For example, computer system 100 can send video data to an application for the purpose of making a video phone call. For another example, computer system 100 can detect the sound of a subject talking, glass breakings, and/or music playing via a microphone of I/O device 140. In some embodiments, computer system 100 recognizes speech as verbal a input from a subject that are detected via a microphone.

In some embodiments, computer system 100 detects information about the environment via other types of sensors of I/O device 140. Examples of such sensors include a flow sensor, a gas sensor, a humidity sensor, a chemical sensor, a contact sensor, a precipitation sensor, a pressure sensor, a proximity sensor, a motion sensor, an occupancy sensor, an electricity sensor, and/or a flood sensor.

In some embodiments, computer system 100 detects a physical input via a physical user-interface device of I/O device 140 that allow a subject to communicate with computer system 100 directly. In some embodiments, computer system 100 includes one or more input devices as described above, and data from one input device is combined with data from one or more other input devices (e.g., that are a part of computer system 100 and/or other computer systems) to gather information about the physical environment.

In some embodiments, computer system 100 outputs visual information via a component of I/O device 140, such as a display screen, a projector, a touch-sensitive display, and/or a light. For example, I/O device 140 can include a light to indicate a status of computer system 100, such as an on/off status. For another example, I/O device 140 can include a display screen for displaying user interface elements. In some embodiments, “outputting” visual information includes sending data (e.g., image and/or video data) to an external display component via a wired or wireless connection, causing the external display component can display the visual information.

In some embodiments, computer system 100 emits sound via an audio output device of I/O device 140, such as a speaker, a headphone, an earbud, an audio jack, an optical audio output, a Bluetooth audio output, an HDMI audio output, and/or a hearing loop. For example, computer system 100 can provide a subject with information and/or audio-based content via speakers of I/O device 140.

In some embodiments, I/O device 140 includes a tactile output device. For example, I/O device 140 can include a haptic element that allows computer system 100 to communicate with a subject who is in close proximity to or in physical contact with computer system 100.

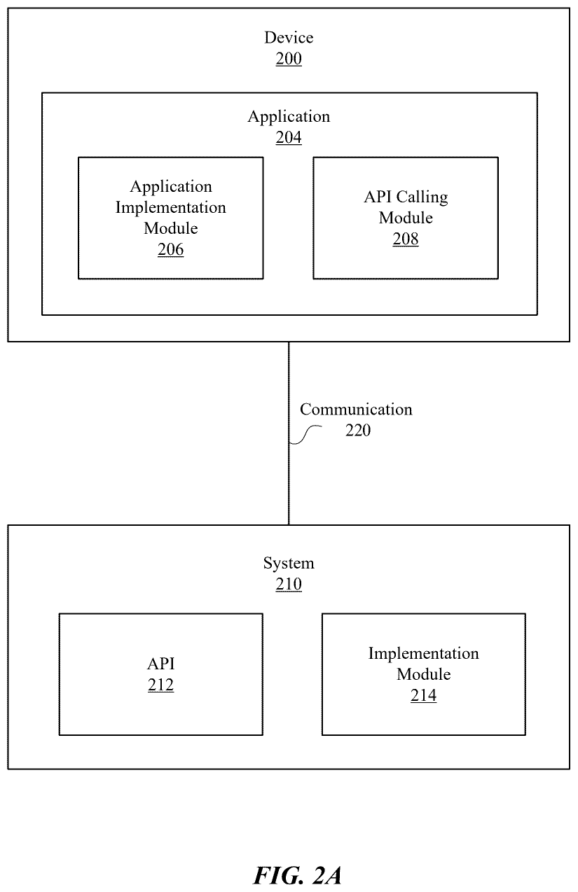

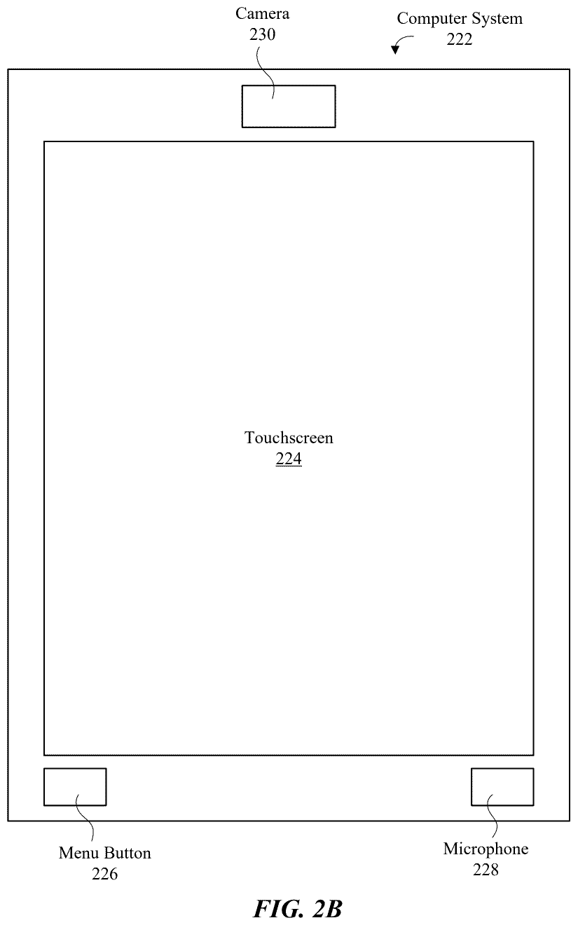

FIG. 2A is a block diagram illustrating a device and a system in accordance with some embodiments. In some embodiments, device 200 is a personal computing device, a server system, a smart phone, a smart watch, a tablet, a laptop computer, a fitness tracking device, a head-mounted display (HMD) device, a desktop computer, a communal device (e.g., a smart speaker, connected thermostat, and/or other home-based computer systems), an accessory (e.g., a switch, light, speaker, air conditioner, heater, window cover, fan, lock, media playback device, and/or television), a controller, a hub device, or a sensor. In some embodiments, system 210 is an operating system hosted on device 200. In some embodiments, system 210 is an operating system hosted on an external device (e.g., a server, a peripheral device, an accessory, and/or a personal computing device). It should be acknowledged that device 200 and/or system 210 can include more, fewer, and/or different components than illustrated in FIG. 2A.

As illustrated in FIG. 2A, device 200 includes an application (e.g., application 204) that, when executed by one or more processing units, causes device 200 to perform one or more processes and/or methods described herein. In some embodiments, application 204 is an application that is pre-installed on device 200 by a manufacture of device 200 (e.g., a first-party application). In some embodiments, application 204 is an application that is provided to device 200 via an operating system update file (e.g., a first-party application or a second-party application). In some embodiments, application 204 is an application that is installed by a user of device 200, such as through an application store installed on device 200. It should be acknowledged that application 204 can be any suitable type of application such a browser application, a fitness application, a health application, a digital payments application, a media application, a social network application, a messaging application, a maps application, and/or an application that functions as an execution environment for plug-ins, widgets and/or other applications. In some embodiments, application 204 causes device 200 to perform processes 500, 600, 800, 1000, 1100, 1200, 1400, 1500, and 1700 (FIGS. 5, 6, 8, 10, 11, 12, 14, 15, and 17).

In some embodiments, a software platform has a set of frameworks that provide objects and/or behaviors that a software developer uses to build applications on the software platform. Software developers use the set of frameworks to display and/or interact with content, and/or manage interactions with the software platform. In some embodiments, an application relies on the set of frameworks for their behavior. In such embodiments, the set frameworks can provide different ways for the software developer to customize behavior of the application to match specific needs of the application.

In some embodiments, interaction with a device includes transfer and/or receipt of one or more API calls between multiple different software processes (e.g., different portions of an operating system, an application and an operating system, or different applications) via one or more APIs. For example, when an input is detected, raw sensor data can be processed into one or more input events that are provided (e.g., via an API) to a receiving software process that makes some determination based on the one or more input events, and then sends (e.g., via an API) information to a software process to perform an operation (e.g., change a device state and/or user interface).

In some embodiments, an object and/or a behavior is accessed via an API, specifying a format for communication between processes, including specifying and grouping available protocols, variables, and/or functions. For example, an API call, sometimes referred to as an API request, can be sent from a first software process to a second software process as a way to accomplish different things. The first software process can request information from the second software process. The first software process can provide information to the second software process. The first software process can request action by the second software process. The first software process can provide information to the second software process about action taken by the first software process.

In some embodiments, while a determination and an operation performed in response can be made by the same software process, alternatively, a determination can be made in a first software process and relayed (e.g., via an API) to a second software process different from the first software process. Relaying the determination can cause an operation to be performed by the second software process. Alternatively, the second software process can relay one or more instructions (e.g., via an API) to a third software process different from the first software process and/or the second software process. The one nor more instructions can be to perform an operation.

It should be acknowledged that some or all subject interactions with a computer system can involve one or more API calls within a step of interacting with the computer system, such as between different software components of the computer system or between a software component of the computer system and a software component of one or more remote computer systems.

As illustrated in FIG. 2A, application 204 includes application implementation module 206 and API calling module 208. In some embodiments, application implementation module 206 includes a set of one or more instructions corresponding to one or more operations performed by application 204. For example, when application 204 is a messaging application, application implementation module 206 can include operations to receive and send messages.

In some embodiments, API calling module 208 is a module that can receive application programming interface (API) calls, respond to API calls, and/or send API calls. In some embodiments, application implementation module 206 communicates with API calling module 208 to communicate with a system, such as system 210. In some embodiments, communication 220 represents one or more API calls and/or one or more other forms of communication between device 200 (e.g., one or more components of device 200) and system 210 (e.g., one or more components of system 210).

As illustrated in FIG. 2A, system 210 includes API 212 and implementation module 214. In some embodiments, API 212 is a software and/or hardware module that can receive API calls, respond to API calls, and/or send API calls. In some embodiments, API 212 is a software module (e.g., a collection of computer-readable instructions) that provides an interface that allows a different module (e.g., API calling module 208) to access and/or use one or more functions, methods, procedures, data structures, classes, and/or other services provided by implementation module 214. For example, API calling module 208 can make an API call to API 212 to access and use a feature of implementation module 214 that is specified by API 212. In some embodiments, API 212 is implemented in part by firmware, microcode, or other low-level logic that executes in part on the hardware component.

In some embodiments, API calling module 208 passes data and/or controls information within implementation module 214 through the one or more API calls via API 212. In some embodiments, API 212 includes one or more features for translating API calls and returns between implementation module 214 and API calling module 208, which allows multiple API-calling modules written in different programming languages to communicate with implementation module 214. For example, API calling module 208 can call using APIs from different providers such as a set of APIs from an OS provider, another set of APIs from a plug-in provider, and/or another set of APIs from another provider (e.g., the provider of a software library) or creator of the other set of APIs.

In some embodiments, implementation module 214 is a system (e.g., operating system, and/or server system) software module that is constructed to perform an operation in response to receiving an API call via API 212. In some embodiments, implementation module 214 is constructed to provide an API response (via API 212) as a result of processing an API call. In some embodiments, implementation module 214 is embodied at least in part in firmware, microcode, or hardware logic. In some embodiments, implementation module 214 calls one or more other components via an underlying API and thus is both an implementation module and an API calling module similar to API calling module 208. For example, implementation module 214 and API calling module 208 can each be any one of an operating system, a library, a device driver, an API, an application program, or other module. It should be acknowledged that implementation module 214 and API calling module 208 can be the same or different type of module from each other.

In some embodiments, various API calls are transferred between API calling module 208 and implementation module 214. It should be acknowledged that transferring API calls can include issuing, initiating, invoking, calling, receiving, returning, and/or responding to a function of calls or messages. In other words, transferring API calls can describe actions by either API calling module 208 or implementation module 214. In some embodiments, in response to an API call from API calling module 208, implementation module 214 returns (via API 212) a value to report to application 204 the capabilities or state of a hardware component of device 200, such as input capabilities and state, output capabilities and state, processing capability, power state, storage capacity and state, and/or communications capability.

In some embodiments, implementation module 214 provides more than one API, with different APIs supplying different aspects of functionality performed by implementation module 214 while protecting some aspects of functionality from view. For example, one API of implementation module 214 can provide a first set of functions and can be exposed to third-party developers while another API of implementation module 214 can be hidden (e.g., not exposed) and provide a subset of the first set of functions and/or provide a different set of functions, such as testing or debugging functions which are not in the first set of functions. It should be acknowledged that implementation module 214 can include additional functions, methods, classes, data structures, and/or other features that are not specified through API 212 and are not available to API calling module 208. In some embodiments, implementation module 214, API 212, and/or API calling module 208 are stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, in response to and/or after receiving information from one or more hardware components of device 200, one or more software modules of device 200, and/or one or more hardware components external to device 200 (e.g., a peripheral device, an accessory device, and/or a server), application 204 executes a task with the information. In some embodiments, the tasks executed include: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling API 212 of system 210 based on the information. In some embodiments, after receiving the information, application 204 executes the task in response to a trigger, such as a detection of an event, a notification received from system 210, an input, and/or a response to a call to an API provided by system 210.

In some embodiments, application 204 calling API 212 (e.g., as part of a task executed by application 204 in response to and/or after receiving information) includes using one or more parameters defined by API 212. In some embodiments, the one or more parameters include a constant, a key, a data structure, an object, an object class, a variable, a data type, a pointer, an array, a list or a pointer to a function or method, and/or another way to reference a data or other item to be passed via API 212.

In some embodiments, in response to and/or after receiving the information, application 204 transfers the information to system 210 via communication 220. In some embodiments, after receiving the information, application 204 transfers the information to system 210 in response to a trigger.

FIG. 2B illustrates a computer system with a touch screen in accordance with some embodiments. In some embodiments, computer system 222 is a portable multifunction device that is a personal device of a user. It should be acknowledged that computer system 222 can be computer system 100 and/or device 200 as described above.

As illustrated in FIG. 2B, computer system 222 includes touch screen 224, touch screen 230, menu button 226, and microphone 228. In some embodiments, computer system 222 displays, via touch screen 224, a user interface (UI) including one or more user interface elements, such as controls, graphics, and/or content. Computer system 222 can then detect an input, such as a tap input using a finger of a user or a stylus, on a user interface element to select the user interface element. In some embodiments, the user interface element is selected when touch screen 223 no longer detects the input.

In some embodiments, microphone 228 is an input device for detecting sounds near computer system 222, including verbal inputs from a user. For example, computer system 222 can detect a subject making a verbal request and/or command to computer system 222 via microphone 228. In some embodiments, computer system 222 collects data and/or information about a subject via microphone 228. For example, computer system 222 can confirm an identity of a subject by matching a verbal input of the subject to a voice profile of a user. At FIG. 2B, microphone 228 is part of computer system 222. In some embodiments, microphone 228 is not part of but is in communication (e.g., via a wired and/or wireless communication) with computer system 222.

In some embodiments, camera 230 is an input device that includes an image or video sensor (such as one or more optical sensors and/or one or more depth sensors) that allows computer system 222 to detect objects and/or inputs (e.g., hand and/or air-gesture inputs) near computer system 222. In some embodiments, computer system 222 collects data and/or information about a subject via camera 230. For example, computer system 222 can confirm an identity a subject by matching a facial scan of a subject to a biometric profile of a user. At FIG. 2B, camera 230 is part of computer system 222. In some embodiments, camera 230 is not part of computer system 222 but is in communication (e.g., via a wired and/or wireless connection) with computer system 222. In some embodiments, camera 230 is always on and continuously capturing images (e.g., periodically and/or without interruption). In some embodiments, camera 230 begins to capture an image when an input and/or interaction is detected.

In some embodiments, menu button 226 is a physical button that, when depressed, provides a physical input for computer system 222. In some embodiments, touch screen 224 and/or menu button 226 are used for turning computer system 222 on and off and/or locking it. For example, menu button 226 can be used to lock computer system 222 by pressing and releasing menu button 226 before a predetermined amount of time (e.g., 2-10 seconds) has passed. For another example, menu button 226 can be used to unlock computer system 222 or start an unlocking process, or to turn computer system 222 on or off by pressing and holding menu button 226 in the depressed state for longer than the predetermined amount of time. In some embodiments, microphone 228 allows computer system 222 to detect a verbal input for turning on or off certain features. Additionally, computer system 222 can optionally have one or more tactile output devices to provide tactile outputs (e.g., haptic outputs) to the user and/or one or more contact intensity sensors to detect the intensity of contacts on touch screen 224

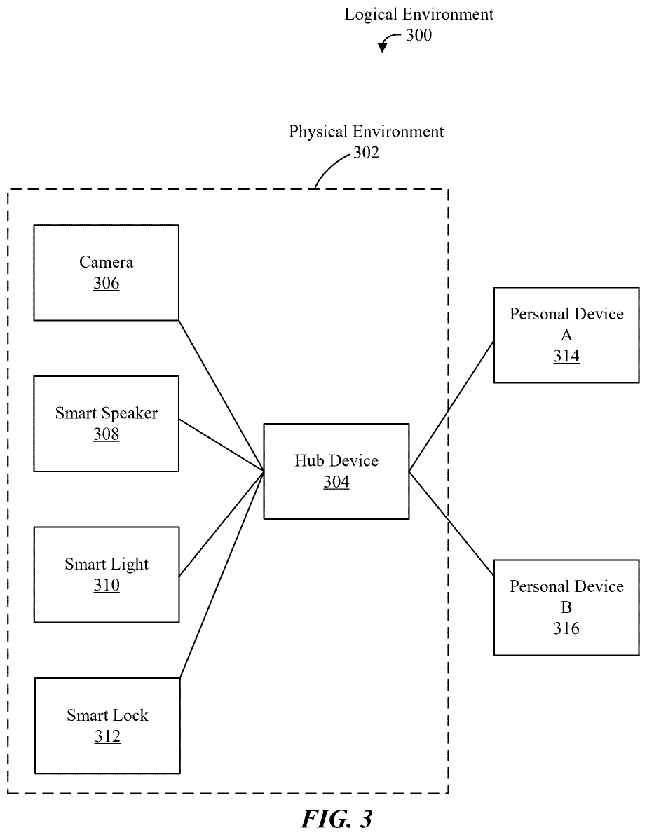

FIG. 3 is a block diagram illustrating a logical environment in accordance with some embodiments. As illustrated in FIG. 3, logical environment 300 includes multiple devices that are in communication (e.g., wired and/or wirelessly) with each other. In some embodiments, logical environment 300 is a software-defined construct that represents state, capabilities, and/or permissible interactions of devices within logical environment 300. For example, logical environment 300 can maintain a data model including (1) unique identifiers for different devices and/or assigned roles for each device, (2) a capability map describing supported functions and/or data formats, (3) a relationship graph indicating pairing status, hierarchy, and/or authorized communication paths, (4) contextual state parameters such as operating modes, user profiles, and/or session data, and/or (5) policy constraints that govern security, power management, and/or permissible commands. In some embodiments, logical environment 300 enables controller devices (e.g., hub device 304, personal device A 314, personal device B 316, and/or server 318) to discover, address, control, and/or configure accessory devices (e.g., camera 306, smart speaker 308, smart light 310, smart lock 310, and/or hub device 304). In such embodiments, logical environment 300 can be independent of underlying physical transports and/or physical location.

As illustrated in FIG. 3, logical environment 300 includes (e.g., involves) devices within physical environment 302 (e.g., camera 306, smart speaker 308, smart light 310, smart lock 312, and hub device 304). In some embodiments, physical environment 302 is a physical location, such a home, an office building, a warehouse, and/or an apartment building. It should be acknowledged that techniques described herein can be used with any type of physical location.

In some embodiments, the devices within logical environment 300 work together using one or more of the techniques described herein for detecting an activity in, interacting with, capturing sensor data related to, and/or communicating data about physical environment 302. Such control and/or communication can be via a homeowner and/or administrator of physical environment 302 and/or logical environment 300. In some embodiments, detecting an activity includes detecting and/or identifying a subject within physical environment 302. In some embodiments, in response to detecting the activity, a device (e.g., camera 306, smart speaker 308, smart light 310, smart lock 312, and/or hub device 304) within physical environment 302 captures sensor data in physical environment 302 and/or performs an operation. In such embodiments, the operation can includes allowing or denying a subject access to all or part of physical environment 302, turning on a light, and/or playing music.

At FIG. 3, devices illustrated within the dashed box of physical environment 302 are located within physical environment 302. Such devices include hub device 304, camera 306, smart speaker 308, smart light 310, and smart lock 312. In some embodiments, such devices and are in communication via one or more local area networks (e.g., WiFi and/or ethernet), one or more personal area network (e.g., Bluetooth, Zigbee, and/or Thread), one or more wide area networks (e.g., Internet and/or cellular), and/or one or more peer-to-peer connections.

At FIG. 3, devices illustrated outside the dashed box of physical environment 302 are located outside of physical environment 302 or are mobile with the ability to be inside or outside of physical environment 302. Such devices include personal device A 314, personal device B 316, and server 318. It should be acknowledged that logical environment 300 and physical environment 302 are described for explanatory purposes and that techniques described below can be carried out with more, less, similar, and/or different devices than the devices and/or the configurations discussed above.

In some embodiments, hub device 304 is a stationary or semi-stationary computer system that communicates with accessory devices located within physical environment 302 including, but not limited to, camera 306, smart speaker 308, smart light 310 and/or smart lock 312. In some embodiments, hub device 304 communicates with one or more accessory devices on behalf of (e.g., communicates information to and/or from) one or more controller devices, such as personal device A 314 and/or personal device B 316. In some embodiments, hub device 304 provides centralized coordination, routing, and/or persistent data storage for physical environment 302. In some embodiments, hub device 304 includes a component for detecting other devices, such as a camera, a microphone, and/or Bluetooth and/or Ultra-Wideband (UWB) component. While hub device 304 is depicted in FIG. 3 as a single device, the functionality described below can be implemented with two or more resident devices operating together. Examples of hub device 304 include a smart speaker, a set-top box, a router, a home-automation bridge, a television, and/or a desktop computer.

In some embodiments, hub device 304 communicates with devices outside of physical environment 302. For example, hub device 304 can communicate with other hub devices that belong to different environments. For another example, hub device 304 can communicate with other accessory devices and/or other controller devices. In such embodiments, hub device 304 communicates with other devices through one or more communication channels described above (e.g., a local area network, a personal area network, a peer-to-peer connection, and/or a wide area network).

In some embodiments, hub device 304 includes and/or is in communication with one or more cameras with which hub device 304 can capture an image and/or a video of a subject and/or activity within physical environment 302. In some embodiments, hub device 304 includes and/or is in communication with one or more microphones with which hub device 304 can detect noise (e.g., glass breaking, an alarm going off, and/or a subject talking) within physical environment 302. In some embodiments, a microphone enables hub device 304 to detect verbal inputs from a subject, enabling the subject to interact with hub device 304 without making physical contact with hub device 304 or another computer system within physical environment 302.

In some embodiments, hub device 304 includes and/or is in communication with one or more sensors. In some embodiments, a sensor includes a hardware component capable of detecting (e.g., sensing and/or processing) information about physical environment 302 in proximity to the hardware component. For example, a sensor can be configured to detect information surrounding the sensor, detect information in one or more directions away from the sensor, and/or detect information based on contact of the sensor with an element of physical environment 302. In some embodiments, a hardware component of a sensor includes a sensing component (e.g., a temperature and/or image sensor), a transmitting component (e.g., a radio transmitter and/or laser transmitter), and/or a receiving component (e.g., a radio receiver and/or laser receiver). It should be acknowledged that a sensor can be multiple types of sensors. For example, a sensor can be an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a motion sensor, a range or depth sensor (e.g., RADAR and/or LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. In some embodiments, hub device 304 combines data from multiple sensors to generate information about physical environment 302.

In some embodiments, hub device 304 includes and/or is in communication with one or more speakers that can output audio content into physical environment 302. In some embodiments, hub device 304 includes and/or is in communication with one or more display components, such as a display, a projector, a touch-sensitive display, a head-mounted display (HMD), and/or another device component that presents visual content to a subject. In some embodiments, hub device 304 includes and/or is in communication with a touch-sensitive surface (such as a touchpad or a touch screen display) from which hub device 304 detects inputs.

In some embodiments, camera 306 is a computer system for capturing and/or recording images in the form of digital photos and/or videos. In some embodiments, camera 306 includes and/or is in communication with one or more sensors, such as those mentioned above with respect to hub device 304. In some embodiments, camera 306 captures an image and/or a video continuously and/or in response to detecting an activity via a sensor. In some embodiments, camera 306 combines data from multiple sensors (e.g., that are part of camera 306 and/or one or more additional devices in communication with camera 306) to generate information about physical environment 302. While camera 306 is presented as an individual device, it should be acknowledged that camera 306 can represent multiple devices capable of capturing images and/or videos. For example, camera 306 can include cameras positioned to observe important areas of physical environment 302, such as an entrance, a hallway, and/or a living room area.

In some embodiments, smart speaker 308 is a computer system that converts electrical signals into sound and includes one or more components for outputting audio, such as speakers, audio distributors, soundbars, headphones, earphones, earbuds, television speakers, HMD speakers, audio jacks, optical audio outputs, Bluetooth audio outputs, and/or HDMI audio outputs. For example, smart speaker 308 can output audio content to provide information to a subject. In some embodiments, smart speaker 308 includes one or more microphones that can be used by smart speaker 308 to obtain data and/or information from a subject and/or about physical environment 302. For example, smart speaker 308 can detect if a subject is in the room by detecting a subject talking via a microphone. In some embodiments, the information that smart speaker 308 obtains via the microphone includes verbal inputs from a subject. For example, a subject can request smart speaker 308 to perform an action and/or obtain information for the subject. While smart speaker 308 is presented as an individual device, it should be acknowledged that smart speaker 308 can represent multiple devices capable of outputting audio.

In some embodiments, smart light 310 is a computer system for outputting light and includes one more components for outputting light, such as an incandescent, LED, fiber optic, fluorescent, halogen, and/or neon light. In some embodiments, smart light 310 includes and/or is in communication with one or more sensors, such as those mentioned above with respect to hub device 304. In some embodiments, smart light 310 outputs light or ceases outputting light in response to detecting an activity via a sensor. For example, smart light 310 can turn on in response to detecting a sound via a microphone. For another example, smart light 310 can turn off in response to detecting light from another light source via a light sensor. While smart light 310 is presented as an individual device, it should be acknowledged that smart light 310 can represent multiple devices capable of outputting light.

In some embodiments, smart lock 312 is a computer system for locking and unlocking an area and includes one or more components for such locking, such as a deadbolt, mortise, electromagnet, and/or latch lock. In some embodiments, smart lock 312 includes and/or is in communication with one or more sensors, such as those mentioned above with respect to hub device 304, and locks or unlocks in response to detecting an activity via a sensor. For example, smart lock 312 can lock in response to detecting a contact sensor close, indicating that a door has closed. In some embodiments, smart lock 312 includes and/or is in communication with an input component capable of detecting physical inputs, such as a physical input mechanism (e.g., one or more buttons) and/or a touch sensitive surface and/or screen, and locks or unlocks in response to detecting inputs via the input component. For example, smart lock 312 can unlock in response to detecting a correct PIN code being entered via the input component. In some embodiments, smart lock 312 includes a component for detecting other devices, such as Bluetooth, UWB, and/or Near Field Communication (NFC) component, and locks or unlocks in response to detecting another device. For example, smart lock 312 can unlock in response to detecting, via UWB, a personal device of a user approach smart lock 312. While smart lock 312 is presented as an individual device, it should be acknowledged that smart lock 312 can represent multiple devices capable of locking and unlocking areas.

Personal device A 314 and personal device B 316 are computer systems belonging to users and/or groups of users. For example, personal device A 314 and/or personal device B 316 can be a smart phone, a tablet, a smart watch, a laptop, a communal device, a personal gaming system, a desktop computer, a fitness tracking device, and/or an HMD. In some embodiments, personal device A 314 and personal device B 316 are the same type of device. For example, both personal device A 314 and personal device B 316 can both be smart phones. In other embodiments, personal device A 314 and personal device B 316 are different types of devices. For example, personal device A 314 can be a smartwatch while personal device B 316 can be a smart phone.

In some embodiments, server 318 is a remotely accessible digital storage system, that is hosted by a service provider and accessible by registered devices of logical environment 300 (e.g., hub device 304 and/or other device with appropriate user credentials). In some embodiments, hub device 304 communicates with server 318 via a wired or wireless connection, such as Wi-Fi, ethernet, and/or cellular network.

In some embodiments, one or more devices within logical environment 300 communicate with hub device 304 about an activity detected within physical environment 302. For example, in response to unlocking, smart lock 312 can communicate the unlocking to hub device 304. In some embodiments, in response to a device communicating a detected activity, hub device 304 captures a photo and/or a video of physical environment 302 (e.g., via camera 306 and/or a camera of hub device 304). For example, in response to smart speaker 308 communicating about detecting a noise, hub device 304 can send a command to camera 306 to capture video of physical environment 302 near smart speaker 308. In some embodiments, one or more devices within logical environment 300 send information (e.g., images, video, audio, inputs and/or status updates from sensors) regarding an activity to hub device 304 and, in response, hub device 304 analyzes the information. For example, when camera 306 captures a video in response to detecting motion (e.g., as discussed above), camera 306 can send the video to hub device 304 to analyze. For example, hub device 304 can analyze a captured image of physical environment 302 that includes smoke and determine a fire is in physical environment 302.

In some embodiments, devices outside of hub device 304 analyze data to make determination. For example, camera 306 can determine an identity of a subject within an image and send the identity to hub device 304 rather than sending the image. For another example, in response to smart lock 312 detecting the presence of a personal device of a user (e.g., personal device A 314), hub device 304 can request camera 306 to capture an image. After capturing the image, camera 306 can identify a subject in the image to determine whether the image includes the user.

In some embodiments, after a subject is identified (e.g., such as using camera 306 as described above), hub device 304 initiates an authentication process to authenticate the subject. The authentication process can verify and/or confirm the identity of the subject in physical environment 302. For example, if the subject is registered with hub device 304, in conjunction with identifying the subject (e.g., via camera 306 as described above), hub device 304 communicates with a personal device (e.g., personal device A 314 or personal device B 316) registered to the subject through wireless signal (e.g., UWB signal, Bluetooth signal, and/or Wi-Fi signal) to authenticate the subject. In some embodiments, hub device 304 captures and/or receives multiple types of information at once and is able to identify and authenticate the subject simultaneously. For example, in a scenario where the subject in physical environment 302 is speaking while being within the field-of-view of camera 306, hub device 304 can identify the subject using an image captured via camera 306 using facial recognition and authenticate the subject using audio captured via smart speaker 308 to match voice biometrics. In some embodiments, hub device 304 receives an authentication key (e.g., PIN code and/or key fob authenticator) for a user (such as when the user enters the authentication key at smart lock 312) and uses the fact that the authentication key corresponds to same user as detected in physical environment 302 via another device, such as camera 306, to authenticate the user.

In some embodiments, when a subject is identified and not authenticated, hub device 304 sends an authentication request to a personal device (e.g., personal device A 314 or personal device B 316) of the subject. For example, hub device 304 can send a request for a facial scan and/or a PIN to personal device A 314, and consider the subject authenticated upon receiving a notification from personal device B 316 that correct information has been entered and/or received. In some embodiments, hub device 304 sends an authentication request to a personal device detected within physical environment 302.

In some embodiments, personal device B 316 is a personal device (e.g., phone, watch and/or tablet) belonging to an administrator (e.g., a resident, owner, and/or caretaker) of logical environment 300. Personal device B 316 can be in communication with hub device 304, and allow the administrator to view and/or remotely control aspects of logical environment 300, such as managing camera views and/or visitor access. In some embodiments, in response to detecting an inquiry (e.g., “Who is at the door?” and/or “Is anyone home?”), personal device B 316 sends a request to hub device 304 to capture an image (e.g., via camera 306) and send the image to personal device B 316. It should be acknowledged that communication between devices within physical environment 302 and personal device B 316 can occur even when personal device B 316 is outside physical environment 302, such as through a secure outside internet or cellular connection.

In some embodiments, hub device 304 sends a notification to personal device B 316 in response to detecting (e.g., directly and/or via another device of logical environment 300) an activity. For example, hub device 304 can send a notification to personal device B 316 in response to not being able to identify a subject detected in physical environment 302. In some embodiments, the notification sent by hub device 304 to personal device B 316 includes information corresponding to a time and/or a location that the activity and/or subject was detected. In some embodiments, the notification includes an image and/or a video of the activity. For example, the notification can include a video of smoke filling a room where smoke was detected. In some embodiments, the notification includes identifying information (e.g., name, photo, and/or video) of the subject in physical environment 302. In some embodiments, hub device 304 sends a notification without sending images to personal device B 316. For example, an administrator might want to be notified if someone they recognize is at the front door without showing a video feed of a camera at the front door. For another example, the notification might not require an image, such as a notification that a thermostat has detected a temperature outside of a predetermined range. In other embodiments, hub device 304 does not send a notification if certain identified subjects are detected, thus avoiding unnecessary notifications (e.g., an administrator might not care to be notified if their spouse or roommate is detected at the front door).

In some embodiments, the notification sent by hub device 304 to personal device B 316 includes an option to authenticate a detected subject via the notification (e.g., a control within the notification and/or an application corresponding the notification). In some embodiments, if the detected subject is identified, the notification includes a control to initiate communication (e.g., text and/or call) with the detected subject. In some embodiments, the notification includes a control to initiate communication with a subject detected in physical environment 302 via smart speaker 308. In some embodiments, the notification includes escalation options such as a control contacting emergency services. In some embodiments, the administrator corresponding to personal device B 316 creates a profile for a subject in physical environment 302 that automatically authenticates the subject.

In some embodiments, devices within physical environment 302 output content to communicate information to a subject within physical environment 302. For example, in response to a subject being identified but not authenticated, hub device 304 can output via smart speaker 308 a request for the subject to authenticate themselves. For another example, in response to detecting a door being opened, hub device 304 can indicate the door is opened by outputting light via smart light 310 near the door. In some embodiments, devices within physical environment 302 output content to communicate an event escalation. For example, in response to personal device B 316 detecting an input on the control to contact emergency services (e.g., as described above), smart light 310 can flash its lights and smart speaker 308 can output alarm noises.

In some embodiments, hub device 304 allows communication with administrators of logical environment 300. For example, a person in physical environment 302 can request to call an administrator of logical environment 300 (e.g., initiate a call to personal device B 316) to request access to physical environment 302 and/or devices within physical environment 302. In some embodiments, hub device 304 detect such a request directly or via an input on a personal device (e.g., personal device A 314). In such embodiments, the administrator can give allowance to subject in physical environment 302 and personal device B 316 communicates to hub device 304 that the subject in physical environment 302 has been authenticated.

In some embodiments, after the subject in physical environment 302 is identified and authenticated, hub device 304 enables the subject access to physical environment 302 and/or one or more devices with physical environment 302. In some embodiments, hub device 304 enables the subject access to physical environment 302s for a predefined amount of time (e.g., 1 hour to 10 days). In such embodiments, the predefined amount of time can vary depending on the type of authorization provided to the subject. For example, a guest of physical environment 302 can have access for less time than a temporary resident of physical environment 302.

In some embodiments, data about activities detected within physical environment 302 is recorded and stored. Some or all of such activity data can be stored locally and/or on server 318. Storing activity data can allow an administrator of physical environment 302 to review a history of activity in physical environment 302.

Reference is made herein to environmental context (also referred to herein as a “context of an environment” and/or “a context corresponding to an environment”). In some embodiments, an environmental context is a context based on one or more characteristics of physical environment 302 (e.g., subjects, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) by detecting input (e.g., via one or more input devices) and/or receiving data (e.g., from one or more other devices and/or components in communication with the device).

Reference is made herein to user context (also referred to herein as a “context of a user” and/or “a context corresponding to a user”). In some embodiments, a user context is a context based on one or more characteristics of a user. For example, a user context can include a subject's appearance and/or clothing, personality, actions, behavior, movement, location, and/or pose. In some embodiments, a device (e.g., using an agent) determines a user context (e.g., to be currently true, occurring, and/or applicable) by detecting input (e.g., via one or more input devices) and/or receiving data (e.g., from one or more other devices and/or components in communication with the device). In some embodiments, a device determines user context based on historical context and/or learned characteristics of the subject, where one or more characteristics of the subject are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include an internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) by detecting input (e.g., via one or more input devices) and/or receiving data (e.g., from one or more other devices and/or components in communication with the device). In some embodiments, a device (e.g., using an agent) determines an operational context (e.g., to be currently true, occurring, and/or applicable) by assessing one or more internal states (e.g., accessed, retrieved, and/or queried by a process of the device).

Reference is made herein to “performing output,” “causing output,” “outputting,” and/or similar phrases. Such phrases can be interchangeable and/or include computer system itself performing such output or causing another computer system perform such output. Reference is made herein to “displaying,” “causing display of,” “outputting visual content,” and/or similar phrases. Such phrases can be interchangeable and/or include computer system itself displaying or causing another computer system perform such display. Reference is made herein to “outputting audio,” “causing output of audio,” “providing audio output,” and/or similar phrases. Such phrases can be interchangeable and/or include computer system itself outputting audio or causing another computer system perform such output.

Attention is now directed towards embodiments of user interfaces (“UI”) and associated processes that are implemented on an electronic device, such as computer system 100.

FIGS. 4A-4N illustrate exemplary user interfaces and techniques for authenticating subjects in accordance with some embodiments. The user interfaces in these figures are used to illustrate the processes described below, including the processes in FIGS. 5-6.

FIGS. 4A-4N illustrate resident device 400 on the left, personal computer system 424 in the middle, and schematic 448 on the right. Schematic 448 is a representation of a location (e.g., a home, building, office building and/or an outdoor environment). Schematic 448 includes representation of resident device 460 and representation of camera 414 (e.g., a representation of the camera within the location). Representation of resident device 460 is a representation of resident device 400 and representation of camera 414 that is a representation of one or more cameras within the environment. At FIG. 4A, schematic 448 includes representation 472. Representation 472 is a representation of a subject named John who is an administrator. In some embodiments, an administrator is someone who is registered with resident device 400. In some embodiments, an administrator is someone who is an owner of the location (e.g., a homeowner).

At FIGS. 4A-4N, resident device 400 is in communication with personal computer system 424 and/or the camera. It should be recognized that resident device 400 is an example of a resident computer system. In some embodiments, a resident computer system is a central computer system within the location that connects to and/or communicates with computer systems and/or accessories within the home environment that pertain to a common eco-system. In some embodiments, a resident computer system is a communal device.

As illustrated in FIG. 4A, resident device 400 displays home screen user interface 412. Home screen user interface 412 includes an indication of the date (e.g., “October 11”) and the time (e.g., “8:30 AM”) of the current day. At FIG. 4A, resident device 400 is in communication with personal computer system 424 and the camera.

FIGS. 4A-4N illustrate personal computer system 424 as a smart phone. It should be recognized that personal computer system 424 can be other types of computer systems such as a tablet, a smart watch, a laptop, a communal device, an accessory, a personal gaming system, a desktop computer, a fitness tracking device, and/or a head-mounted display (HMD) device. In some embodiments, personal computer system 424 includes and/or is in communication with one or more input devices (e.g., a sensor, a camera, a lidar detector, a motion sensor, an infrared sensor, a touch-sensitive surface, a physical input mechanism, and/or a microphone). In some embodiments, personal computer system 424 includes and/or is in communication with one or more output devices (e.g., a display screen, a projector, a touch-sensitive display, and/or a speaker). In some embodiments, personal computer system 424 includes one or more components and/or features described above in relation to computer system 100 and/or electronic device 200. As illustrated in FIG. 4A, personal computer system 424 displays lock screen user interface 436. Lock screen user interface 436 includes an indication of the date (e.g., “Friday, October 11”) and time (e.g., “8:30”) of the current day. It should be recognized that personal computer system 424 is the personal computer system of the administrator, John.

FIGS. 4A-4B illustrate a scenario where a subject is identified and automatically authenticated as the subject approaches resident device 400. At FIG. 4A, John (e.g., the administrator) is walking towards resident device 400 (e.g., as indicated by the arrow originating from representation 472 and being directed towards representation of resident device 460 within schematic 448). At FIG. 4A, the camera detects that John is walking towards resident device 400.

In between FIGS. 4A and 4B, the camera identifies John. The camera is able to identify John by capturing an image and/or video of John and comparing the image and/or video of John to previously captured images and/or videos of John. More specifically, the camera compares the face of John in the newly captured image and/or video and compares the face of John in the newly capture image and/or video to the face of John in previously captured images and/or videos. In some embodiments, the camera identifies John by capturing a recording of the voice of John and comparing the voice recording to previously captured voice recordings of John. In between FIGS. 4A and 4B, the camera transmits the identification of John to resident device 400. In some embodiments, the camera initiates the identification of a detected subject based on a determination that resident device 400 detects a request to identify the detected subject. For example, the camera initiates the identification of a detected subject based on a determination that the detected subject selects a user interface object that is displayed via resident device 400 that corresponds to a request to identify the detected subject.

In some embodiments, the camera initiates the identification of a detected subject based on a determination that the subject is positioned at a particular location. For example, the camera initiates the process of identifying John based on a determination that John is positioned in front of resident device 400. In some embodiments, the camera initiates the identification of a subject based on a determination that the subject is within a predetermined distance of resident device 400. For example, based on a determination that John is within five feet of the resident device 400, the camera initiates the process of identifying John. In some embodiments, in a scenario where the camera detects multiple subjects, the camera serially identifies the detected subjects. In some embodiments, when the camera detects multiple subjects, the camera simultaneously identifies each detected subject.

In between FIGS. 4A and 4B, based on the successful identification of John, the camera transmits the identification of John to resident device 400. Of note, the camera transmits the identification of John to resident device 400 without transmitting an image and/or video of John to resident device 400.

At FIG. 4B, in response to receiving the identity of John, resident device 400 initiates an authentication process. At FIG. 4B, resident device 400 automatically (e.g., without intervening user input) authenticates John by communicating with personal computer system 424 (e.g., personal computer system 424 of John) through a wireless signal (e.g., Bluetooth signal, UWB signal, and/or Wi-Fi signal). In some embodiments, resident device 400 automatically authenticates John based on resident device 400 performing a voice analysis in response to detecting John speak. In some embodiments, resident device 400 is able to automatically authenticate John via personal computer system 424 because John is registered with resident device 400. In some embodiments, the duration that a subject is authenticated for is different for different types of subjects. For example, a subject that is registered with resident device 400 is authenticated for a longer period of time than a subject that is not registered with resident device 400. In some embodiments, resident device 400 must authenticate John within a predetermined amount of time (e.g., 1-20 minutes) of John being identified by the camera. In some embodiments, resident device 400 is able to authenticate John based a determination that a predefined amount of time has not elapsed since resident device 400 has communicated with personal computer system 424. For example, based on determination that ten seconds have passed since resident device 400 has communicated with personal computer system 424, resident device 400 automatically authenticates John.

As illustrated in FIG. 4B, because resident device 400 receives the identification of John and automatically authenticates John, resident device 400 displays notification 484. Notification 484 is an indication welcoming John to the location. As illustrated in FIG. 4B, notification 484 includes image 484a that is an image of the of John. In some embodiments, image 484a is an image that John has selected for a profile correspond on resident device 400. In some embodiments, image 484a is an image captured by one or more cameras of resident device 400. In some embodiments, rather than display notification 484, resident device 400 audibly outputs, “Welcome home, John” in response to automatically authenticating John. In some embodiments, because resident device 400 receives the identification of John and automatically authenticates John, resident device 400 illuminates a portion of itself to help guide John to a security feature (e.g., security pad and/or mechanical lock) of resident device 400.

It should be recognized that the first step of the above-described authentication process is the identification of John by the camera and the second step of authentication process is resident device 400 communicating with personal computer system 424 (e.g., the personal computer system of John) to verify the identity of John. In some embodiments, resident device 400 authenticates a subject by detecting one or more biometrics (e.g., face, voice analysis, and/or fingerprints) of the subject. In other embodiments, resident device 400 authenticates a subject in response to receiving a message from a personal device of an administrator (e.g., homeowner). In some embodiments, resident device 400 authenticates a subject in response to detecting the presence of a computer system of the subject. It should be recognized that any of the abovementioned steps of authentication combined with a successful identification can result in a successful two factor authentication.

FIGS. 4C-4D illustrate a scenario where a Tai is identified and automatically authenticated using the above-described process. In some embodiments, Unlike John, Tai is not an administrator (e.g., Tai is not a homeowner and/or Tai is not a resident of the location) At FIGS. 4C and 4D, schematic 448 includes representation 430. Representation 430 is representative of the positioning of Tai within the location. At FIG. 4C, as indicated by the arrow extending from representation 430 towards representation of resident device 460, representation 430 is moving towards representation of resident device 460. Accordingly, at FIG. 4C, Tai is walking towards resident device 400. At FIG. 4C, the camera detects Tai as moving towards resident device 400.

In between FIGS. 4C and 4D, in response to detecting that Tai is moving towards resident device 400, the camera identifies Tai. In between FIGS. 4C and 4D, the camera captures an image and/or a video of Tai and compares the face of Tai in the newly capture images and/or videos to previously captured images and/or videos of Tai that are stored on the camera. Based on the comparison of the newly captured images and/or videos and the previously captured images and/or videos, the camera is able to identify Tai. In between FIGS. 4C and 4D, in response to successfully identifying Tai, the camera transmits the identification of Tai to resident device 400.

At FIG. 4D, in response to receiving the identity of Tai, resident device 400 initiates the authentication process. At FIG. 4D, Tai has stopped in front of resident device 400. At FIG. 4D, resident device 400 is able to automatically authenticate Tai through communicating with a personal computer system (e.g., smartphone, smartwatch, and/or tablet) of Tai. In some embodiments, resident device 400 is able to automatically authenticate Tai based on a detection that Tai has recently used a PIN code specific to Tai on an accessory device (e.g., smart lock, smartwatch, smartphone) in close proximity to and/or in communication with resident device 400.

At FIG. 4D, in response to automatically authenticating Tai, resident device 400 displays notification 420. Notification 420 is an indication welcoming Tai to the location. As illustrated in FIG. 4D, notification 420 includes image 420a which is an image of Tai. In some embodiments, rather than display notification 420, resident device 400 audibly outputs, “Welcome home, Tai.” in response to authenticating Tai. At FIG. 4D, based on the successful identification and authentication of Tai, resident device 400 transmits a notification to personal computer system 424 that includes an indication that Tai has been successfully identified and authenticated.

As illustrated in FIG. 4D, in response to receiving notification, personal computer system 424 displays notification 404. Notification 404 provides an indication that Tai is at the location (e.g., Tai is at the home of John). In some embodiments, along with displaying notification 404, personal computer system 424 audibly outputs “Tai is at your home” in response to receiving the notification.

As illustrated in FIG. 4D, notification 404 includes guest status indication 404a, image 404b, view activity control 404c, and message control 404d. Guest status indication 404a provides a status (e.g., “Tai is at your home” and “Entered at 9:42 AM”) of the subject that was authenticated and identified. Image 404b is an image of the detected subject (e.g., Tai). In some embodiments, in response to detecting an input directed to view activity control 404c, personal computer system 424 ceases display of notification 404 and displays an activity user interface that includes user interfaces elements corresponding to the detected activities of Tai at the location. In some embodiments, in response to detecting an input directed to message control 404d, personal computer system 424 ceases display of notification 404 and displays a messaging user interface for drafting and sending a message to resident device 400.

FIGS. 4E-4H illustrate a scenario where a detected subject named Sandra must manually authenticate herself. At FIGS. 4E-4H, schematic 448 includes representation 408 that is representative of the positioning of Sandra within the location. At FIG. 4E, schematic 448 depicts representation 408 as moving towards representation of resident device 460. Accordingly, at FIG. 4E, Sandra is walking towards resident device 400. At FIG. 4E, the camera detects Sandra as moving towards resident device 400.

In between FIGS. 4E and 4F, based on the detection of Sandra as moving towards resident device 400, the camera identifies Sandra. The camera is able to identify Sandra by capturing an image and/or video of Sandra and comparing the image and/or video of Sandra to previously captured images and/or videos of Sandra. More specifically, the camera accessory compares the face of Sandra in the newly captured image and/or video and compares it to the face of Sandra in previously captured images and/or videos. In between FIGS. 4E and 4F, in response to successfully identifying Sandra, the camera sends the identity of Sandra to resident device 400.

At FIG. 4F, in response to receiving the identity of Sandra, resident device 400 initiates the authentication process. At FIG. 4F, Sandra has stopped in front of resident device 400. At FIG. 4F, resident device 400 is unable to automatically authenticate Sandra (e.g., resident device 400 is not able to communicate with a personal device of Sandra (e.g., the personal device Sandra is not in the possession of Sandra and/or the personal device is not within range of resident device 400) and/or resident device 400 is not able to authenticate Sandra via a different method). At FIG. 4F, because resident device 400 is unable to authenticate Sandra, resident device 400 displays notification 466. Notification 466 is an indication of welcoming Sandra to the location and requesting that Sandra manually authenticate herself. In some embodiments, resident device 400 audibly outputs a request for Sandra to enter her PIN (e.g., “Please enter your PIN code.”) when resident device 400 is unable to automatically authenticate.

As illustrated in FIG. 4F, notification 466 includes image 466b. Image 466b is an image of Sandra). In some embodiments, image 466b is a profile picture for Sandra that the administrator (e.g., John) has selected. In some embodiments, image 466b is an image captured by a camera connected to and/or in communication with resident device 400. In some embodiments, notification 466 includes a user interface element that allows Sandra to begin to initiate an authentication process (e.g., “Enter PIN”).

At FIG. 4G, because resident device 400 is unable to automatically authenticate Sandra, resident device 400 ceases display of home screen user interface 412 and notification 466 and displays authentication user interface 432. That is, in some embodiments, resident device 400 automatically displays authentication user interface 432 when resident device 400 is unable to automatically authenticate a subject. In some embodiments, resident device 400 displays authentication user interface 432 in response to detecting an input after resident device 400 is unable to automatically authenticate a subject. In some embodiments, resident device 400 displays authentication user interfaced 432 based on a determination that the detected subject has a PIN code and the subject is unable to be automatically authenticated. Authentication user interface 432 includes an indication requesting that Sandra enter her PIN code (e.g., “Hi Sandra” and “Please enter PIN”) and PIN region 450. As illustrated in FIG. 4G, PIN region 450 includes a series of number and/or letter controls corresponding to the entry of a unique PIN code, including PIN control 450a (e.g., “1”), PIN control 450b (e.g., “3”), PIN control 450c (e.g., “7”) and PIN control 450d (e.g., “9”).

In some embodiments, when resident device 400 is unable to automatically authenticate a detected subject, resident device 400 causes a personal computer system of the detected subject to initiate an authentication process on the personal computer system of the detected subject. In some embodiments, rather than display authentication user interface 432, resident device 400 audibly outputs a request that the detected subject speak such that resident device 400 can authenticate the subject by voice. In some embodiments, when resident device 400 is unable to automatically authenticate the detected subject, resident device 400 causes a different computer system positioned within the location to display authentication user interface 432. For example, when resident device 400 is unable to automatically authenticate the detected subject, resident device 400 causes a tablet positioned within the location to display authentication user interface 432 such that the detected subject may authenticate themselves.

At FIG. 4G, resident device 400 detects input 405g1 directed to PIN control 450a, input 405g2 directed to PIN control 450b, input 405g3 directed to PIN control 450c, and input 405g4 directed to PIN control 450d (e.g., Sandra is entering her PIN code). It should be recognized that inputs 405g1-4 are examples of a selection input such as tap inputs but can be other inputs, such as a verbal input (e.g., “My PIN is 1379.”), an air gesture, and/or a button press.

At FIG. 4H, in response to detecting inputs 405g1-4, resident device 400 authenticates Sandra. As illustrated in FIG. 4H, based on the successful authentication of Sandra, resident device 400 ceases display of authentication user interface 432 and displays home screen user interface 412. At FIG. 4H, because Sandra is successfully authenticated, resident device 400 displays welcome indication 444 (e.g., “Welcome Sandra”) within home screen user interface 412. In some embodiments, in response to resident device 400 detecting an incorrect pin code entry, resident device 400 displays an indication notifying Sandra of the incorrect entry. For example, in response to detecting an incorrect PIN code entry, resident device 400 displays “PIN not recognized. Please try again.”

At FIG. 4H, in response to successfully authenticating Sandra, resident device 400 transmits an indication to personal computer system 424 (e.g., the personal computer system of the administrator) that Sandra is present at the location. As illustrated in FIG. 4H, in response to receiving the indication from resident device 400, personal computer system 424 displays notification 404 that includes an indication that Sandra is present at the location. Notification 404 includes guest status indication 404a (e.g., “Sandra entered your home” and “Entered PIN code at 10:00 AM”) and image 404e. It should be recognized that image 404e of Sandra and is the same image as image 466a that resident device 400 displays at FIG. 4F.

FIGS. 4I-4K illustrate a scenario in which the camera detects an unknown subject at the location. The unknown subject cannot be identified but is assigned a shared PIN code (e.g., a PIN code that is shared among a group of subjects). In this scenario, the shared PIN code is assigned to a company that employs the unknown subject.

As illustrated in FIG. 4I, schematic 448 includes representation 456 which is representative of an unknown subject at the location. At FIG. 4I, schematic 448 depicts representation 456 as moving towards representation of resident device 460. Accordingly, at FIG. 4I, the unknown subject is walking towards resident device 400. At FIG. 4I, the camera detects the unknown subject is walking towards resident device 400.

Between FIGS. 4I-4J, in response to detecting the unknown subject walking towards resident device 400, the camera attempts to identify the unknown subject. Between FIGS. 4I and 4J, the camera is unable to identify the unknown subject. That is, between FIGS. 4I and 4J, the camera captures a photo and/or video of the unknown subject. However, the camera does not have any previously captured images and/or videos of the unknown subject to compare the newly capture image and/or video against. Accordingly, the camera is not able to identify the unknown subject. In between FIGS. 4I and 4J, the camera sends a notification to resident device 400 that indicates that the camera is not able to identify the unknown subject.

As illustrated in FIG. 4J, in response to receiving the notification from the camera, resident device 400 displays identification user interface 468. Identification user interface 468 includes an indication that the camera was unable to identify the unknown subject (e.g., “Welcome” and “Home doesn't recognize you. Please identify yourself to home members.”). Identification user interface 468 also includes image 468a, PIN control 468b, and contact control 468c. As illustrated in FIG. 4J, because the camera was unable to identity the unknown subject, image 468a is a default image of an individual. In some embodiments, in response to detecting an input directed to PIN control 468b, resident device 400 ceases display of identification user interface 468 and displays authentication user interface 432, including PIN region 450 to allow the unknown subject to authenticate themselves. In some embodiments, in response to detecting an input directed to contact control 468c, resident device 400 ceases display of identification user interface 468 and sends a telecommunications connection request to personal computer system 424. In some embodiments, the telecommunications connection is a video call. In other embodiments, the telecommunications connection is a phone call. In other embodiments, in response to detecting an input directed to contact control 468c, rather than sending a telecommunications connection request to personal computer system 424, resident device 400 displays a messaging user interface to allow the composition and sending of a message to personal computer system 424.

It should be recognized that resident device 400 displays PIN control 468b and contact control 468c because the camera is unable to identify the unknown subject. It should also be recognized that resident device 400 does not display PIN control 468b and/or contact control 468c when a detected subject is successfully identified (e.g., as is the case in FIGS. 4B, 4D, and 4G above).

At FIG. 4J, because the unknown subject is not able to be identified, resident device 400 transmits a notification to personal computer system 424 that indicates that there is an unidentified subject at the location. As illustrated in FIG. 4J, in response to receiving the notification from resident device 400, personal computer system 424 displays notification 474. Notification 474 indicates that there is an unknown subject at the location. Notification 474 includes guest status indication 474a (e.g., “Unknown person at your home”), allow control 474b, get help control 474c, and image 474d. In some embodiments, in response to detecting an input directed to allow control 474b, personal computer system 424 authorizes the presence of the unknown subject at the location. In some embodiments, in response to detecting an input directed to get help control 474c, personal computer system 424 displays a user interface that allows the administrator to contact emergency services and/or an emergency contact. In some embodiments, because the identity of the unknown subject cannot be determined, image 474d is a default image that is representative of an individual. In some embodiments, rather than displaying image 474d, personal computer system 424 displays a live video feed of one or more cameras of resident device 400 within notification 474. In some embodiments, rather than displaying image 474d, personal computer system 424 displays a live video feed of one or more cameras of a computer system positioned at the location other than resident device 400.

In some embodiments, in response to receiving the notification from resident device 400, personal computer system 424 displays one or more controls that, when selected, causes personal computer system 424 to initiate a telecommunications connection with resident device 400 (e.g., such as a control that allows personal computer system 424 to initiate a phone call and/or video conference with resident device 400). At FIG. 4J, resident device 400 detects input 405j directed to PIN control 468b. It should be recognized that input 405j is an example of a selection input as a tap input but can be other inputs, such as a verbal input (e.g., “I can enter my PIN code”), an air gesture, and/or a button press.

As illustrated in FIG. 4K, in response to detecting input 405j, resident device 400 displays authentication user interface 432. As discussed above, authentication user interface 432 includes a series of number and/or letter controls corresponding to the entry of a unique PIN code, including PIN control 450a (e.g., “1”), PIN control 450b (e.g., “3”), PIN control 450d (e.g., “9”) and PIN control 450e (e.g., “0”). As illustrated in FIG. 4K, personal computer system 424 maintains display of notification 474 while personal computer system 424 displays authentication user interface 432.

At FIG. 4K, resident device 400 detects input 405kl directed to PIN control 450a, input 450k2 directed to PIN control 450b, input 450k3 directed to PIN control 450e, and input 405k4 directed to PIN control 450d (e.g., the unknown subject is entering the shared PIN code). It should be recognized that inputs 405k1-4 are examples of selection input as tap inputs but can be other inputs, such as a verbal input (e.g., “My PIN is 1309”), an air gesture, and/or a button press.

At FIG. 4L, in response to detecting inputs 405k1-4, resident device 400 authenticates the unknown subject. At FIG. 4L, based on the successful authentication of the unknown subject, resident device 400 ceases display of authentication user interface 432 and displays home screen user interface 412 with welcome indication 462 (e.g., “Welcome Dog Walkerz”). At FIG. 4L, based on the successful authentication of the unknow subject, resident device 400 transmits a notification to personal computer system 424 that indicates that a subject who is associated with the company who is assigned to the shared PIN code is at the location.

As illustrated in FIG. 4L, in response to receiving the notification from resident device 400, personal computer system 424 displays notification 404. Notification 404 includes guest status indication 404a (e.g., “Dog Walkerz entered” and “Entered PIN code at 7:59 AM), image 474d, view activity control 404c, and review control 404f. In some embodiments, in response to detecting an input directed to review control 404f, personal computer system 424 displays a profile user interface, allowing the administrator to create and/or edit a profile for the company.

FIGS. 4M-4N illustrate an alternative embodiment to what is shown in FIGS. 4K-4L. Either FIG. 4K or FIG. 4M can follow at FIG. 4L. At FIG. 4M, resident device 400 detects input 405m1 directed to contact control 468c. It should be recognized that input 405m1 is an example of a selection input as a tap input but can be other inputs, such as a verbal input (e.g., “Please call the homeowner”), an air gesture, and/or a button press.

At FIG. 4M, in response to detecting input 405m1, resident device 400 sends a telecommunication connection request to personal computer system 424. As illustrated in FIG. 4M, in response to receiving the telecommunication connection request, personal computer system 424 displays call user interface 416. Call user interface 416 includes call indication 416a (e.g., “Front door calling”), decline control 416b, and answer control 416c. Call indication 416a indicates who and/or the name of a device that is calling. In some embodiments, in response to detecting an input directed to decline control 416b, personal computer system 424 rejects the telecommunication connection request and ceases display of call user interface 416. At FIG. 4M, personal computer system 424 detects input 405m2 directed to answer control 416c. It should be recognized that input 405m2 is an example of a selection input as a tap input but can be other inputs, such as a verbal input (e.g., “Join the call”), an air gesture, and/or a button press.

In some embodiments, in response to detecting an input directed to contact control 468c, resident device 400 sends a telecommunications connection request to a personal computer system of an administrator of the location depending on the time of day. For example, if resident device 400 detects an input directed to contact control 468c between the times of 8:00 AM to 5:00 PM, resident device 400 will send a telecommunications connection request to a personal computer system of a first administrator of the location. To the contrary, if resident device 400 detects an input directed to contact control 468c, between the times of 5:00 PM to 11:00 PM, resident device 400 will send a telecommunications connection request to a personal computer system of a second administrator of the location.

At FIG. 4N, in response to detecting input 405m2, personal computer system 424 accepts the telecommunication connection request and initiates a telecommunications connection between resident device 400 and personal computer system 424. As illustrated in FIG. 4N, because personal computer system 424 is a party to the telecommunications connection, resident device 400 ceases display of identification user interface 468 and displays contact user interface 428. Contact user interface 428 includes administrator indicator 428a (e.g., “John”), icon 428b, number pad control 428d, and exit control 428c. Administrator indicator 428a is an indication (e.g., name and/or initials) of the administrator and icon 428b is a graphical representation of the administrator. As illustrated in FIG. 4N, resident device 400 displays icon 428b as a default image. It should be recognized that resident device 400 displays icon 428b as a default image to protect the privacy of the administrator. In some embodiments, resident device 400 does not display the name of the administrator within contact user interface 428 to protect the privacy of the administrator. For example, resident device 400 displays administrator indicator 428a as, “Administrator.” In some embodiments, resident device 400 terminates the telecommunications connection between personal computer system 424 and resident device in response to detecting an input corresponding to exit control 428c. In some embodiments, resident device 400 displays a number pad in response to detecting an input corresponding to number pad control 428d. At FIG. 4N, because resident device 400 is a party to the telecommunications connection, resident device 400 transmits video data from one or more cameras of resident device 400 to personal computer system 424.

At FIG. 4N, as part of being a party to the telecommunications connection, personal computer system 424 begins transmitting audio data to resident device 400. At FIG. 4N, as part of becoming a party to the telecommunications connection, personal computer system 424 ceases display of decline control 416b and answer control 416c, and displays call indication 416a, live feed 434, allow indicator 410, and camera control 498 within call user interface 416. Additionally, as illustrated in FIG. 4N, as a part of joining the telecommunications connection, personal computer system 424 displays live feed 434. Live feed 434 is a representation of a field-of-view of one or more cameras of resident device 400. At FIG. 4N, because the unknown subject is within the field of view of the one or more cameras of resident device 400, live feed 434 includes representation of unknown subject 434a. As illustrated in FIG. 4N, personal computer system 424 displays call region 470 as partially overlaid on live feed 434. Call Region 470 includes icon 428b, which is a representation of the administrator. In some embodiments, call region 470 includes a representation of a field-of-view of one or more cameras of personal computer system 424.

As illustrated in FIG. 4N, allow indicator 410 (e.g., “Allow this person?”) includes confirm control 410a and deny control 410b. In some embodiments, in response to detecting an input directed to confirm control 410a, personal computer system 424 communicates with resident device 400 to authorize the presence of the unknown subject within the location. In some embodiments, in response to detecting an input directed to deny control 410b, personal computer system 424 communicates with resident device 400 to not authorize the presence of the unknown subject within the location. In some embodiments, in response to detecting an input directed to camera control 498, personal computer system 424 begins transmitting video data corresponding to one or more cameras of personal computer system 424 to resident device 400.

FIG. 5 is a flow diagram illustrating a process (e.g., process 500) for outputting an indication based on a subject in accordance with some embodiments. Some operations in process 500 are, optionally, combined, the orders of some operations are, optionally, changed, and some operations are, optionally, omitted.

As described below, process 500 provides an intuitive way for outputting an indication based on a subject. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a computer system (e.g., 400) that is in communication (e.g., wired communication and/or wireless communication) with (and/or includes) one or more output devices (e.g., a display component, an audio component, and/or a haptic component). In some embodiments, the computer system is a watch, a phone, a tablet, a fitness tracking device, a processor, a head-mounted display (HMD) device, a communal device, a media device, a speaker, a television, and/or a personal computing device. In some embodiments, the display component includes a display screen, a projector, a head mounted display, and/or a touch-sensitive display. In some embodiments, the audio component includes a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output. In some embodiments, the computer system is communication with one or more input devices. In some embodiments, the one or more input devices are part of the computer system and/or another computer system different from the computer system. In some embodiments, the one or more input devices include a camera, a depth sensor, a microphone, a hardware input mechanism, a rotatable input mechanism, a physical input mechanism, a button, a crown, a knob, a dial, a physical slider, an accelerometer, and/or a touch-sensitive surface. In some embodiments, the computer system is a resident device (e.g., a device that is permanently installed within a location and/or is part of a connected network at the location, a device that is actively connected to a network at the location and/or consistently part of a network at the location, an always-on device at the location, a permanent device, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or an electronic device).

The computer system detects (502) (e.g., while displaying a user interface) an identity (e.g., an identification, a user account, a unique identifier, and/or a user profile) of a subject (e.g., a user, person, an individual and/or, a personal device of a user) (e.g., 472, 430, 408 and/or 456) (e.g., as described above with respect to FIG. 4A, FIG. 4D, FIG. 4F, and/or FIG. 4J). In some embodiments, the subject is detected in an environment before detecting the identity of the subject. In some embodiments, the identity of the subject is detected while detecting the subject in the environment. In some embodiments, the identity of the subject is detected by the computer system receiving, from another device (e.g., a server or a personal device of the subject) separate from the computer system, a communication including an identification of the identity of the subject. In some embodiments, the subject is detected via the computer system. In some embodiments, the subject is detected via the computer system and the identity of the subject is detected via another computer system different from the computer system. In some embodiments, the subject is detected via the one or more input devices, such as a camera and/or a microphone.

In response to (504) detecting the identity of the subject (and/or while (506) detecting the subject and/or in conjunction with detecting the subject), in accordance with a determination that the subject is not automatically authenticated (e.g., as described above with respect to FIG. 4F, and/or FIG. 4J) (e.g., the subject is not automatically authenticated based on the identity of the subject and/or one or more other automatic authentication mechanisms, the subject is recognized by the computer system but a personal device of the subject is not detected, the computer system does not have access to information related to automatic authentication of the subject, an account of the subject is not registered with the computer system, the computer system does not have access to information regarding biometrics of the subject, the subject has not previously interacted with and/or used the computer system) (and/or the identity of the subject does not correspond to a user account identified by the computer system, the identity of the subject corresponds to a user account that is not configured to be able to be automatically authenticated, and/or the identity of the subject requires an additional authentication mechanism, in addition to being identified, that is not satisfied), the computer system outputs (508), via the one or more output devices, an indication (e.g., 466 and/or 468a) corresponding to the identity of the subject (e.g., as described above with respect to FIG. 4F, and/or FIG. 4J). In some embodiments, the indication includes an indication that the subject is not automatically authenticated. In some embodiments, the indication includes a visual output (e.g., a video, an image, an animation, a 3D rendering, a motion graphic, a data visualization, and/or a digital art) corresponding to the subject. In some embodiments, the indication includes an identification of the identity of the subject. In some embodiments, the indication includes an indication that the subject is not able to be automatically authenticated. In some embodiments, the indication includes an indication that the subject is not able to be authenticated. In some embodiments, the subject is automatically authenticated separate from the identity of the subject being detected. In some embodiments, detecting the identity of the subject is part of automatically authenticating the subject. In some embodiments, automatically authenticating the subject requires detecting the identity of the subject and one or more other requirements as described herein.

In response to (504) detecting the identity of the subject, in accordance with the determination that the subject is not automatically authenticated, the computer system outputs (510), via the one or more output devices, a request (e.g., 468 and/or 466, and/or text within 468 as illustrated in FIG. 4J and/or 4M) to authenticate the subject (e.g., as described above with respect to FIG. 4F, FIG. 4J, and/or FIG. 4M). In some embodiments, the request to authenticate the subject is output via an external device (e.g., of the subject, of the homeowner, and/or near the subject) in communication with the computer system. In some embodiments, the request to authenticate the subject includes one or more instructions for the subject to authenticate with the computer system. In some embodiments, outputting the request to authenticate the subject includes displaying a user interface for authenticating the subject, such as a user interface for entering a credential.

In response to (504) detecting the identity of the subject, in accordance with a determination that that the subject is automatically authenticated (e.g., the subject is recognized by the computer system via an external device, the computer system has access to information relating to the subject on a personal device and/or external device, the computer system is registered with an account of the subject, the computer system has access to information regarding biometrics of the subject including voice recognition, and/or the subject has previously interacted with and/or used the computer system), the computer system outputs (512), via the one or more output devices, an identification (e.g., 484, 484a and/or 420 and/or 420a as illustrated in FIG. 4D) of the identity of the subject without outputting the request to authenticate the subject (e.g., as described above with respect to FIGS. 4A-4D). In some embodiments, the indication corresponding to the identity of the subject is the same as the identification of the identity of the subject. In some embodiments, the indication corresponding to the identity of the subject is different from the identification of the identity of the subject. In some embodiments, a portion of the indication corresponding to the identity of the subject is the same as a portion of the identification of the identity of the subject. Outputting indications of an identity of a subject while selectively outputting a request to authenticate the subject based on whether the subject is automatically authenticated allows the computer system to have a two-factor authentication process that requires identity and one other factor, the one other factor sometimes automatically obtained and other times manually obtained, thereby performing an operation when a set of conditions has been met without requiring further user input.

In some embodiments, outputting the request to authenticate the subject includes transmitting a request (e.g., notification, image, and/or video) to a personal computer system (e.g., 424) (e.g., smartphone, tablet, smartwatch and/or head mounted display) of a subject (e.g., 472) (e.g., an administrator, a user, and/or a person) that is registered (e.g., a resident of a home that corresponds to the computer system) with the computer system (e.g., 400) (e.g., as described above with respect to FIGS. 4J-4K). In some embodiments, the request causes the personal computer system of the subject that is registered with the computer system to display an indication of the request. In some embodiments, the request causes the personal computer system of the subject that is registered with the computer system to output (e.g., audibly output and/or visually output) a progress of the subject to authenticating themselves. In some embodiments, the request causes the personal computer system of the subject that is registered with the computer system to initiate a process of authenticating the subject. Transmitting a request to a personal computer system of a subject that is registered with the computer system as part of outputting a request to authenticate a subject allows the computer system to enable registered users to authenticate subjects, thereby performing an operation when a set of conditions has been met without requiring further user input.

In some embodiments, outputting the request to authenticate the subject includes transmitting a request to a personal computer system (e.g., smartphone, tablet, smartwatch and/or head mounted display) of the subject (e.g., 408) (e.g., as described above with respect to FIGS. 4F-4G) (e.g., owned by the subject and/or registered with the subject). In some embodiments, the request causes the personal computer system of the subject to display an indication of the request. In some embodiments, the request causes the personal computer system of the subject to output (e.g., audibly output and/or visually output) a request for the subject to authenticate themselves. In some embodiments, the request causes the personal computer system of the subject to initiate a process of authenticating the subject. Transmitting a request to a personal computer system of a subject as part of outputting a request to authenticate the subject allows the computer system to enable the subject to authenticate themselves using their own computer system, thereby performing an operation when a set of conditions has been met without requiring further user input.

In some embodiments, the computer system (e.g., 400) corresponds to (e.g., is associated with, is registered with, and/or is assigned to) a location (e.g., a home, an environment, a building, and/or a room) (e.g., 448). In some embodiments, outputting the request to authenticate the subject includes transmitting a request to an accessory device (e.g., a display, a television, a light, a lock, a security system, a speaker, an appliance, a motion detector, and/or a thermostat) that corresponds to (e.g., is at, is associated with, is registered with, and/or is assigned to) the location (e.g., as described above with respect to FIGS. 4F-4G and/or FIGS. 4J-4K). In some embodiments, receipt of the request causes the accessory device to display an indication of the request. In some embodiments, receipt of the request causes the accessory device to output (e.g., audibly output and/or visually output) a request for the subject to authenticate themselves. In some embodiments, the receipt of the request causes the accessory device to initiate a process of authenticating the subject. In some embodiments, the accessory device is different from the computer system. Transmitting a request to an accessory device at a location as part of outputting a request to authenticate a subject for the location allows the computer system to enable different devices to be used for authentication, those different devices having different capabilities, thereby performing an operation when a set of conditions has been met without requiring further user input.

In some embodiments, the computer system (e.g., 400) is in communication (e.g. wireless communication and/or wired communication) with (or includes) one or more display components (e.g., a display screen, a projector, a head mounted display, and/or a touch-sensitive display). In some embodiments, outputting the request to authenticate the subject includes displaying, via the one or more display components, an authentication user interface (e.g., 432 and/or 468) (and/or initiates a process to authenticate the subject) (e.g., as described above with respect to FIG. 4G, FIG. 4J, and/or FIG. 4M). In some embodiments, the authentication user interface includes instructions regarding how the subject may authenticate themselves. In some embodiments, the authentication user interface includes a method for the subject to authenticate themselves (e.g. the authentication user interface includes a number pad such that the subject can enter a pin code). In some embodiments, the computer system automatically ceases display of the authentication user interface after the computer system has displayed the authentication user interface for a predetermined period of time (e.g., 10 seconds to 5 minutes). Displaying an authentication user interface as part of outputting a request to authenticate a subject allows the computer system to authenticate users itself without requiring use of another computer system, thereby performing an operation when a set of conditions has been met without requiring further user input.

In some embodiments, outputting the request to authenticate the subject includes requesting (e.g., audibly requesting and/or visually requesting), via the one or more output devices, that the subject speak (e.g., so that the subject can be identified by voice) (e.g., as described above with respect to FIG. 4F, 4G, FIG. 4J, and/or FIG. 4M). In some embodiments, the request includes text that the subject must read to authenticate themselves. In some embodiments, the request is a set of one or more words of what the subject must say in order for the subject to authenticate themselves. In some embodiments, the request that the subject speak is output by the computer system or another computer system external to the computer system. Requesting that a subject speak as part of outputting a request to authenticate the subject allows the computer system to authenticate users with their voices, thereby performing an operation when a set of conditions has been met without requiring further user input.

In some embodiments, outputting the corresponding to the identity of the subject includes outputting (e.g., on the computer system and/or on another computer system external to the computer system), via the one or more output devices, audio content corresponding to (e.g., directed to, associated with, and/or concerning) the identity of the subject (e.g., as described above with respect to FIG. 4F, FIG. 4J, and/or FIG. 4M). ISE the audio content includes a dictation of a registered name of the subject. In some embodiments, the audio content corresponding to the identity of the subject includes a description of the subject. In some embodiments, the audio content corresponding to the identity of the subject includes a current location of the subject. Outputting audio content corresponding to an identity of a subject when the subject is identified but not automatically authenticated allows the computer system to indicate to the subject that the subject has passed one factor but needs to pass another factor, thereby performing an operation when a set of conditions has been met without requiring further user input.

In some embodiments, the computer system (e.g., 400) is in communication (e.g. wireless communication and/or wired communication) with (or includes) one or more display components (e.g., a display screen, a projector, a head mounted display, and/or a touch-sensitive display). In some embodiments, outputting the indication corresponding to the identity of the subject includes displaying, via the one or more display components, a user interface object (e.g., 466and/or 468) (e.g., via one or more display components of the computer system or via one or more display components of another computer system external to the compute system). In some embodiments, the user interface object is a default user interface object. In some embodiments, an appearance of the user interface object is tailored to the identity of the subject. Displaying a user interface object corresponding to an identity of a subject when the subject is identified but not automatically authenticated allows the computer system to indicate to the subject that the subject has passed one factor but needs to pass another factor, thereby performing an operation when a set of conditions has been met without requiring further user input.

In some embodiments, outputting the indication corresponding to the identity of the subject includes outputting, via the one or more output devices, (e.g., visually outputting and/or audibly outputting) a representation (e.g., 468a, and/or 466b) (e.g., a textual representation and/or a graphical representation) of the subject (e.g., a name, initials, video, and/or image of the subject). In some embodiments, the computer system outputs the representation of the subject. In some embodiments, a computer system external to the computer system outputs the representation of the subject. In some embodiments, the representation of the subject is output for a predetermined period of time (e.g., 30 seconds to 5 minutes). In some embodiments, the representation of the subject is selected by the subject. In some embodiments, the representation of the subject is an image of the subject. In some embodiments, the representation of the subject is based on an appearance of the subject. Outputting a representation of a subject when the subject is identified but not automatically authenticated allows the computer system to indicate to the subject that the subject has passed one factor but needs to pass another factor, thereby performing an operation when a set of conditions has been met without requiring further user input.

In some embodiments, in accordance with the determination that the subject is not automatically authenticated, the indication corresponding to the identity of the subject includes an indication (e.g., a textual indication and/or a graphical indication) that the subject is not authenticated (e.g., as described above with respect to FIG. 4F, FIG. 4J, and/or FIG. 4M). In some embodiments, the indication corresponding to the identity of the subject includes instructions for how the subject can authenticate themselves. In some embodiments, the computer system ceases display of the indication corresponding to the identity of the subject in response to detecting that the subject is authenticated. In some embodiments, the indication corresponding to the identity of the subject includes a prompt asking the subject to authenticate themselves. Outputting an indication that a subject is not authenticated when the subject is identified but not automatically authenticated allows the computer system to indicate to the subject that the subject has passed one factor but needs to pass another factor, thereby performing an operation when a set of conditions has been met without requiring further user input.

In some embodiments, in response to detecting the identity of the subject and in accordance with the determination that the subject is automatically authenticated, the computer system outputs (e.g., visually outputting and/or audibly outputting), via the one or more output devices, a confirmation (e.g., 484, 404 and/or 420 as illustrated in FIG. 4D) that the subject is automatically authenticated, wherein the confirmation that the subject is automatically authenticated and the identification of the identity (e.g., 420a illustrated in FIG. 4D) of the subject are concurrently output. In some embodiments, the confirmation that the subject is automatically authenticated includes an indication of how the subject is automatically authenticated. In some embodiments, the confirmation that the subject is automatically authenticated and the identification of the identity of the subject are not concurrently output. In some embodiments, the confirmation that the subject is automatically authenticated includes an indication of which computer system authenticated the subject. Outputting a confirmation that a subject is automatically authenticated with an identification of an identity of the subject allows the computer system to indicate to the subject that the computer system knows who the subject is, thereby performing an operation when a set of conditions has been met without requiring further user input.

In some embodiments, the computer system (e.g., 400) is in communication (e.g. wireless communication and/or wired communication) with (or includes) one or more display components (e.g., a display screen, a projector, a head mounted display, and/or a touch-sensitive display). In some embodiments, in response to detecting the identity of the subject and in accordance with the determination the subject is not automatically authenticated, the computer system displays, via the one or more display components, a set of one or more controls (e.g., 468b and/or 468c) (e.g. selectable controls), wherein the set of one or more controls are displayed while the indication corresponding to the identity of the subject is output (e.g., as described above with respect to FIG. 4J and/or FIG. 4M). In some embodiments, in response to detecting an input corresponding to a first control of the set of one or more controls, the computer system initiates a telecommunication connection with another computer system external to the computer system. In some embodiments, in response to detecting an input corresponding to a second control of the set of one or more controls, the computer system displays a number pad to allow the subject to enter a pin code. In some embodiments, the second control is different and/or separate from the first control. Displaying a set of one or more controls when a subject is identified but not automatically authenticated allows the computer system to provide ways for the subject to become authenticated, thereby performing an operation when a set of conditions has been met without requiring further user input.

In some embodiments, the determination that the subject is automatically authenticated is made based on (e.g., in response to) a verification (e.g., made by the computer system and/or a computer system external to the computer system) that a personal computer system (e.g., 424) of the subject (e.g., 472 and/or 430) (e.g., smart phone, tablet, smartwatch and/or head mounted device) is positioned within a predetermined threshold distance (e.g., 1-60 inches) of the computer system (e.g., as described above with respect to FIGS. 4A-4D). In some embodiments, the predetermined threshold distance is based on the subject (e.g., more or less distance for different subjects). In some embodiments, the predetermined threshold distance is based on a detected context of an environment of the computer system (e.g., more or less distance for different detected contexts). In some embodiments, the predetermined distance is based on the identity of the subject (e.g., more or less distance for different identities). Automatically authenticating a subject based on a verification that a personal computer system of the subject is nearby in addition to detecting an identity of the subject allows the computer system to authenticate subjects without requiring subjects enter credentials, thereby performing an operation when a set of conditions has been met without requiring further user input.

In some embodiments, the verification that the personal computer system (e.g., 424) of the subject (e.g., 472 and/or 430) is positioned within the predetermined threshold distance of the computer system is made within a predetermined amount time (e.g., 1-360 seconds) after the subject is detected (e.g., as described above with respect to FIGS. 4A-4D). In some embodiments, the predetermined amount of time is based on what type of subject is detected (e.g., more or less time for different types of subjects).

In some embodiments, the determination that the subject is automatically authenticated is made based on a detection (e.g., by the computer system or by another computer system eternal to the computer system) of a voice of the subject (e.g., as described above with respect to FIGS. 4A-4D). In some embodiments, the detection includes detecting a predetermined phrase. In some embodiments, the detection includes detecting an utterance that is not directed at the computer system. In some embodiments, the detection includes detecting an utterance that is directed at the computer system. Automatically authenticating a subject based on a voice of the subject in addition to detecting an identity of the subject allows the computer system to authenticate subjects without requiring subjects to navigate user interfaces of the computer system, thereby performing an operation when a set of conditions has been met without requiring further user input.

In some embodiments, the determination that the subject is automatically authenticated is made based on receipt of (e.g., by the computer system and/or by a computer system external to the computer system) a credential corresponding to (e.g., directed to, associated with, and/or related to) the subject (e.g., 472 and/or 430) within a predetermined threshold of time (e.g., 1-360 seconds) of detecting the identity of the subject (e.g., as described above with respect to FIGS. 4A-4D). In some embodiments, the credential corresponding to the subject is received from a personal computer system (e.g., smartphone, smartwatch, head-mounted display, and/or tablet) of the subject. In some embodiments, the computer system displays an indication that the credential corresponding to the subject is received. In some embodiments, the computer system displays an indication of the type of credential that is received. In some embodiments, the computer system displays an indication of the computer system that transmits the credential to the computer system. Automatically authenticating a subject based on receiving a credential within a predetermined threshold of time before detecting an identity of the subject allows the computer system to authenticate subjects without requiring subjects to navigate user interfaces of the computer system, thereby performing an operation when a set of conditions has been met without requiring further user input.

In some embodiments, the identity of the subject is detected in response to the computer system detecting an input (e.g., a tap input, a swipe input, an air gesture and/or a voice command) (e.g., as described above with respect to FIG. 4B, FIG. 4D, and/or FIG. 4F). In some embodiments, the input corresponds to a user interface object that is displayed (e.g., by the computer system or by a computer system external to the computer system). In some embodiments, the input is not directed at the computer system. In some embodiments, the input is a positioning of the subject relative to the computer system. Detecting an identity of a subject in response to the computer system detecting an input allows the computer system to reserve processing time and/or power for detecting the identity to when the subject has indicated a desire to interact with the computer system, thereby performing an operation when a set of conditions has been met without requiring further user input.

In some embodiments, the identity of the subject is detected in response to the subject being detected (e.g., by the computer system and/or by another computer system external to the computer system) at a predefined location (e.g., in front of the computer system, to the side of the computer system, above the computer system, below the computer system, and/or behind the computer system) in an environment (e.g., 448) (e.g., as described above with respect to FIG. 4B, FIG. 4D, and/or FIG. 4F). In some embodiments, the computer system and the subject are positioned within the environment. In some embodiments, the computer system is not positioned within the environment. In some embodiments, the predefined location is within a predetermined distance (e.g., 0 to 10 feet) of the computer system. In some embodiments, the predefined location is not within a field-of-view of one or more cameras of the computer system. In some embodiments, the predefined location is relative to another computer system other than the computer system. Detecting an identity of a subject in response to the subject being detected at a predefined location in an environment allows the computer system to reserve processing time and/or power for detecting the identity to when the subject is more likely to interact with the computer system, thereby performing an operation when a set of conditions has been met without requiring further user input.

In some embodiments, before detecting the identity of the subject, the computer system detects a presence of the subject (e.g., 472, 430, 408 and/or 456) in an environment (e.g., 448) (e.g., as described above with respect to FIG. 4B, FIG. 4D, FIG. 4F, and/or FIG. 4J). In some embodiments, one or more cameras of the computer system detects the presence of the subject in the environment. In some embodiments, one or more cameras of a computer system external to the computer system detects the presence of the subject in the environment. In some embodiments, the presence of the subject is detected in the environment for a predetermined period of time (e.g., 0-10 minutes). In some embodiments, the presence of the subject is detected in the environment as the subject moves about the environment. In some embodiments, the presence of the subject is detected in the environment via one or more microphones of the computer system or another computer system other than the computer system. In some embodiments, the computer system is not positioned within the environment. Detecting an identity of a subject after detecting that the subject is present in an environment allows the computer system to reserve processing time and/or power for detecting the identity to when the subject is more likely to interact with the computer system, thereby performing an operation when a set of conditions has been met without requiring further user input.

In some embodiments, the subject is a first subject. In some embodiments, while (or before or after) detecting the identity of the first subject, the computer system detects a second subject (e.g., 472, 430, 408, and/or 456) and a third subject (e.g., 472, 430, 408, and/or 456) without detecting identities of the second subject and the third subject. In some embodiments, the second subject and the third subject are not registered with the computer system and the first subject is registered with the computer system. In some embodiments, the first subject, the second subject and the third subject are registered with the computer system. In some embodiments, the first subject, the second subject, and the third subject are not registered with the computer system. In some embodiments, the identities of the second subject and the third subject are detected while the identity of the first subject is detected. In some embodiments, the second subject and the third subject are detected via different modalities. Detecting an identity of one subject but not others allows the computer system to reserve processing time and/or power for detecting different identities when one subject is sufficient, thereby performing an operation when a set of conditions has been met without requiring further user input.

In some embodiments, the identity of subject is detected using (e.g., via) an image (e.g., as described above with respect to FIG. 4B, FIG. 4D, FIG. 4F, and/or FIG. 4J). In some embodiments, the image is from a video. In some embodiments, one or more cameras of the computer system captures the image. In some embodiments, the computer system receives the image from another computer system external to the computer system.

In some embodiments, before detecting the identity of the subject, the computer system receives data corresponding to the image from one or more cameras (e.g., 414) external to the computer system (e.g., as described above with respect to FIG. 4B, FIG. 4D, FIG. 4F, and/or FIG. 4J). In some embodiments, the identity of the subject is detected within a predetermined amount of time (e.g., 1-360 seconds) since the image is captured. In some embodiments, the identity of the subject is detected within a predetermined amount of time (e.g., 1-360 seconds) since the image is received.

In some embodiments, the identity of the subject is detected in response to (and/or in conjunction with or after) the computer system receiving an indication of the identity of the subject from another computer system (e.g., represented by camera 414) (e.g., a watch, a phone, a tablet, a fitness tracking device, a processor, a head-mounted display (HMD) device, a communal device, a media device, a speaker, a television, an electronic device, and/or a personal computing device) external to the computer system (e.g., as described above with respect to FIG. 4B, FIG. 4D, and/or FIG. 4F). In some embodiments, the other computer system external to the computer system determines the identity of the subject. In some embodiments, the other computer system external to the computer determines the identity of the subject using one or more microphones and/or one or more cameras of the other computer system external to the computer system. Detecting an identity of a subject using an indication of the identity received from another computer system external to the computer system allows the computer system to reserve processing time and/or power for detecting the identity by using other computer systems for such tasks, thereby performing an operation when a set of conditions has been met without requiring further user input.

Note that details of the processes described above with respect to process 500 (e.g., FIG. 5) are also applicable in an analogous manner to other processes described herein. For example, process 800 optionally includes one or more of the characteristics of the various processes described above with reference to process 500. For example, the indication of process 600 is output based on the subject identified in process 800. For brevity, these details are not repeated herein.

FIG. 6 is a flow diagram illustrating a process (e.g., process 600) for displaying a control based on a subject in accordance with some embodiments. Some operations in process 600 are, optionally, combined, the orders of some operations are, optionally, changed, and some operations are, optionally, omitted.

As described below, process 600 provides an intuitive way for displaying a control based on a subject. Process 600 reduces the cognitive burden on a user, thereby creating a more efficient human-machine interface. For battery-operated computing devices, enabling a user to interact with such devices faster and more efficiently conserves power and increases the time between battery charges.

In some embodiments, process 600 is performed at a first computer system (e.g., 400) that is in communication (e.g., wired communication and/or wireless communication) with (and/or includes) one or more display components and one or more input devices. In some embodiments, the first computer system is a watch, a phone, a tablet, a fitness tracking device, a processor, a head-mounted display (HMD) device, a communal device, a media device, a speaker, a television, and/or a personal computing device. In some embodiments, the one or more input devices includes a camera, a depth sensor, a microphone, a hardware input mechanism, a rotatable input mechanism, a physical input mechanism, a button, a crown, a knob, a dial, a physical slider, an accelerometer, and/or a touch-sensitive surface. In some embodiments, the one or more display components include a display screen, a projector, a head mounted display, and/or a touch-sensitive display. In some embodiments, the first computer system is in communication with one or more output devices, such as the one or more display components, one or more audio components, and/or one or more haptic components. In some embodiments, the one or more audio components include a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output. In some embodiments, the first computer system is a resident device (e.g., a device that is permanently installed within a location and/or is part of a connected network at the location, a device that is actively connected to a network at the location and/or consistently part of a network at the location, an always-on device at the location, a permanent device, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device). In some embodiments, the first computer system is communication with one or more input devices. In some embodiments, the one or more input devices are part of the first computer system and/or another computer system different from the first computer system.

The first computer system detects (602) a subject (e.g., 472, 430, 408 and/or 456) (e.g., a user, a guest, an individual and/or, a personal device of the subject) in an environment (e.g., 448) (e.g., a physical area, a home, an office, a zone, a living room, and/or a locality configured by a user and/or defined by a computer system, such as the first computer system or another computer system different from the first computer system) (e.g., as described above with respect to FIG. 4B, FIG. 4D, FIG. 4F, and/or FIG. 4J). In some embodiments, the subject is detected via the one or more input devices, such as a camera and/or a microphone. In some embodiments, the subject is detected by the first computer system receiving, from another computer system (e.g., a server or a personal computer system of the subject) separate from the first computer system, a communication including an identification of the identity of the subject.

In response to (604) detecting the subject in the environment, in accordance with a determination that the subject is not recognized (e.g., by the first computer system, a server, and/or another computer system separate from the first computer system, the subject is not recognized by the first computer system, the first computer system does not have access to information relating to the subject, an account of the subject is not registered or linked with the first computer system, the first computer system and/or another computer system does not have access to information regarding biometrics of the subject, the subject has not previously interacted with and/or used the first computer system), the first computer system displays (606), via the one or more display components, a control (e.g., 468c) for initiating a communication with another computer system (e.g., 424) (e.g., as described above with respect to FIGS. 4I-4J and/or FIG. 4M). In some embodiments, the determination that the subject is not recognized includes a determination based on receiving, from another computer system (e.g., a server or a personal device of the subject) separate from the first computer system, a communication that the subject is unrecognizable. In some embodiments, the control for initiating a communication with another computer system is displayed while the first computer system detects the subject in the environment. In some embodiments, the first computer system displays the control within a user interface (e.g., a lockscreen, home user interface, and/or a notification center).

In response to (604) detecting the subject in the environment, in accordance with a determination that the subject is recognized (e.g., the subject is recognized by the first computer system via an external device, the first computer system has access to information relating to the subject on a personal device and/or external device, the first computer system is registered or linked with an account of the subject, the first computer system has access to information regarding biometrics of the subject including voice recognition, the subject has previously interacted with and/or used the first computer system, the subject is identified but not automatically authenticated based on an identity of the subject and/or one or more other automatic authentication methods the subject is identified but a personal device of the subject is not detected, and/or the subject is automatically authenticated based on the identity of the subject and/or detection of a personal device of the subject), the first computer system forgoes (608) display of, via the one or more display components, the control for initiating a communication with another computer system (e.g., as described above with respect to FIG. 4J). In some embodiments, the determination that the subject is recognized includes a determination that the subject is identified and/or authenticated via the first computer system and/or another computer system different from the first computer system.

While displaying the control (e.g., 468c) for initiating a communication with another computer system, the first computer system detects (610), via the one or more input devices, an input (e.g., 405m1) (e.g., selection input such as a tap input, an air gesture input, a mouse click, and/or a long press detected via the one or more input devices) corresponding to the control for initiating a communication (e.g., a telecommunication connection, a phone call, a text, and/or, a video conference) with another computer system (e.g., 424) (e.g., as described above with respect to FIG. 4M). In some embodiments, the first computer system detects that the subject performs the input. In some embodiments, the input is an input detected at a location of the control.

In response to detecting the input corresponding to the control for initiating a communication with another computer system, the first computer system sends (612), to a second computer system (e.g., 424) external to the first computer system, a request to initiate the communication, wherein the second computer system is different from the first computer system (e.g., as described above with respect to FIGS. 4M-4N). In some embodiments, in response to detecting the input corresponding to the control, the first computer system displays, via the one or more display components, a user interface that corresponds to the telecommunications connection. In some embodiments, in response to detecting the input corresponding to the control, the first computer system maintains display of, via the one or more display components, a user interface. In some embodiments, the subject is recognized while the first computer system detects the subject in the environment. In some embodiments, the subject is recognized in response to the first computer system receiving, from another computer system (e.g., a server, a personal device of an owner or, a personal device of the subject) separate from the first computer system, a communication including an identification of the identity of the subject. In some embodiments, the subject is recognized based on and/or occurs in response to the first computer system receiving, from the other computer system, an indication that the subject is and/or has been authenticated. In some embodiments, the subject is recognized based on and/or occurs in response to the first computer system receiving (e.g., from a server or the other computer system) one or more authorization content (e.g., biometric data, pin code, and/or key). In some embodiments, in response to detecting the subject and in accordance with the determination that the subject is a recognized subject and that the subject is (e.g., has been) automatically authenticated (e.g., as described above with respect to process 500), the first computer system outputs (e.g. displays and/or audibly outputs) an indication that the subject is authenticated. In some embodiments, in response to detecting the subject and in accordance with the determination that the subject is a recognized subject and that the subject is not (e.g., has not been) automatically authenticated (e.g., as described above with respect to process 500), the first computer system outputs a request to authenticate the subject. Selectively displaying a control for initiating a communication with another computer system depending on whether a subject is recognized allows the first computer system to provide help for subjects that are not recognized without cluttering output when subjects are recognized, thereby performing an operation when a set of conditions has been met without requiring further user input.

In some embodiments, while displaying the control (e.g., 468c) for initiating a communication with another computer system (e.g., and/or in response to detecting the subject in the environment and in accordance with the determination that the subject is not recognized), the first computer system displays, via the one or more display components, a control (e.g., 468b) for entering a credential (e.g., a password, a pin code, a numeric pin code, and/or an alphanumeric pin code) (e.g., as described above with respect to FIG. 4J and/or FIG. 4M). In some embodiments, the first computer system serially displays the control for entering a credential and the control for initiating a communication with another computer system In some embodiments, while displaying the control for entering a credential, the first computer system detects, via the one or more input devices, an input (e.g., 405j) (e.g., a tap input, a voice command, and/or an air gesture) corresponding to (e.g., directed to, at a location of, related to, and/or associated with) the control for entering a credential. In some embodiments, in response to detecting the input corresponding to the control for entering a credential, the first computer system displays, via the one or more display components, a set of one or more user interface objects (e.g., 450) that each correspond to (e.g., directed to, related to, and/or associated with) a number (and/or a character). In some embodiments, the set of one or more user interface objects correspond to a range of numbers form 0-9. In some embodiments, the first computer system ceases display of the control for entering a credential and/or the control for initiating a communication with another computer system as a part of displaying the set of one or more user interface objects that each correspond to a number. In some embodiments, the first computer system continues display of the control for entering a credential and/or the control for initiating a communication with another computer system as a part of displaying the set of one or more user interface objects that each correspond to a number. In some embodiments, the first computer system detects that a credential is entered via selection of one or more user interface objects that each correspond to a number. Displaying a control for entering a credential while displaying a control for initiating a communication with another computer system depending on whether a subject is recognized allows the first computer system to provide help for subjects that are not recognized in different manners without cluttering output when subjects are recognized, thereby performing an operation when a set of conditions has been met without requiring further user input.

In some embodiments, in response to detecting the subject in the environment and in accordance with a determination that the subject is recognized and authenticated, the first computer system displays, via the one or more display components, an identification (e.g., 484, 484a and/or 420 and/or 420a) of the subject (e.g., a photo of the subject, a video the subject, a name of the subject, and/or initials of the subject) (e.g., as described above with respect to FIGS. 4A-4D). In some embodiments, the subject is authenticated via one or more biometrics. In some embodiments, the subject is authenticated via a personal device of the subject. In some embodiments, the first computer system does not display the identification of the subject in response to the first computer system detecting the subject in the environment and in accordance with a determination that the subject is recognized but not authenticated. In some embodiments, the first computer system ceases display of the identification of the subject based on a determination that the subject is no longer detected. In some embodiments, the subject is recognized before or after the subject is authenticated. Displaying an identification of a subject when the subject is recognized and authenticated allows the first computer system to indicate an authentication status of the subject, thereby performing an operation when a set of conditions has been met without requiring further user input.

In some embodiments, the first computer system (e.g., 400) is in communication (wired communication and/or wirelessly communication) with (or includes) one or more output devices (e.g., a display generation component, an audio generation component, and/or a haptic generation component). In some embodiments, in response to detecting the subject in the environment and in accordance with a determination that the subject is recognized and not authenticated, the first computer system outputs (e.g., audibly outputs and/or displays), via the one or more output devices, a request for the subject to authenticate themselves (e.g., 466 and/or 468) (e.g., as described above with respect to FIGS. 4E-4G) (e.g., a request for the subject to enter a credential, provide biometric information, and/or authenticate via a personal device of the subject). In some embodiments, in response to detecting the subject in the environment and in accordance with a determination that the subject is recognized and is authenticated, the first computer system forgoes output of the request for the subject to authenticate themselves. In some embodiments, the first computer system loops and/or repeats output of the request for the subject to authenticate themselves. In some embodiments, the first computer system outputs the request for the subject to authenticate themselves once. In some embodiments, the first computer system ceases output of the request for the subject to authenticate themselves after a predetermined period of time (e.g., 5 seconds to 2 minutes). In some embodiments, in response to detecting the subject in the environment and in accordance with a determination that the subject is recognized and not authenticated, the first computer system does not display the control for initiating a communication with another computer system. Outputting a request for a subject to authenticate themselves when the subject is recognized but not authenticated allows the first computer system to indicate to the subject that an identity of the subject is recognized but that more information is required to be authenticated, thereby performing an operation when a set of conditions has been met without requiring further user input.

In some embodiments, after outputting the request for the subject to authenticate themselves (and/or while not displaying the control for initiating a communication with another computer system), the first computer system detects, via the one or more input devices, one or more failed authentication attempts by the subject (e.g., as described above with respect to FIG. 4G-4H) (e.g., the subject enters a wrong credential, one or more attempts at capturing one or more biometrics of the subject are unsuccessful, and/or a personal device of the subject cannot be detected). In some embodiments, in response to detecting the one or more failed authentication attempts by the subject (and/or in accordance with a determination that a number of the one or more failed authentication attempts satisfied a threshold number of attempts (e.g., 1-10)), the first computer system displays, via the one or more display components, the control for initiating a communication with another computer system (e.g., as described above with respect to FIG. 4G). In some embodiments, in response to detecting the one or more failed authentication attempts by the subject (and/or in accordance with a determination that a number of the one or more failed authentication attempts satisfied a threshold number of attempts (e.g., 1-10)), the first computer system enters in a locked mode (e.g., a mode where one or more functionalities of the first computer system are restricted). In some embodiments, in response to detecting the one or more failed authentication attempts by the subject (and/or in accordance with a determination that a number of the one or more failed authentication attempts satisfied a threshold number of attempts (e.g., 1-10)), the first computer systems sends to the second computer system external to the first computer system, a request to initiate the communication. In some embodiments, the first computer system displays an indication after each failed authentication attempt by the subject. In some embodiments, the first computer system prohibits the subject from authenticating themselves after the first computer system detects the one or more failed authentication attempts by the subject (and/or in accordance with a determination that a number of the one or more failed authentication attempts satisfied a threshold number of attempts (e.g., 1-10)). Displaying a control for initiating a communication with another computer system in response to detecting one or more failed authentication attempts allows the first computer system to provide further assistance when a subject is having trouble authenticating, thereby performing an operation when a set of conditions has been met without requiring further user input.

In some embodiments, the first computer system (e.g., 400) is a communal computer system that corresponds to an environment and is connected to one or more computer systems (e.g., within a common ecosystem) within the environment (e.g., as described above with respect to FIG. 4A) (e.g., a device that is permanently installed within a location and/or is part of a connected network at the location, a device that is actively connected to a network at the location and/or consistently part of a network at the location, an always-on device at the location, a permanent device, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

In some embodiments, the second computer system (e.g., 424) is a personal device (e.g., as described above with respect to FIG. 4A) (e.g., a device that is registered with a single subject and/or user, a device that is configured for a single subject and/or user, a device that is access by a single set of credentials, and/or a device that is owned by a single user).

In some embodiments, while displaying the control (e.g., 468c) for initiating a communication with another computer system (and/or in response to detecting the subject in the environment and in accordance with the determination that the subject is not recognized), the first computer system displays, via the one or more display components, an indication (e.g., 468) (e.g., a textual indication and/or a graphical indication) that the subject is not authenticated (e.g., as described above with respect to FIG. 4I-4J and/or FIG. 4M). In some embodiments, the first computer system ceases display of the indication that the subject is not authenticated based on a determination that the subject authenticates themself. In some embodiments, the first computer system ceases display of the indication that the subject is not authenticated while the subject remains unauthenticated. In some embodiments, the indication that the subject is not authenticated includes a prompt for the subject to authenticated themselves. In some embodiments, the indication that the subject is not authenticated includes instructions on how the subject can authenticate themselves. In some embodiments, the first computer system displays user interface corresponding to a method of authenticating the subject in response to detecting an input that corresponds to the indication that the subject is not authenticated. Displaying an indication that a subject is not authenticated while displaying a control for initiating a communication with another computer system allows the first computer system to indicate to the subject why the control is being displayed, thereby performing an operation when a set of conditions has been met without requiring further user input.

In some embodiments, in response to detecting the input (e.g., 405m1 and/or 405m2) corresponding to the control for initiating a communication with another computer system, the first computer system displays, via the one or more display components, a call user interface (e.g., 428 and/or 416) corresponding to (e.g., directed to, associated with, and/or related to) a communication between the first computer system (e.g., 400) and the second computer system (e.g., 424) (e.g., as described above with respect to FIG. 4N). In some embodiments, the first computer system ceases display of the call user interface based on a determination that the request to initiate the communication is not accepted. In some embodiments, the first computer system ceases display of the call user interface in response to detecting that the communication between the first computer system and the second computer system ends. In some embodiments, the first computer system ceases display of the call user interface in response to the first computer system detecting an input while the communication between the first computer system and the second computer system is ongoing. Displaying a call user interface when calling another computer system as a result of a subject not being authenticated allows the first computer system to indicate to the subject what is occurring, thereby performing an operation when a set of conditions has been met without requiring further user input.

In some embodiments, the call user interface includes an identification (e.g., 428a) (e.g., a photo, a video, initials, initials and/or a name) of a subject (e.g., 472) that is registered with the first computer system (e.g., 400) (e.g., as described above with respect to FIG. 4N). In some embodiments, the identification of subject that is registered with the first computer system is selectable. In some embodiments, the

In some embodiments, the call user interface (e.g., 428 and/or 416) does not include an identification (e.g., a photo, a video, initials, initials and/or a name) of a subject that is registered with the first computer system (e.g., as described above with respect to FIG. 4N). Displaying a call user interface without an indication of who is being called when calling another computer system as a result of a subject not being authenticated allows the first computer system to indicate to the subject what is occurring without providing information that the subject might not be required to know (e.g., who is being called), thereby performing an operation when a set of conditions has been met without requiring further user input.

In some embodiments, the first computer system (e.g., 400) is in communication (e.g., wireless communication and/or wired communication) with (and/or includes) one or more audio components (e.g., a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output), one or more cameras (e.g., a periscope camera, a telephoto camera, a wide-angle camera, and/or an ultra-wide-angle camera), and one or more microphones. In some embodiments, after sending the request to initiate the communication, the first computer system receives an acceptance of the request to initiate the communication (e.g., as described above with respect to FIGS. 4M-4N). In some embodiments, the first computer system receives the acceptance of the request to initiate the communication from the second computer system. In some embodiments, the first computer system receives the acceptance of the request to initiate the communication from a computer system other than the second computer system. In some embodiments, the first computer system displays a user interface that corresponds to the communication in response to receiving the acceptance of the request to initiate the communication. In some embodiments, in conjunction with (e.g., and/or in response to) receiving the acceptance of the request to initiate the communication, the first computer system outputs, via the one or more audio components, a representation of audio data received from the second computer system (e.g., 424) (e.g., receiving audio data from the second computer system) without displaying (e.g., via the one or more display components) a representation of a field-of-view of one or more cameras of the second computer system (e.g., as described above with respect to FIG. 4N) (e.g., without receiving video data from the second computer system). In some embodiments, the first computer system outputs the representation of the audio data received from the second computer system in response to and/or in conjunction with receiving the audio data from the second computer system. In some embodiments, the first computer system does not display a representation of a field-of-view of the one or more cameras of the first computer system because the second computer system does not transmit video data and/or the first computer system does not receive video data. In some embodiments, the first computer system updates the representation of the field-of-view of the one or more cameras of the second computer system based on movements of the second computer system. In some embodiments, in conjunction with receiving the acceptance of the request to initiate the communication, the first computer system transmits video data corresponding to (e.g., captured by, directed to, related to, and/or associated with) one or more cameras of the first computer system to the second computer system (e.g., as described above with respect to FIG. 4N). In some embodiments, in conjunction with receiving the acceptance of the request to initiate the communication, the first computer system transmits audio data corresponding to (e.g., captured by, directed to, related to, and/or associated with) the one or more microphones of the first computer system to the second computer system (e.g., as described above with respect to FIG. 4N). In some embodiments, the first computer system displays a representation of the video data corresponding to the one or more cameras of the first computer system. In some embodiments, the first computer ceases to transmit the video data corresponding to the one or more cameras of the first computer system and to the audio data corresponding to the one or more microphones of the first computer system in response to detecting one or more inputs. Sending video and audio while receiving audio but not video allows the first computer system to maintain visual privacy of the second computer system while on a call to determine whether to authenticate a subject at the first computer system, thereby performing an operation when a set of conditions has been met without requiring further user input.

In some embodiments, after (or before) outputting the representation of the audio data received from the second computer system (e.g., 424) without displaying the representation of the field-of-view of one or more cameras of the second computer system, the first computer system receives video data (e.g., as described above with respect to FIG. 4N). In some embodiments, the first computer system receives the video data from the second computer system or from a computer system different from the second computer system. In some embodiments, in response to receiving (e.g., or in conjunction with receiving) the video data from the second computer system, the first computer system displays, via the one or more display components, a representation of the video data (e.g., as described above with respect to FIG. 4N) (e.g., while or without outputting a representation of audio data that is received from the second computer system). In some embodiments, the first computer system updates the representation of the video data based on one or more movements of the second computer system. In some embodiments, the first computer system ceases display of the representation of the video data based on a determination that the communication between the first computer system and the second computer system ends. While initially receiving audio but not video, eventually receiving both audio and video allows the second computer system to maintain visual privacy while on a call to determine whether to authenticate a subject at the first computer system until a user of the second computer system feels comfortable with sharing video, thereby performing an operation when a set of conditions has been met without requiring further user input.

In some embodiments, in accordance with a determination that the input (e.g., 405m1) corresponding to the control (e.g., 468c) for initiating a communication with another computer system is detected at a first time (e.g., first time of day, morning, afternoon, or evening), the second computer system (e.g., 424) is a computer system that corresponds to (e.g., is associated with, owned by, related to, and/or registered with) a first registered subject (e.g., 472) (e.g., as described above with respect to FIGS. 4M-4N) (e.g., a subject that is registered with the first computer system). In some embodiments, in accordance with a determination that the input corresponding to the control for initiating a communication with another computer system is detected at a second time (e.g., second time of day, morning, afternoon, or evening), the second computer system is a computer system that corresponds to (e.g., is associated with, owned by, related to, registered with) to a second registered subject (e.g., 430) (e.g., as described above with respect to FIGS. 4M-4N) (e.g., a subject that is registered with the first computer system). In some embodiments, the second registered subject is different from the first registered subject. In some embodiments, the second time is different from the first time. In some embodiments, the computer system that corresponds to the first registered subject is separate (and/or different) from the computer system that corresponds to the second registered subject (e.g., different computer systems are communicated with depending on a time, such that certain computer systems are communicated with during certain times and other computer systems are communicated with during other times). In some embodiments, the second computer system corresponds to a third registered subject irrespective of what time the input corresponding to the control for initiating a communication with another computer system is detected. Providing a control to contact different computer systems at different times allows the first computer system to cater its contact to when different computer systems are configured to be used, thereby performing an operation when a set of conditions has been met without requiring further user input.

In some embodiments, the computer system is in communication (e.g. wired communication and/or wireless communication) with (or includes) one or more illumination components (e.g., one or more lights and/or a flashlight). In some embodiments, in response to detecting the subject in the environment and in accordance with the determination that the subject is recognized, the first computer system illuminates, via the one or more light components, a first portion of the first computer system that corresponds to a security feature (e.g., a mechanical lock, an electric lock, and/or a credential sensor) of the first computer system (e.g., 400) (e.g., as described above with respect to FIGS. 4A-4B) (e.g., without illuminating a second portion of the first computer system). In some embodiments, the first computer system ceases illumination of the first portion of the first computer system in response to detecting a presence of a personal device within a proximity threshold of the first portion of the first computer system. In some embodiments, the first computer system ceases illumination of the first portion of the first computer system after the first portion of the first computer system has been illuminated for a threshold amount of time (e.g., 5 seconds to 2 minutes). In some embodiments, the first computer system does not illuminate the first portion of the first computer system in response to detecting the subject in the environment and in accordance with the determination that the subject is not recognized. Selectively illuminating a portion of the first computer system depending on whether a subject is recognized allows the first computer system to direct recognized users but not direct unrecognized users, thereby performing an operation when a set of conditions has been met without requiring further user input.

Note that details of the processes described above with respect to process 600 (e.g., FIG. 6) are also applicable in an analogous manner to other processes described herein. For example, process 600 optionally includes one or more of the characteristics of the various processes described above with reference to process 600. For example, the control of process 600 is displayed in conjunction with the output of on the indication in process 500. For brevity, these details are not repeated herein.

FIGS. 7A-7F illustrate exemplary user interfaces and techniques for identifying a subject based on one or more characteristics in accordance with some embodiments. The user interfaces in these figures are used to illustrate the processes described below, including the processes in FIG. 8.

FIGS. 7A-7F illustrate resident device 400 on the left and representation of field of view 700 on the right. Representation of field of view 700 is a representation of a field of view of a camera (e.g., or two or more cameras) that is in communication with resident device 400. In some embodiments, the camera is positioned in the location (e.g., home, room, and/or building) of resident device 400. In some embodiments, the camera is not positioned in the location of resident device 400. As illustrated in FIG. 7A, resident device 400 displays home screen user interface 412, which includes indications of the date (e.g., “January 27”) and the time (e.g., “8:00 AM”). At FIG. 7A, a subject named Miles is in the field-of-view of the camera holding personal computer system (e.g., smartphone, smartwatch, and/or tablet). Accordingly, at FIG. 7A, representation of field of view 700 includes representation of guest 712 that is representative of Miles holding representation of personal computer system 776 that is representative of the personal computer system of Miles. At FIG. 7A, the camera detects Miles as moving towards resident device 400.

Between FIGS. 7A and 7B, in response to detecting Miles moving towards resident device 400, the camera identifies Miles. That is, between FIGS. 7A and 7B, the camera captures an image and/or video of Miles and identifies Miles by comparing the newly captured image and/or video of Miles with a previously captured image and/or video of Miles. As a part of identifying Miles, the camera detects and stores one or more characteristics of Miles. More specifically, the camera detects and stores data corresponding to an outfit of Miles (e.g., the polka-dot sweater). In some embodiments, the one or more characteristics includes a shape of one or more portions (e.g., head, torso, legs) of Miles. In some embodiments, the one or more characteristics include physical characteristics of Miles such as facial hair, a hair style, glasses, and/or tattoo that Miles has. In some embodiments, the one or more characteristics include one or more accessories that Miles is wearing (e.g., a necklace, rings, and/or glasses).

It should be recognized that, for a predetermined period of time (e.g., 12-48 hours) after the camera detects the one or more characteristics of Miles while the camera identifies Miles using the image, the camera can identify Miles based on the one or more detected characteristics of Miles (e.g., the outfit of Miles) when the camera is not able to identify Miles using and image and/or video of Miles. In some embodiments, the camera can detect different features of Miles during the predetermined period of time and use said features to identity Miles for a different period of time. For example, if the camera detects that Miles is wearing a hat during the predetermined period of time, the camera can identify Miles based on Miles wearing the hat during a second period of time that follows the predetermined period of time.

It should also be recognized that, once the predetermined period of time expires, the camera will no longer be able identify Miles based on the detection of the one or more characteristics of Miles. In some embodiments, the camera identifies Miles using an image and/or video of Miles (e.g., using facial analysis) before the predetermined period of time has elapsed.

At FIG. 7B, in response to successfully identifying Miles, the camera sends the identity of Miles to resident device 400. At FIG. 7B, in response to receiving the identification of Miles, resident device 400 initiates an authentication process. At FIG. 7B, resident device 400 is able to automatically authenticate Miles through communicating with the personal computer system (e.g., representation of personal computer system 776) of Miles. As illustrated in FIG. 7B, in response to automatically authenticating Miles, resident device 400 displays notification 420 (e.g., an indication welcoming Miles home). Notification 420 includes image 724 that is an image of Miles. In some embodiments, image 724 is a profile picture that an administrator of resident device 400 has selected to represent Miles. In some embodiments, image 724 is an image of Miles that is captured by a camera connected to and/or in communication with resident device 400. In some embodiments, rather than display notification 420, resident device 400 audibly outputs, “Welcome home, Miles.”

In between FIGS. 7B-7C, eight hours and thirty-three minutes elapses. It should be recognized that, during the period between FIGS. 7B-7C, Miles left the location (e.g., home and/or building) of resident device 400 has returned to the location of resident device 400. At FIG. 7C, Miles is in the field-of-view of the camera, but the camera cannot detect his face because Miles is not facing the camera. At FIG. 7C, though Miles is not facing the camera, the camera is able to identify Miles using the clothes that Miles is wearing. That is, at FIG. 7C, the camera identifies Miles based on the detection of the previously detected characteristics (e.g., the clothes of Miles). More specifically, the camera is able to identify Miles at FIG. 7C because the clothes that Miles is presently wearing are the same clothes that Miles was wearing earlier when the camera identified Miles based on his facial features. In some embodiments, the camera is configured to not identify certain types of subjects (e.g., guest and/or subjects that are not registered with resident device 400) based on the detection of one or more previously detected characteristics. For example, in a scenario where a subject that is not registered with resident device 400 is detected by the camera, the camera will identify the unregistered subject based on one or more facial characteristics and not clothes of the unregistered subject.

At FIG. 7D, in response to successfully identifying Miles, the camera sends the identification of Miles n to resident device 400. As illustrated in FIG. 7D, in response to receiving the identity of Miles, resident device 400 initiates the authentication process. At FIG. 7D, resident device 400 is able to automatically authenticate Miles through communicating with Miles' personal computer system (e.g., representation of personal computer system 776). As illustrated in FIG. 7D, in response to automatically authenticating Miles, resident device 400 displays notification 420 (e.g., an indication welcoming Miles to the location).

In between FIGS. 7D-7E, thirteen hours and fifteen minutes have passed (e.g., twenty-five hours and fifteen minutes have passed since FIG. 7B), and a new day has begun. It should be recognized that, during the period between FIGS. 7D-7E, Miles has left the location of resident device 400 (e.g., the home that resident device 400 is registered with) and has now returned to the location. As illustrated in FIG. 7E, Miles is still wearing the same polka-dot sweater.

As illustrated in FIG. 7E, Miles is positioned within the field-of-view of the camera but is not facing the camera. At FIG. 7E, because Mile's is in the field-of-view of the camera, the camera attempts to identify Miles. At FIG. 7E, the camera is unable to identify Miles through facial recognition (e.g., because Miles is not facing the camera) and the camera is not able to identify Miles based on the detection of the previously detected one or more characteristics of Miles (e.g., the outfit of Miles). That is, at FIG. 7E, the predetermined period of time since Miles was identified while the camera detected the one or more characteristics of Miles has elapsed. Accordingly, the camera is no longer able to identify Miles solely based on the previously detected one or more characteristics. At FIG. 7E, because the camera is unable to identify Miles, the camera sends a notification to resident device 400 that the identity of Max cannot be determined.

As illustrated in FIG. 7F, in response to receiving the notification that the camera is unable to identify Miles, resident device 400 displays identification user interface 468. Identification user interface 468 includes an indication that the identity of Miles cannot be determined (e.g., “Welcome” and “Home doesn't recognize you. Please identify yourself to home members.”). Identification user interface 468 also includes image 468a, PIN control 468b, and contact control 468c. As illustrated in FIG. 4J, because the identity of Miles cannot be determined, image 468a is a default image of an icon of an individual.

In some embodiments, in response to detecting an input directed to PIN control 468b, resident device 400 ceases display of identification user interface 468 and displays an authentication user interface (e.g., as illustrated in FIG. 4G) that corresponds to a manual method of authenticating a subject. In some embodiments, in response to detecting an input directed to contact control 468c, resident device 400 ceases display of identification user interface 468 and sends a telecommunications connection request to a personal computer system of an administrator of resident device 400 (e.g., a homeowner of a home that resident device 400 is registered with). In some embodiments, in response to receiving the notification that the camera is unable to identify Miles, resident device 400 sends a notification to a personal computer system of an administrator (e.g., homeowner and/or resident of the home of resident device 400) that indicates that an unknown subject is at the location of resident device 400.

FIG. 8 is a flow diagram illustrating a process (e.g., process 800) for identifying a subject based on one or more characteristics in accordance with some embodiments. Some operations in process 800 are, optionally, combined, the orders of some operations are, optionally, changed, and some operations are, optionally, omitted.

As described below, process 800 provides an intuitive way for identifying a subject based on one or more characteristics. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a computer system (e.g., 400) that is in communication (e.g., wired communication and/or wireless communication) with (and/or includes) one or more output devices (e.g., one or more display components, one or more audio components, and/or one or more haptic components) that includes one or more display components. In some embodiments, the computer system is a watch, a phone, a tablet, a fitness tracking device, a processor, a head-mounted display (HMD) device, a communal device, a media device, a speaker, a television, and/or a personal computing device. In some embodiments, the one or more display components include a display screen, a projector, a head mounted display, and/or a touch-sensitive display. In some embodiments, the one or more audio components include a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output. In some embodiments, the computer system is in communication with one or more input devices. In some embodiments, the one or more input devices include a camera, a depth sensor, a microphone, a hardware input mechanism, a rotatable input mechanism, a physical input mechanism, a button, a crown, a knob, a dial, a physical slider, an accelerometer, and/or a touch-sensitive surface. In some embodiments, the computer system is a resident device (e.g., a device that is permanently installed within a location and/or is part of a connected network at the location, a device that is actively connected to a network at the location and/or consistently part of a network at the location, an always-on device at the location, a permanent device, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

In conjunction with (e.g., while, before and/or after) recognizing (e.g., identifying, authenticating, verifying, and/or confirming an identity), the computer system uses (802) a first set of one or more features (e.g., user biometric, one or more facial characteristics, fingerprint, iris, voice, password, and/or PIN code) corresponding to a subject (e.g., 712) (e.g., a user, a guest, a personal device of a user, and/or an individual), the subject, detecting, via the one or more input devices, a second set of one or more features corresponding to (e.g., directed to, associated with, and/or worn by) the subject, wherein the second set of one or more features is different from the first set of one or more features (e.g., as described above with respect to FIGS. 7A-7B). In some embodiments, the second set of one or more features includes physical characteristics of the subject such as clothing, shoes, a hat, accessories worn, a birthmark and/or their torso. In some embodiments, the second set of one or more features is detected via a camera of the computer system. In some embodiments, data corresponding to the second set of one or more features is stored on the computer system. In some embodiments, the second set of one or more features corresponds to a user profile of the subject for a threshold period of time. In some embodiments, the subject is detected via the one or more input devices, such as a camera and/or a microphone. In some embodiments, the second set of one or more feature is detected while the computer system authenticates the subject. In some embodiments, the second set of one or more features are stored on a computer system (e.g., the computer system and/or another computer system (e.g., an external device in communication with the computer system such as a personal device of a resident), different from the computer system, for a predefined threshold of time). In some embodiments, the first set of one or more features are not specific to the subject. In some embodiments, the second set of one or more features are not specific to the subject.

After detecting the second set of one more feature, the computer system detects (804), via the one or more input devices, the subject using the second set of one or more features (e.g., as described above with respect to FIG. 7C and/or FIG. 7E). In some embodiments, the subject is detected before an identity of the subject is detected. In some embodiments, the identity of the subject is detected while the subject is detected using the first set of one or more features. In some embodiments, the subject is detected via a computer system other than the computer system. In some embodiments, the subject is detected via one or more microphones of the computer system and/or one or more cameras of the computer system. In some embodiments, the subject is detected in an environment of the computer system, an environment external to the computer system, a home, a room, a yard, and/or a building.

In response to (806) detecting the subject using the second set of one or more features, in accordance with a determination that the subject is detected using the second set of one or more features within a predetermined threshold of time (e.g., 1 hours-twenty-four hours) since the computer system recognized the subject using the first set of one or more features (e.g., with or without using the second set of one or more features), the computer system displays (808), via the one or more display components, an indication (e.g., 420 and/or 724) (e.g., a graphical indication and/or textual indication) that the subject is recognized (e.g., and/or identified) (e.g., as described above with respect to FIG. 7D). In some embodiments, the indication includes a visual output (e.g., a video, an image, an animation, a 3D rendering, a motion graphic, a data visualization, and/or a digital art) corresponding to the subject. In some embodiments, the indication includes an identification of identifying factors (e.g., name and/or representation of the subject) of the subject. In some embodiments, while displaying the indication, the computer system outputs a second indication (e.g., audio output and/or light output) via the computer system and/or another computer system external from the computer system. In some embodiments, the second set of one or more features includes a biometric of the subject and/or a PIN of the subject.

In response to (806) detecting the subject using the second set of one or more features, in accordance with a determination that the subject is detected using the second set of one or more features after the predetermined threshold of time since the computer system recognized the subject using the first set of one or more features, the computer system forgoes (910) display of, via the one or more display components, the indication that the subject is recognized (e.g., as described above with respect to FIG. 7F). In some embodiments, in response to detecting the subject in the environment and in accordance with the determination that the subject is detected using the first set of one or more features after the predetermined threshold of time since the computer system authenticated the subject using the second set of one or more features, the computer system causes a computer system external to the computer system to display an indication that the subject is not recognized. In some embodiments, in response to detecting the subject in the environment and in accordance with the determination that the subject is detected using the first set of one or more features after the predetermined threshold of time since the computer system authenticated the subject using the second set of one or more features, the computer system outputs an indication that the user is not recognized. Selectively using a first set of one or more features to recognize a subject depending on whether a second set of one or more features were used to recognize the subject within a predetermined threshold of time allows the computer system to lighten its requirements for recognizing when attempting to recognize within the predetermined threshold of time, thereby performing an operation when a set of conditions has been met without requiring further user input.

In some embodiments, the indication that the subject is recognized is a first indication. In some embodiments, in response to (e.g., in conjunction with and/or after) recognizing, the computer system uses the first set of one or more features corresponding to the subject, the subject, displaying, via the one or more display components, a second indication (e.g., 420 and/or 724 as illustrated in FIG. 7B) (e.g., graphical indication and/or textual indication) that the subject is recognized (e.g., as described above with respect to FIGS. 7A-7B). In some embodiments, the second indication includes an identity of the subject. In some embodiments, the second indication includes an indication of how the subject was recognized and/or how the subject is authenticated. In some embodiments, the second indication includes subject-specific content and/or a subject-specific control. Displaying an indication that a subject is recognized when the subject is recognized using a set of one or more features allows the computer system to indicate a state of authentication for the subject, thereby performing an operation when a set of conditions has been met without requiring further user input.

In some embodiments, the first indication (e.g., 420 and/or 724 as illustrated in FIG. 7B) and the second indication (e.g., 420 and/or 724 as illustrated in FIG. 7D) are the same (e.g., as described above with respect to FIGS. 7A-7D). In some embodiments, the first indication that the subject is recognized and the second indication that the subject is recognized are different. Displaying the same indication of a subject regardless of whether the subject is authenticated using a first set of one or more features or a second set of one or more feature allows the computer system to provide a consistent user interface when interacting with subjects, thereby performing an operation when a set of conditions has been met without requiring further user input.

In some embodiments, the second set of one or more features includes one or more articles of clothing (e.g., shirt, pants, shoes, hat, and/or socks) of the subject (e.g., 712) (e.g., as described above with respect to FIGS. 7A-7F). In some embodiments, the second set of one or more features consists of the one or more articles of clothing of the subject. Selectively using one or more articles of clothes to recognize a subject depending on whether another set of one or more features were used to recognize the subject within a predetermined threshold of time allows the computer system to lighten its requirements for recognizing when attempting to recognize within the predetermined threshold of time, thereby performing an operation when a set of conditions has been met without requiring further user input.

In some embodiments, the second set of one or more features includes a shape of a portion (e.g., upper torso, head, lower torso, legs, and/or arms) of the subject (e.g., 712) (e.g., as described above with respect to FIGS. 7A-7F). Selectively using a shape of a subject to recognize the subject depending on whether another set of one or more features were used to recognize the subject within a predetermined threshold of time allows the computer system to lighten its requirements for recognizing when attempting to recognize within the predetermined threshold of time, thereby performing an operation when a set of conditions has been met without requiring further user input.

In some embodiments, the first set of one or more features includes one or more biometrics (e.g., voice, facial biometric, thumbprint, and/or eye iris) of the subject (e.g., 712) (e.g., as described above with respect to FIGS. 7A-7F). In some embodiments, the first set of one or more features consist of the one or more biometrics of the subject. Selectively using a set of one or more features to recognize a subject depending on whether one or more biometrics were used to recognize the subject within a predetermined threshold of time allows the computer system to lighten its requirements for recognizing when attempting to recognize within the predetermined threshold of time, thereby performing an operation when a set of conditions has been met without requiring further user input.

In some embodiments, the predetermined threshold of time is a first predetermined threshold of time. In some embodiments, after detecting the subject (e.g., 712) using the second set of one or more features, the computer system detects, via the one or more input devices, a third set of one or more features (e.g., clothing, shoes, body shape, biometrics, facial shape, voice, and/or facial features) corresponding to (e.g., directed to, associated with, and/or worn by) the subject within the first predetermined threshold of time since the computer system recognized the subject using the first set of one or more features, wherein the third set of one or more features is different from the second set of one or more features and (or) the first set of one or more features (e.g., as described above with respect to FIGS. 7C-7F). In some embodiments, the third set of one or more features includes physical characteristics of the subject such as clothing, shoes, a hat, accessories worn, a birthmark and/or their torso. In some embodiments, the third set of one or more features is detected via a camera of the computer system. In some embodiments, data corresponding to the third set of one or more features is stored on the computer system. In some embodiments, the third set of one or more features corresponds to a user profile of the subject for a threshold period of time. In some embodiments, the third set of one or more feature is detected while the computer system authenticates the subject. In some embodiments, data corresponding to the third set of one or more features are stored on a computer system (e.g., the computer system and/or another computer system (e.g., an external device in communication with the computer system such as a personal device of a resident), different from the computer system, for a predefined threshold of time). In some embodiments, after detecting the third set of one or more features corresponding to the subject, the computer system detects, via the one or more input devices, the subject using the third set of one or more features (e.g., as described above with respect to FIGS. 7C-7F). In some embodiments, in response to detecting the subject using the third set of one or more features and in accordance with a determination that the subject is detected using the third set of one or more features within a second predetermined threshold of time (e.g., 30-480 minutes) since computer system recognized the subject using the first set of one or more features, the computer system displays, via the one or more display components, the indication that the subject is recognized, wherein the second predetermined threshold of time is different (e.g., longer or shorter) from the first predetermined threshold of time (e.g., as described above with respect to FIGS. 7C-7F). In some embodiments, the third set of features and the second set of features correspond to a common body part of the subject. In some embodiments, the third set of features and the second set of features are detected via a common modality. In some embodiments, the third set of features and the second set of features are detected via different modalities. In some embodiments, the third set of features is physical trait of the subject. In some embodiments, the third set of features is not a physical trait of the subject. Selectively using different sets of one or more features to recognize a subject depending on whether another second set of one or more features were used to recognize the subject within different predetermined thresholds of time allows the computer system to lighten its requirements differently for recognizing when attempting to recognize within different predetermined thresholds of time, thereby performing an operation when a set of conditions has been met without requiring further user input.

In some embodiments, the one or more input devices includes one or more cameras (e.g., a periscope camera, a telephoto camera, a wide-angle camera, and/or an ultra-wide-angle camera). In some embodiments, second set of one or more features is detected via the one or more cameras (e.g., as described above with respect to FIGS. 7A-7F). In some embodiments, the second set of one or more features is detected via the one or more cameras and via a different modality. In some embodiments, the second set of one or more features is detected via a subset of the one or more cameras. In some embodiments, the second set of one or more features is detected via each camera included in the one or more cameras.

In some embodiments, the computer system is in communication (e.g., wireless and/or wired) with (and/or includes) one or more cameras (e.g., a periscope camera, a telephoto camera, a wide-angle camera, and/or an ultra-wide-angle camera). In some embodiments, recognizing, using the first set of one or more features corresponding to the subject, the subject includes detecting, via the one or more cameras, the first set of one or more features (e.g., as described above with respect to FIGS. 7A-7B). In some embodiments, the first set of one or more features is detected via the one or more cameras and via a different modality. In some embodiments, the first set of one or more features is detected via a subset of the one or more cameras. In some embodiments, the first set of one or more features is detected via each camera included in the one or more cameras.

In some embodiments, the computer system is in communication (e.g., wireless and/or wired) with (and/or includes) one or more microphones. In some embodiments, recognizing, using the first set of one or more features corresponding to the subject, the subject includes detecting, via the one or more microphones, the first set of one or more features (e.g., as described above with respect to FIGS. 7A-7B). In some embodiments, the first set of one or more features is detected via the one or more microphones and via a different modality.

In some embodiments, the computer system (e.g., 400) is a communal computer system that corresponds to an environment and is connected to one or more computer systems (e.g., within a common ecosystem) within the environment (e.g., as described above with respect to FIGS. 7A-7F) (e.g., a device that is permanently installed within a location and/or is part of a connected network at the location, a device that is actively connected to a network at the location and/or consistently part of a network at the location, an always-on device at the location, a permanent device, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

In some embodiments, the one or more input devices are included (e.g., integrated, joined, and/or combined) in another computer system (e.g., a watch, a phone, a tablet, a fitness tracking device, a processor, a head-mounted display (HMD) device, a communal device, a media device, a speaker, a television, an electronic device, and/or a personal computing device) external to the computer system (e.g., 400) (e.g., as described above with respect to FIGS. 7A-7F). In some embodiments, the one or more input devices are not included (e.g., integrated, joined, and/or combined) in the computer system. In some embodiments, the computer system and the other computer system are in communication. In some embodiments, the one or more input devices are included in the computer system.

In some embodiments, before (or while) detecting the second set of one or more features corresponding to the subject, the computer system receives, from the other computer system (e.g., 776) external to the computer system, an identification (e.g., a name, a photo, initials, and/or a video) of the subject (e.g., as described above with respect to FIGS. 7C-7F). In some embodiments, in response to receiving the identification of the subject, the computer system displays, via the one or more display components, a representation of the identification of the subject. In some embodiments, the identification is captured via one or more cameras of the other computer system external to the computer system.

In some embodiments, the determination that the subject (e.g., 712) is detected using the second set of one or more features does not use the first set of one or more features (e.g., as described above with respect to FIGS. 7C-7F). Selectively using a first set of one or more features to recognize a subject depending on whether a second set of one or more features were used to recognize the subject within a predetermined threshold of time allows the computer system to lighten its requirements for recognizing when attempting to recognize within the predetermined threshold of time, thereby performing an operation when a set of conditions has been met without requiring further user input.

In some embodiments, in response to detecting the subject using the second set of one or more features and in accordance with a determination that the subject is detected using the second set of one or more features after the predetermined threshold of time since the computer system recognized the subject using the first set of one or more features, the computer system performs an operation (e.g., outputting a haptic, outputting an alarm, displaying an indication that the subject is not recognized, outputting a request that the subject authenticate themselves, outputting a request that the subject make their face visible to one or more cameras of the computer system, outputting a request that the subject present identification to the computer system) different from displaying the indication that the subject is recognized (e.g., as described above with respect to FIGS. 7E-7F). In some embodiments, the computer system performs the operation different from displaying the indication that the subject is recognized while the subject remains unrecognized. In some embodiments, the computer system ceases performance of the operation different from displaying the indication while the subject remains unrecognized. Performing an operation without displaying an indication that a subject is recognized when the subject is detected using a lesser set of one or more features too long after a greater set of one or more features is used to recognized the subject allows the computer system to only lighten its requirements for recognizing when attempting to recognize within the predetermined threshold of time, thereby performing an operation when a set of conditions has been met without requiring further user input.

In some embodiments, the operation includes (or is) displaying, via the one or more display components, a request (e.g., 468) for the subject to authenticate themselves (e.g., as described above with respect to FIGS. 7E-7F). In some embodiments, the request for the subject to authenticate themselves includes a request for the subject to enter a subject-specific credential, such as a pin code. In some embodiments, the request for the subject to authenticate themselves includes a request for the subject to bring a personal device (e.g., smart phone, smart watch, and/or tablet) in close proximity to the computer system. In some embodiments, the request for the subject to authenticate themselves includes a request for the subject to authenticate themselves via one or more biometrics of the subject.

In some embodiments, the computer system is a first computer system (e.g, 400). In some embodiments, the operation includes transmitting a notification to a second computer system (watch, a phone, a tablet, a fitness tracking device, a processor, a head-mounted display (HMD) device, a communal device, a media device, a speaker, a television, an electronic device, and/or a personal computing device) different from the first computer system (e.g., as described above with respect to FIGS. 7E-7F). In some embodiments, the in response to transmitting the notification to the second computer system, the first computer system outputs (displays, audibly outputs, and/or outputs a haptic) a notification that the notification has been transmitted. In some embodiments, the first computer system causes the second computer system to display a representation of the notification upon receipt of the notification. In some embodiments, the second computer system is a personal computer system of the subject.

In some embodiments, in accordance with a determination that the subject (e.g., 712) is a first type of subject (e.g., the subject is a guest in a home that the computer system is registered with, the subject is a resident in the home that the computer system is registered with, the subject is a primary resident in the home that the computer system is registered with, and/or the subject is a secondary resident in the home that the computer system is registered with), the predetermined threshold of time is a first amount of time (e.g., 30 minutes-480 minutes) (e.g., as described above with respect to FIGS. 7C-7F). In some embodiments, in accordance with a determination that the subject is a second type of subject (e.g., the subject is a guest in a home that the computer system is registered with, the subject is a resident in the home that the computer system is registered with, the subject is a primary resident in the home that the computer system is registered with, and/or the subject is a secondary resident in the home that the computer system is registered with), the predetermined threshold of time is a second amount of time (e.g., 30 minutes-480 minutes) different from the first amount of time (e.g., as described above with respect to FIGS. 7C-7F). In some embodiments, the second type of subject is different from the first type of subject (e.g., as described above with respect to FIGS. 7C-7F). In some embodiments, the predetermined threshold of time is greater when the subject is a resident of the home that the computer system is registered with in contrast to when the subject is a guest of the home that the computer system is registered with. In some embodiments, the predetermined threshold of time is greater when the subject is the primary resident of the home that the computer system is registered with in contrast to when the subject is the secondary resident of the home that the computer is registered with. In some embodiments, the predetermined threshold of time is not dependent based on the type of subject that is detected. Different types of subjects having different thresholds of time for using lesser authentication mechanisms after greater authentication mechanisms are used allows the computer system to cater its authentication operation based on a type of subject and allow certain types of subjects greater leniency, thereby performing an operation when a set of conditions has been met without requiring further user input.

In some embodiments, the subject is a first subject. In some embodiments, the computer system detects, via the one or more input devices, the second set of one or more features corresponding to a second subject, wherein the second subject is different from the first subject (e.g., as described above with respect to FIGS. 7A-7B). In some embodiments, the computer system detects the second set of one or more features corresponding to the second subject before or after recognizing, using first set of one or more features corresponding to the second subject, the second subject. In some embodiments, the first subject and the second subject are classified differently (e.g., the first subject is classified as a resident of the home that is registered with the computer system and the second subject is classified as a guest of the home that is registered with the computer system). In some embodiments, after detecting the second set of one or more features corresponding to the second subject, the computer system detects, via the one or more input devices, the second subject using the second set of one or more features (e.g., as described above with respect to FIG. 7C and/or FIG. 7E). In some embodiments, the second subject is detected via a computer system other than the computer system. In some embodiments, the second subject is detected via one or more microphones of the computer system and/or one or more cameras of the computer system. In some embodiments, the second subject is detected in an environment of the computer system, an environment external to the computer system, a home, a room, a yard, and/or a building. In some embodiments, in response to detecting the subject using the second set of one or more features and in accordance with a determination that the second subject is detected using the second set of one or more features within the predetermined threshold of time since the computer system recognized the second subject using the first set of one or more features, the computer system forgoes display of, via the one or more display components, an indication (e.g., 420) (e.g., a textual indication and/or graphical indication) that the second subject is recognized (e.g., as described above with respect to FIG. 7F). In some embodiments, in response to detecting the subject using the second set of one or more features and in accordance with a determination that the second subject is detected using the second set of one or more features within the predetermined threshold of time since the computer system recognized the second subject using the first set of one or more features, the computer system displays an indication that the second subject is not recognized. In some embodiments, after forgoing display of the indication that the second subject is recognized, the computer system detects, via the one or more input devices, the second subject using the first set of one or more features. In some embodiments, in response to detecting the second subject using the first set of one or more features, the computer system displays, via the one or more display components, the indication that the second subject is recognized (e.g., as described above with respect to FIG. 7F). In some embodiments, the indication that the second subject is recognized includes a visual output (e.g., a video, an image, an animation, a 3D rendering, a motion graphic, a data visualization, and/or a digital art) corresponding to the second subject. In some embodiments, the indication that the second subject is recognized includes an identification of identifying factors (e.g., name and/or representation of the subject) of the second subject. In some embodiments, while displaying the indication that the second subject is recognized, the computer system outputs a second indication (e.g., audio output and/or light output) via the computer system and/or another computer system external from the computer system. Requiring a greater level of authentication for certain types of subjects while other types of subjects are allowed a lesser level of authentication allows the computer system to cater its authentication operation based on a type of subject and allow certain types of subjects greater leniency, thereby performing an operation when a set of conditions has been met without requiring further user input.

In some embodiments, the subject (e.g., 712) is a first subject. In some embodiments, before recognizing, the computer system uses the first set of one or more features corresponding to a third subject, the third subject, detecting, via the one or more input devices, a third set of one or more features (e.g., a body shape, a head shape, and/or characteristics of a voice) corresponding to (directed to, associated with, and/or at a location of) the third subject (e.g., a subject that is registered with the computer system, a subject that is not registered with the computer system, a subject that is a resident of the home corresponding to the computer system, a subject that is a guest of the home corresponding to the computer system), wherein the third subject is different from the first subject (e.g., as described above with respect to FIGS. 7A-7F). In some embodiments, after detecting the third set of one or more features corresponding to the third subject, the computer system detects, via the one or more input devices, the third subject using the third set of one or more features (e.g., as described above with respect to FIGS. 7A-7F). In some embodiments, in response to detecting the third subject using the third set of one or more features, in accordance with a determination that the third subject is a first type of subject (e.g., the third subject is a guest in a home that the computer system is registered with, the third subject is a resident in the home that the computer system is registered with, the third subject is a primary resident in the home that the computer system is registered with, and/or the third subject is a secondary resident in the home that the computer system is registered with), the computer system displays, via the one or more display components, an indication that the third subject is recognized (e.g., as described above with respect to FIG. 7D). In some embodiments, the indication that the third subject is recognized includes a visual output (e.g., a video, an image, an animation, a 3D rendering, a motion graphic, a data visualization, and/or a digital art) corresponding to the second subject. In some embodiments, the indication that the third subject is recognized includes an identification of identifying factors (e.g., name and/or representation of the subject) of the third subject. In some embodiments, while displaying the indication that the third subject is recognized, the computer system outputs a second indication (e.g., audio output and/or light output) via the computer system and/or another computer system external from the computer system. In some embodiments, in response to detecting the third subject using the third set of one or more features, in accordance with a determination that the third subject is a second type of subject (e.g., the third subject is a guest in a home that the computer system is registered with, the third subject is a resident in the home that the computer system is registered with, the third subject is a primary resident in the home that the computer system is registered with, and/or the third subject is a secondary resident in the home that the computer system is registered with), the computer system forgoes display of, via the one or more display components, the indication that the third subject is recognized (e.g., as described above with respect to FIG. 7F). Allowing certain types of subjects to be authenticated using mechanisms not allowed for other types of subjects allows the computer system to cater its authentication operation based on a type of subject and allow certain types of subjects greater leniency, thereby performing an operation when a set of conditions has been met without requiring further user input.

Note that details of the processes described above with respect to process 800 (e.g., FIG. 8) are also applicable in an analogous manner to the processes described herein. For example, process 500 optionally includes one or more of the characteristics of the various processes described herein with reference to process 800. For example, the subject of process 500 is identified based on one or more characteristics of process 800. For brevity, these details are not repeated herein.

FIGS. 9A-9V illustrate exemplary user interfaces for displaying and ceasing to display content in response to input in accordance with some embodiments. The user interfaces in these figures are used to illustrate the processes described below, including the processes in FIGS. 5-7.

FIGS. 9A-9V illustrate computer system 900 as a smart phone. It should be recognized that computer system 900 can be other types of computer systems such as a tablet, a smart watch, a laptop, a communal device, a smart speaker, an accessory, a personal gaming system, a desktop computer, a fitness tracking device, and/or a head-mounted display (HMD) device. In some embodiments, computer system 900 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 900 includes and/or is in communication with one or more output devices (e.g., a display screen, a projector, a touch-sensitive display, a speaker, and/or a movement component). In some embodiments, computer system 900 includes one or more components and/or features described above in relation to computer system 100 and/or electronic device 200.

FIGS. 9A-9V are split between a left side and a right side to illustrate a subject in a physical environment interacting with computer system 990 via computer system 900. In the examples illustrated in FIGS. 9A-9V, the right side illustrates a top-down schematic view of physical environment 906 that includes tablet representation 908 (e.g., representing a tablet located in the environment, and first user representation 904 (e.g., a person interacting with computer system 900 by providing inputs, the first user). In some embodiments, the relative positioning of first user representation 910 is indicative of relative physical positioning of the first user in a physical environment. The left side of FIGS. 9A-9V illustrate output of computer system 900. While FIGS. 9A-9V illustrate computer system 900 outputting particular content, it should be recognized that such content is merely for explanatory purposes and that such content can be in different forms, at different locations, at different sizes, include different content, and/or that more, fewer, and/or different content can be output in accordance with techniques described herein.

While the examples in FIGS. 9A-9V include computer system 990 detecting one or more inputs, it should be recognized that such inputs are merely for explanatory purposes and that such inputs can be other types of inputs such as voice inputs via one or more microphones, touch inputs via one or more touch-sensitive surfaces, physical inputs via one or more physical input mechanisms, and/or hand-gesture inputs via one or more cameras. In some embodiments, inputs detected by computer system 990 are passive inputs that are not purposefully directed at computer system 990 by a subject (e.g., a person, an animal, an object, and/or a device). Examples of such inputs include, but are not limited to, motion of the subject through the environment, location of the subject within the environment, direction that the subject is facing and/or looking, light levels within the environment, and/or sound levels within the environment.

FIG. 9A illustrates computer system 900 displaying environment activities user interface 902. As illustrated in FIG. 9A, within environment activities user interface 902, computer system 900 displays one or more indications of activities detected by computer system 990 within in the environment in the order that they were detected.

FIG. 9B illustrates computer system 900 displaying user activity user interface 920. As illustrated in FIG. 9B, within user activity user interface 920, computer system 900 displays one or more indications of activities of a registered user (e.g., the first user) that are detected by computer system 990 within the environment. As illustrated in FIG. 9B, computer system 900 displays the indications of activities of the registered user in the order that they were detected.

FIG. 9C illustrates computer system 900 displaying user activity user interface 920 after a recognition scenario. In this recognition scenario, when the first user enters the environment, computer system 990 detects computer system 900, which is associated with the first user, and the first user's face is recognized by computer system 990 via one or more cameras in communication with computer system 990. At FIG. 9C, in response to the first user being detected at the environment, via computer system 990 detecting computer system 900, computer system 990 outputs a chime via living room smart speaker, as indicated by music notes 922. Also at FIG. 9C, in response to the first user being recognized by computer system 990, computer system 990 outputs a greeting to the first user (e.g., “Welcome home, Jane.”) via the living room smart speaker, as indicated by output 924. At FIG. 9C, in response to the first user arriving at the environment with computer system 900 and computer system 990 recognizing the first user, computer system 990 activates the cooling of the environmental control system of the environment to 68 degrees. It should be noted that this is just an example and that other automations of the environment can be activated, such as lights, shades, music, televisions, and/or locks.

FIG. 9D illustrates computer system 900 displaying user activity user interface 920 after a first scenario where computer system 990 does not recognize the first user and requires a second form of authentication to confirm the user. At FIG. 9D, the first user arrives at the environment and is detected by computer system 990 by detecting computer system 900. At FIG. 9D, in response to the first user being detected at the environment, via computer system 990 detecting computer system 900, computer system 990 outputs a chime via living room smart speaker, as indicated by music notes 922. At FIG. 9D, in response to the first user arriving at the environment with their face obscured (e.g., wearing a head, scarf, facemask, makeup, and/or glasses), computer system 990 requires the first user to verify their identity in a secondary manner. At FIG. 9D, the first user uses a facial recognition scan to unlock computer system 900 via one or more cameras of computer system 900. At FIG. 9D, in response to the first user unlocking computer system 900 via facial recognition scan, computer system 990 makes a determination that the first user is authenticated. At FIG. 9D, in response to computer system 990 making a determination that the first user is authenticated, computer system 990 computer system 990 outputs a greeting to the first user (e.g., “Welcome home, Jane.”) via the living room smart speaker, as indicated by output 924. At FIG. 9D, in response to the first user arriving at the environment with computer system 900 and computer system 990 making the determination that the first user is authenticated, computer system 990 activates the cooling of the environmental control system of the environment to 68 degrees. It should be noted that this is just an example and that other automations of the environment can be activated, such as lights, shades, music, televisions, and/or locks.

FIG. 9E illustrates computer system 900 displaying user activity user interface 920 after a second scenario where computer system 990 does not recognize the first user and requires a second form of authentication to confirm the user. At FIG. 9E, the first user arrives at the environment and is detected by computer system 990 by detecting computer system 900. At FIG. 9E, in response to the first user being detected at the environment, via computer system 990 detecting computer system 900, computer system 990 outputs a chime via living room smart speaker, as indicated by music notes 922. At FIG. 9E, in response to the first user arriving at the environment with their face obscured (e.g., wearing a head, scarf, facemask, makeup, and/or glasses), computer system 990 requires the first user to verify their identity in a secondary manner. At FIG. 9E, the first user walks up the tablet and the first user's face is recognized by the camera of the tablet. At FIG. 9E, in response to the tablet recognizing the first user's face, computer system 990 makes a determination that the first user is authenticated. At FIG. 9E, in response to computer system 990 making a determination that the first user is authenticated, computer system 990 computer system 990 outputs a greeting to the first user (e.g., “Welcome home, Jane.”) via the living room smart speaker, as indicated by output 924. At FIG. 9E, in response to the first user arriving at the environment with computer system 900 and computer system 990 making the determination that the first user is authenticated, computer system 990 activates the cooling of the environmental control system of the environment to 68 degrees. It should be noted that this is just an example and that other automations of the environment can be activated, such as lights, shades, music, televisions, and/or locks.

FIG. 9F illustrates computer system 900 displaying user activity user interface 920 after a third scenario where computer system 990 does not recognize the first user and requires a second form of authentication to confirm the user. At FIG. 9F, the first user arrives at the environment and is detected by computer system 990 by detecting computer system 900. At FIG. 9F, in response to the first user being detected at the environment, via computer system 990 detecting computer system 900, computer system 990 outputs a chime via living room smart speaker, as indicated by music notes 922. At FIG. 9F, in response to the first user arriving at the environment with their face obscured (e.g., wearing a head, scarf, facemask, makeup, and/or glasses), computer system 990 requires the first user to verify their identity in a secondary manner. At FIG. 9F, computer system 990 sends a notification to the first user's devices requesting that the first user confirm that it is them at the environment. At FIG. 9F, the first user confirms on the first user's smart watch that it is the first user in the environment. At FIG. 9F, in response to the user confirming on the first user's smart watch that it is the first user in the environment, computer system 990 makes a determination that the first user is authenticated. At FIG. 9F, in response to computer system 990 making a determination that the first user is authenticated, computer system 990 computer system 990 outputs a greeting to the first user (e.g., “Welcome home, Jane.”) via the living room smart speaker, as indicated by output 924. At FIG. 9F, in response to the first user arriving at the environment with computer system 900 and computer system 990 making the determination that the first user is authenticated, computer system 990 activates the cooling of the environmental control system of the environment to 68 degrees. It should be noted that this is just an example and that other automations of the environment can be activated, such as lights, shades, music, televisions, and/or locks.

FIG. 9G illustrates computer system 900 displaying user activity user interface 920 after a scenario where the first user arrives at the environment without computer system 900. At FIG. 9F, the first user arrives at the environment and is identified by computer system 990 via one or more cameras in communication with computer system 990. At FIG. 9G, in response to computer system 990 detecting the first user at the environment while not detecting computer system 900, computer system 990 outputs a chime via living room smart speaker, as indicated by music notes 922. At FIG. 9G, in response to computer system 990 detecting the first user at the environment while not detecting computer system 900, computer system 990 outputs content via the living room smart speaker requesting that the first user verify their identity in a secondary manner (e.g., “Hi, Jane. Can you confirm it is you by verifying your PIN.”), as indicated by content 926. At FIG. 9G, the first user enters their PIN via the tablet. At FIG. 9G, in response to the first user entering their PIN via the tablet, computer system 990 makes a determination that the first user is authenticated. In some embodiments, in response to computer system 990 making a determination that the first user is authenticated, computer system 990 computer system 990 outputs a greeting to the first user (e.g., “Welcome home, Jane.”) via the living room smart speaker. At FIG. 9G, in response to the first user arriving at the environment with computer system 900 and computer system 990 making the determination that the first user is authenticated, computer system 990 activates the cooling of the environmental control system of the environment to 68 degrees. It should be noted that this is just an example and that other automations of the environment can be activated, such as lights, shades, music, televisions, and/or locks.

FIG. 9H illustrates computer system 900 displaying user activity user interface 920 after a scenario where the first user arrives at the environment while another registered occupant of the environment (e.g., a second user) is already recognized by computer system 990 at the environment. At FIG. 9H, in response to detecting the first user in the environment, via detecting computer system 900 and/or identifying the first user via one or more cameras in communication with computer system 990, while the second user is already in the environment, computer system 990 outputs a chime via living room smart speaker, as indicated by music notes 922. At FIG. 9H, in response to detecting the first user in the environment while detecting the second user is already in the environment, computer system 990 outputs content via the living room smart speaker alerting the second user that the first user has arrived at the environment (e.g., “Jane is home.”), as indicated by content 928. At FIG. 9H, in response to the second user already being in the environment when the first user is detected, computer system 990 does not activate the cooling of the environmental control system.

FIG. 9I illustrates computer system 900 displaying lock screen user interface 932. At FIG. 9I, a first guest (e.g., Phil), who is registered with computer system 990, arrives at the environment, as indicated by first guest representation 934 being illustrated within physical environment 906, and is recognized by computer system 990. As illustrated in FIG. 9I, in response to computer system 990 recognizing the first guest, computer system 900 displays recognized guest indicator 934 overlayed on lockscreen user interface 932. As illustrated in FIG. 9I, in response to computer system 990 continuing to detect the first guest at the environment, computer system 900 displays recognized guest indicator 934 indicating that the first guest is at the environment (e.g., Phil is at your home).

At FIG. 9H, at a time after FIG. 9I, the first guest (e.g., Phil) who is registered with computer system 990 is no longer at the environment, as indicated by first guest representation 934 not being illustrated within physical environment 906, and is no longer detected by computer system 990. As illustrated in FIG. 9H, in response to computer system 990 no longer detecting the first guest, computer system 900 displays recognized guest indicator 934 overlayed on lock screen user interface 932. As illustrated in FIG. 9H, in response to computer system 990 no longer detecting the first guest at the environment, computer system 900 displays recognized guest indicator 934 indicating that the first guest was formerly at the environment (e.g., Phil visited your home).

FIG. 9J illustrates computer system 900 displays recognized guest activity user interface 946. As illustrated in FIG. 9J, within recognized guest activity user interface 946, computer system 900 displays one or more indications of activities of a recognized guest (e.g., the first guest) that are detected by computer system 990 within the environment. As illustrated in FIG. 9J, computer system 900 displays the indications of activities of a recognized guest in the order that they were detected.

FIG. 9K illustrates computer system 900 displaying lock screen user interface 932. At FIG. 9K, a second guest (e.g., John the plumber), who is not registered with computer system 990, arrive at the environment. In response, computer system 990 outputs content requesting that the unregistered guest.

FIG. 10 is a flow diagram illustrating a process (e.g., process 1000) for outputting a tone based on authentication in accordance with some embodiments. Some operations in process 1000 are, optionally, combined, the orders of some operations are, optionally, changed, and some operations are, optionally, omitted.

As described below, process 1000 provides an intuitive way for outputting a tone based on authentication. Process 1000 reduces the cognitive burden on a user, thereby creating a more efficient human-machine interface. For battery-operated computing devices, enabling a user to interact with such devices faster and more efficiently conserves power and increases the time between battery charges.

In some embodiments, process 1000 is performed at a computer system that is in communication (e.g., wired or wirelessly) with (and/or includes) one or more audio components (e.g., a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

The computer system receives (1002) an indication that a subject has entered (e.g., currently entered or previously entered) an environment (e.g., a home, a room, an office, an environment of the computer system and/or an environment different from the environment of the computer system). In some embodiments, the indication that the subject has entered the environment is received from a computer system that is positioned in the environment. In some embodiments, the indication that the subject has entered the environment is received after the subject is present in the environment for a predetermined period of time (e.g., 5 seconds to 2 minutes).

In response to (1004) receiving the indication that the subject has entered the environment, in accordance with a determination that a first set of one or more criteria is satisfied (e.g., that an authenticated subject is already in the environment, that an identity of the subject is not detected, that the identity of the subject is detected as an unidentified subject, and/or that the subject has been authenticated), the computer system outputs (1006), via the one or more audio components, a first tone (e.g., a beep, a continuous tone, a single beep, and/or a harmony).

In response to (1004) receiving the indication that the subject has entered the environment, in accordance with a determination that a second set of one or more criteria is satisfied (e.g., and the first set of one or more criteria is not satisfied), the computer system outputs (1008), via the one or more audio components, a second tone (e.g., a beep, a continuous tone, a single beep, and/or a harmony) different from the first tone (e.g., the first tone and the second tone have different audio characteristics, the first tone and the second tone have different durations, and/or the first tone and the second tone are output at different volumes), wherein the second set of one or more criteria is different from the first set of one or more criteria. In some embodiments, the first tone and/or the second tone are output until the subject is authenticated. In some embodiments, the first tone and/or the second tone is based on an identity of the subject. In some embodiments, the first tone and/or the second tone are output in a portion of the environment where the subject is detected. In some embodiments, the first tone and/or the second tone are output in a portion of the environment where the subject is not detected. In some embodiments, the first set of one or more criteria and second set of one or more criteria are based on a time of day. In some embodiments, in response to receiving an indication that the subject has entered the environment and in accordance with a determination that the subject is not recognized (e.g., identified), the computer system outputs (e.g., via another computer system external to the computer system) one or more representations of interactions between the subject and the computer system. In some embodiments, in response to receiving the indication that the subject has entered the environment and in accordance with a determination that the subject is recognized, the computer system does not output one or more representations of interactions between the subject and the computer system. In some embodiments, as part of configuring the computer system, the computer system displays a representation of one or more recognized subjects (e.g., identified and/or authenticated subjects) that are within a field of view of one or more cameras of the computer system. In some embodiments, the computer system ceases to display the representation of the one or more recognized subjects based on a determination that the one or more subjects cannot be recognized. In some embodiments, the computer system displays a representation of one or more unrecognized subjects based on a determination that the one or more subjects cannot be recognized. In some embodiments, the representation of the one or more unrecognized subjects is different from the representation of the one or more recognized subjects. In some embodiments, the representation of the one or more unrecognized subjects and/or the representation of the one or more recognized subjects move as subjects are detected as moving within the field of view of the one or more cameras of the computer system. In some embodiments, the computer system ceases display of the representation of the one or more recognized subjects based on a determination that the one or more subjects are not in the field of view of the of the one or more cameras of the computer system.

In some embodiments, the first set of one or more criteria includes a criterion that is satisfied when it is determined that the subject has a first authentication level (e.g., the subject is identified but not authenticated, the subject is identified and authenticated, the subject is not identified and not authenticated). In some embodiments, the second set of one or more criteria includes a criterion that is satisfied when it is determined that the subject has a second authentication level (e.g., the subject is identified but not authenticated, the subject is identified and authenticated, the subject is not identified and not authenticated) different from the first authentication level.

In some embodiments, the first set of one or more criteria includes a criterion that is satisfied when it is determined that an authenticated subject is present in the environment (e.g., currently present and/or present in the environment within a predetermined period of time receiving the indication that the subject has entered the environment). In some embodiments, the second set of one or more criteria includes a criterion that is satisfied when it is determined that an authenticated subject is not present in the environment (e.g., not currently present and/or left the environment within a predetermined period of time receiving the indication that the subject has entered the environment). In some embodiments, the authenticated subject is a resident and/or owner of the environment. In some embodiments, the authenticated subject is an administrator. In some embodiments, a computer system other than the computer system determines whether the subject is present in the environment.

In some embodiments, the first set of one or more criteria includes a criterion that is satisfied when it is determined that the subject has entered a first portion (e.g., living room, bedroom, bathroom, and/or basement) of the environment. In some embodiments, the second set of one or more criteria includes a criterion that is satisfied when it is determined that the subject has entered a second portion (e.g., living room, bedroom, bathroom, and/or basement) of the environment different from the first portion of the environment.

In some embodiments, the first set of one or more criteria includes a criterion that is satisfied when it is determined that the subject is authenticated. In some embodiments, the second set of one or more criteria includes a criterion that is satisfied when it is determined that the subject is not authenticated. In some embodiments, the subject is automatically authenticated. In some embodiments, the subject is manually authenticated. In some embodiments, the computer system authenticates the subject. In some embodiments, a computer system other than the computer system authenticates the subject.

Note that details of the processes described above with respect to process 1000 (e.g., FIG. 10) are also applicable in an analogous manner to other processes described herein. For example, process 1100 optionally includes one or more of the characteristics of the various processes described above with reference to process 1000. For example, the notification to authenticate of process 1100 is sent in conjunction with the output of tone of process 1000. For brevity, these details are not repeated herein.

FIG. 11 is a flow diagram illustrating a process (e.g., process 1100) for sending reminders based on time in accordance with some embodiments. Some operations in process 1100 are, optionally, combined, the orders of some operations are, optionally, changed, and some operations are, optionally, omitted.

As described below, process 1100 provides an intuitive way for sending reminders based on time. Process 1100 reduces the cognitive burden on a user, thereby creating a more efficient human-machine interface. For battery-operated computing devices, enabling a user to interact with such devices faster and more efficiently conserves power and increases the time between battery charges.

In some embodiments, process 1100 is performed at a computer system that is in communication (e.g., wired or wirelessly) with (and/or includes) one or more display components (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

The computer system detects (1102) an identity of a subject (e.g., a user, a person, and/or an animal) in an environment (e.g., a physical or virtual environment). In some embodiments, detecting the identity of the subject includes receiving, from a personal device of the subject, a communication. In some embodiments, detecting the identity of the subject includes detecting that the personal device of the subject is in proximity to and/or within a predefined distance of the computer system. In some embodiments, the communication includes an indication and/or an identification of the identity. In some embodiments, detecting the identity of the subject includes detecting that the personal device of the subject is in proximity to and/or within a predefined distance of the computer system. In some embodiments, the identity of the subject is detected via computer vision using media captured via one or more cameras in communication with and/or included in the computer system. In some embodiments, the identity of the subject is detected via computer vision using media captured via one or more cameras in communication with and/or included in the computer system. In some embodiments, the identity of the subject is detected via analysis of a voice of the subject. In some embodiments, the voice is captured via one or more microphones in communication with and/or included in the computer system. In some embodiments, the identity of the subject is detected via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) in communication with and/or included in the computer system. In some embodiments, the identity of the subject is detected based on a credential (e.g., a PIN, a passcode, a password, and/or a passphrase) being provided by the subject to the computer system. In some embodiments, detecting the identity of the subject includes receiving, from another computer system different from the computer system, an indication of the identity of the subject. In some embodiments, the other computer system is an accessory device, such as a camera, where the camera identifies the identity of the subject.

After (1104) detecting the identity of the subject in the environment, in accordance with a determination that a non-zero period of time (e.g., 5 seconds to 10 minutes) has expired since detecting the identity of the subject in the environment without authenticating the subject, the computer system sends (1106), to a personal device (e.g., a watch, a phone, a tablet, a fitness tracking device, a processor, a head-mounted display (HMD) device, a media device, an electronic device, and/or a personal computing device) of the subject, a notification (e.g., a prompt, a communication, a request, and/or a message) to authenticate the subject. In some embodiments, the subject is authenticated by the computer system separate from detecting the identity of the subject. In some embodiments, the subject is authenticated by two-factor authentication, a first factor of the two-factor authentication including detecting the identity of the subject in the environment. In some embodiments, authenticating the subject includes receiving, from a personal device of the subject, a communication. In some embodiments, authenticating the subject includes detecting that the personal device of the subject is in proximity to and/or within a predefined distance of the computer system. In some embodiments, the communication includes an indication and/or an identification of the identity. In some embodiments, authenticating the subject includes detecting that the personal device of the subject is in proximity to and/or within a predefined distance of the computer system. In some embodiments, the subject is authenticated via computer vision using media captured via one or more cameras in communication with and/or included in the computer system. In some embodiments, the subject is authenticated via computer vision using media captured via one or more cameras in communication with and/or included in the computer system. In some embodiments, the subject is authenticated via analysis of a voice of the subject. In some embodiments, the voice is captured via one or more microphones in communication with and/or included in the computer system. In some embodiments, the subject is authenticated via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) in communication with and/or included in the computer system. In some embodiments, the subject is authenticated based on a credential (e.g., a PIN, a passcode, a password, and/or a passphrase) being provided by the subject to the computer system. In some embodiments, authenticating the subject includes receiving, from another computer system different from the computer system, an indication of the identity of the subject. In some embodiments, the other computer system is an accessory device, such as a camera, where the camera identifies the identity of the subject.

After (1104) detecting the identity of the subject in the environment, in accordance with a determination that the non-zero period of time has not expired since detecting the identity of the subject in the environment without authenticating the subject, the computer system forgoes (1108) sending, to the personal device of the subject, the notification to authenticate the subject. In some embodiments, the computer system displays a notification that the personal device of the subject is being remotely accessed. In some embodiments, the computer system updates display of the notification that the personal device of the subject is being remotely accessed based on a determination that another personal device of the subject is being remotely accessed.

In some embodiments, the computer system is in communication with one or more speakers. In some embodiments, in response to detecting the identity of the subject in the environment and in accordance with a determination that the subject is not authenticated, the computer system outputs, via the one or more speakers, audio. In some embodiments, the audio includes a tone (e.g., a beep, a continuous tone, a single beep, and/or a harmony) and/or one or more words. In some embodiments, the audio is repeated until the subject is authenticated. In some embodiments, the audio is output once and not repeated until the subject is authenticated. In some embodiments, while outputting the audio, the computer system detects whether the subject is authenticated. In some embodiments, in response to detecting whether the subject is authenticated, in accordance with a determination that the subject is authenticated, the computer system ceases output of, via the one or more speakers, the audio. In some embodiments, in response to detecting whether the subject is authenticated, in accordance with a determination that the subject is not authenticated, the computer system maintains output of, via the one or more speakers, the audio.

In some embodiments, the non-zero period of time is a first non-zero period of time. In some embodiments, the computer system is in communication with one or more speakers. In some embodiments, after detecting the identity of the subject in the environment, in accordance with a determination that the subject is not authenticated within a second non-zero period of time (e.g., 5 seconds to 10 minutes), the computer system outputs, via the one or more speakers, audio (e.g., in response to the second non-zero period of time expiring). In some embodiments, the audio includes a tone (e.g., a beep, a continuous tone, a single beep, and/or a harmony) and/or one or more words. In some embodiments, the audio is repeated until the subject is authenticated. In some embodiments, the audio is output once and not repeated until the subject is authenticated. In some embodiments, the second non-zero period of time is the first non-zero period of time. In some embodiments, the second non-zero period of time is different from the first non-zero period of time. In some embodiments, after detecting the identity of the subject in the environment, in accordance with a determination that the subject is authenticated within the second non-zero period of time, the computer system forgoes output of, via the one or more speakers, the audio.

In some embodiments, before sending, to the personal device of the subject, the notification to authenticate the subject, the computer system detects the personal device of the subject in the environment (e.g., when another personal device of the subject is detected in the environment instead of the personal device of the subject, the computer system sends, to the other personal device of the subject, the notification to authenticate the subject). In some embodiments, the personal device of the subject is detected in the environment by the computer system receiving, from the personal device, a communication indicating presence of the personal device of the subject.

In some embodiments, the identity of the subject is detected via the personal device (e.g., the identity of the subject is detected by the personal device being in proximity to and/or within a predefined distance of the computer system). In some embodiments, the identity of the subject is detected by authenticating the subject with the personal device after the subject is detected in the environment. In some embodiments, the subject is authenticated via the personal device via one or more cameras and/or one or more microphones of the personal device. In some embodiments, the subject is authenticated via the personal device by the subject providing a credential (e.g., a PIN, a passcode, a password, and/or a passphrase) to the personal device.

In some embodiments, the identity of the subject is detected via one or more cameras in communication with but separate from the computer system. In some embodiments, the one or more cameras are separate from the personal device of the subject. In some embodiments, the identity of the subject is detected using computer vision and/or some other identity detection technique on the one or more cameras. In some embodiments, the one or more cameras are included in the computer system.

Note that details of the processes described above with respect to process 1100 (e.g., FIG. 11) are also applicable in an analogous manner to other processes described herein. For example, process 1200 optionally includes one or more of the characteristics of the various processes described above with reference to process 1100. For example, the request to authenticate the subject of process 1200 can also be based on if the non-zero period of time has expired in process 1100. For brevity, these details are not repeated herein.

FIG. 12 is a flow diagram illustrating a process (e.g., process 1200) for outputting a request based on subjects in environment in accordance with some embodiments. Some operations in process 1200 are, optionally, combined, the orders of some operations are, optionally, changed, and some operations are, optionally, omitted.

As described below, process 1200 provides an intuitive way for outputting a request based on subjects in environment. Process 1200 reduces the cognitive burden on a user, thereby creating a more efficient human-machine interface. For battery-operated computing devices, enabling a user to interact with such devices faster and more efficiently conserves power and increases the time between battery charges.

In some embodiments, process 1200 is performed at a computer system that is in communication (e.g., wired or wirelessly) with (and/or includes) one or more display components (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

The computer system detects (1202) an identity (e.g., a user, a person, and/or an animal) of a new subject in an environment (e.g., a physical or virtual environment). In some embodiments, detecting the identity of the subject includes receiving, from a personal device of the subject, a communication. In some embodiments, detecting the identity of the subject includes detecting that the personal device of the subject is in proximity to and/or within a predefined distance of the computer system. In some embodiments, the communication includes an indication and/or an identification of the identity. In some embodiments, detecting the identity of the subject includes detecting that the personal device of the subject is in proximity to and/or within a predefined distance of the computer system. In some embodiments, the identity of the subject is detected via computer vision using media captured via one or more cameras in communication with and/or included in the computer system. In some embodiments, the identity of the subject is detected via computer vision using media captured via one or more cameras in communication with and/or included in the computer system. In some embodiments, the identity of the subject is detected via analysis of a voice of the subject. In some embodiments, the voice is captured via one or more microphones in communication with and/or included in the computer system. In some embodiments, the identity of the subject is detected via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) in communication with and/or included in the computer system. In some embodiments, the identity of the subject is detected based on a credential (e.g., a PIN, a passcode, a password, and/or a passphrase) being provided by the subject to the computer system. In some embodiments, detecting the identity of the subject includes receiving, from another computer system different from the computer system, an indication of the identity of the subject. In some embodiments, the other computer system is an accessory device, such as a camera, where the camera identifies the identity of the subject. In some embodiments, the new subject is not detected in the environment before (e.g., immediately before and/or within a predefined period of time before) detecting the identity of the new subject in the environment.

In response to (1204) detecting the identity of the new subject in the environment, in accordance with a determination that an authenticated subject (e.g., a subject that has been or is currently authenticated, such as via a two-factor authentication) is not already in the environment (e.g., while detecting the identity of the new subject in the environment), the computer system outputs (1206) a request to authenticate the new subject. In some embodiments, the two-factor authentication includes a first factor of the two-factor authentication including detecting an identity of the authenticated subject in the environment. In some embodiments, authenticating the authenticated subject includes receiving, from a personal device of the authenticated subject, a communication. In some embodiments, authenticating the authenticated subject includes detecting that the personal device of the authenticated subject is in proximity to and/or within a predefined distance of the computer system. In some embodiments, the communication includes an indication and/or an identification of an identity of the authenticated subject. In some embodiments, authenticating the authenticated subject includes detecting that the personal device of the authenticated subject is in proximity to and/or within a predefined distance of the computer system. In some embodiments, the authenticated subject is authenticated via computer vision using media captured via one or more cameras in communication with and/or included in the computer system. In some embodiments, the authenticated subject is authenticated via computer vision using media captured via one or more cameras in communication with and/or included in the computer system. In some embodiments, the authenticated subject is authenticated via analysis of a voice of the authenticated subject. In some embodiments, the voice is captured via one or more microphones in communication with and/or included in the computer system. In some embodiments, the authenticated subject is authenticated via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) in communication with and/or included in the computer system. In some embodiments, the authenticated subject is authenticated based on a credential (e.g., a PIN, a passcode, a password, and/or a passphrase) being provided by the authenticated subject to the computer system. In some embodiments, authenticating the authenticated subject includes receiving, from another computer system different from the computer system, an indication of an identity of the authenticated subject. In some embodiments, the other computer system is an accessory device, such as a camera, where the camera identifies the identity of the authenticated subject. In some embodiments, outputting the request to authenticate the new subject includes displaying, via one or more display components that are in communication with and/or included in the computer system, a user interface to authenticate the new subject. In some embodiments, outputting the request to authenticate the new subject includes outputting, via one or more speakers that are in communication with and/or included in the computer system, audio including a request to authenticate the new subject. In some embodiments, outputting the request to authenticate the new subject includes sending, to a personal device of the new subject, a request to authenticate the new subject. In some embodiments, outputting the request to authenticate the new subject includes sending, to a personal device of a previously authenticated subject (and/or an administrator of the computer system and/or the environment), a request to authenticate the new subject.

In response to (1204) detecting the identity of the new subject in the environment, in accordance with a determination that an authenticated subject (e.g., a subject that has been or is currently authenticated, such as via a two-factor authentication) is already in the environment (e.g., while detecting the identity of the new subject in the environment), the computer system forgoes (1208) output of the request to authenticate the new subject.

In some embodiments, the computer system is in communication with (and/or includes) one or more speakers. In some embodiments, in response to detecting the identity of the new subject in the environment, in accordance with the determination that an authenticated subject is not already in the environment (e.g., while detecting the identity of the new subject in the environment), the computer system outputs, via the one or more speakers, first audio. In some embodiments, the first audio includes a tone (e.g., a beep, a continuous tone, a single beep, and/or a harmony) and/or one or more words. In some embodiments, the first audio is repeated until the new subject is authenticated. In some embodiments, the first audio is output once and not repeated until the new subject is authenticated. In some embodiments, in response to detecting the identity of the new subject in the environment, in accordance with the determination that an authenticated subject is already in the environment (e.g., while detecting the identity of the new subject in the environment), the computer system outputs, via the one or more speakers, second audio different from the first audio. In some embodiments, the second audio includes a tone (e.g., a beep, a continuous tone, a single beep, and/or a harmony) and/or one or more words. In some embodiments, the second audio is output once and not repeated until the new subject is authenticated.

In some embodiments, the first audio continues to be output until the new subject is authenticated (e.g., unless a non-zero period of time, such as 30 seconds to 10 minutes, elapses). In some embodiments, the non-zero period of time corresponds to a period of time in which an alert corresponding to the new subject is output, such as an alert sent to an administrator of the computer system and/or the environment and/or an alert sent to emergency services (e.g., police, 911, and/or another service for emergency services). In some embodiments, the first audio continues to be output until the new subject is authenticated or the non-zero period of time elapses. In some embodiments, different non-zero periods of time are used depending on whether the new subject is identified or not (e.g., a longer non-zero period of time is used when the new subject identified than when the new subject is not identified). In some embodiments, the second audio is output once and does not continue to be output. In some embodiments, the second audio is output in an area corresponding to a location of the authenticated subject (e.g., and not an area corresponding to a location of the new subject). In some embodiments, the second audio is output in an area corresponding to a location of the new subject.

In some embodiments, the computer system is in communication with (and/or includes) one or more speakers. In some embodiments, in response to detecting the identity of the new subject in the environment, in accordance with a determination that the identity of the new subject is known (e.g., by the computer system) and the determination that an authenticated subject is not already in the environment (e.g., while detecting the identity of the new subject in the environment), the computer system outputs, via the one or more speakers, third audio. In some embodiments, the third audio includes a tone (e.g., a beep, a continuous tone, a single beep, and/or a harmony) and/or one or more words. In some embodiments, the third audio is repeated until the new subject is authenticated. In some embodiments, the third audio is output once and not repeated until the new subject is authenticated. In some embodiments, the third audio is the first audio. In some embodiments, in response to detecting the identity of the new subject in the environment, in accordance with a determination that the identity of the new subject is unknown (e.g., by the computer system) and the determination that an authenticated subject is already in the environment (e.g., while detecting the identity of the new subject in the environment), the computer system outputs, via the one or more speakers, fourth audio different from the third audio. In some embodiments, the fourth audio includes a tone (e.g., a beep, a continuous tone, a single beep, and/or a harmony) and/or one or more words. In some embodiments, the fourth audio is output once and not repeated until the new subject is authenticated.

In some embodiments, the identity of the new subject is detected via one or more cameras in communication with but separate from the computer system. In some embodiments, the one or more cameras are separate from the personal device of the subject. In some embodiments, the identity of the new subject is detected using computer vision and/or some other identity detection technique on the one or more cameras. In some embodiments, the one or more cameras are included in the computer system.

In some embodiments, the identity of the new subject is detected via a personal device of the new subject (e.g., the identity of the new subject is detected by the personal device being in proximity to and/or within a predefined distance of the computer system). In some embodiments, the identity of the new subject is detected by authenticating the new subject with the personal device after the new subject is detected in the environment. In some embodiments, the new subject is authenticated via the personal device via one or more cameras and/or one or more microphones of the personal device. In some embodiments, the new subject is authenticated via the personal device by the new subject providing a credential (e.g., a PIN, a passcode, a password, and/or a passphrase) to the personal device.

Note that details of the processes described above with respect to process 1200 (e.g., FIG. 12) are also applicable in an analogous manner to the processes described herein. For example, process 1000 optionally includes one or more of the characteristics of the various processes described herein with reference to process 1200. For example, receiving the indication the subject has entered the environment of process 1000 can be received before detecting the identity of the new subject in process 1200. For brevity, these details are not repeated herein.

FIGS. 13A-13K illustrate exemplary user interfaces for authenticating subjects in accordance with some embodiments. The user interfaces in these figures are used to illustrate the processes described below, including the processes in FIGS. 14 and 15.

FIGS. 13A-13K are split between a left side and a right side. In the examples illustrated in FIGS. 13A-13K, the left side illustrates computer system 1300 as a tablet. It should be recognized that computer system 1300 can be other types of computer systems such as a smart phone, a smart watch, a laptop, a communal device, a smart speaker, an accessory, a personal gaming system, a desktop computer, a fitness tracking device, and/or a head-mounted display (HMD) device. In some embodiments, computer system 1300 includes and/or is in communication with one or more input devices (e.g., a sensor, a camera, a lidar detector, a motion sensor, an infrared sensor, a touch-sensitive surface, a physical input mechanism, and/or a microphone). In some embodiments, computer system 1300 includes and/or is in communication with one or more output devices (e.g., a display screen, a projector, a touch-sensitive display, a speaker, and/or a movement component). In some embodiments, computer system 1300 includes one or more components and/or features described above in relation to computer system 100 and/or electronic device 200.

In some embodiments, computer system 1300 is an example of a hub device. In such embodiments, the hub device can be a central computer system within home 1304 that connects to, manages, communicates with, and/or facilitates communication between multiple computer systems and/or accessory devices within home 1304 that are included in a logical environment (e.g., as described below).

In some embodiments, a logical environment is a construct defined by software. For example, the logical environment can be defined by a series of settings created across multiple devices to facilitate data flow and device communication. In some embodiments, devices within the logical environment communicate through computer system 1300. For example, in response to detecting an unidentified subject, a camera communicates with computer system 1300. In other embodiments, devices within the logical environment communicate directly without going through computer system 1300. For example, in response to detecting an unidentified subject, a camera communicates with a personal computer system belonging to John. In some embodiments, the logical environment represents the state, capabilities, and/or permissible interactions of devices within and/or associated with the logical environment.

The right side of FIGS. 13A-13K illustrates a top-down schematic view of home 1304 that includes computer system 1300, speaker 1306, speaker 1308, and speaker 1310. In some embodiments, home 1304 is an example of a physical environment that features described below can be implemented within. It should be recognized that other examples of physical environments can be used with techniques described herein, such as a school, an office, a warehouse, a community center, and/or an apartment building. In some embodiments, home 1304 includes a camera that is included in and/or in communication with computer system 1300. In some embodiments, home 1304 includes, more, less, and/or different subjects and/or devices than described herein.

The left side of FIGS. 13A-13K illustrate output of computer system 1300. While FIGS. 13A-13K illustrate computer system 1300 outputting particular content, it should be recognized that such content is merely for explanatory purposes and that such content can be in different forms, at different locations, at different sizes, include different content, and/or that more, fewer, and/or different content can be output in accordance with techniques described herein.

While the examples in FIGS. 13A-13K include computer system 1300 detecting and/or receiving communication of one or more inputs, it should be recognized that such inputs are merely for explanatory purposes and that such inputs can be other types of inputs such as voice inputs detected via one or more microphones, touch inputs detected via one or more touch-sensitive surfaces, and/or gesture inputs detected via one or more cameras.

FIGS. 13A-13E illustrate a scenario where an identified but unauthenticated subject is detected within home 1304. As illustrated in the left side of FIG. 13A, computer system 1300 displays lock screen user interface 1302 including an indication of the current time (“8:34 AM”). As illustrated in the right side of FIG. 13A, subject 1312 (referred to below as “Jane”) is positioned outside the front door of home 1304.

At FIG. 13B, Jane has entered home 1304 and, as illustrated by the positioning of Jane within home 1304, is in the entryway of home 1304. At FIG. 13B, Jane is detected as entering home 1304. In some embodiments, computer system 1300 detects Jane as entering home 1304. For example, one or more cameras and/or one or more microphones included in and/or in communication with computer system 1300 detect that Jane is positioned within home 1304. In some embodiments, the one or more cameras and/or the one or more microphones are external to computer system 1300. In such embodiments, computer system 1300 receives, from the one or more cameras and/or the one or more microphones, an indication that Jane entered home 1304. In some embodiments, Jane is detected as entering home 1304 in response to computer system 1300 receiving a signal from a personal device of Jane. For example, computer system 1300 can detect Jane as entering home 1304 in response to computer system 1300 receiving a signal from a smart phone of Jane.

At FIG. 13B, after Jane is detected as entering home 1304, Jane is identified. In some embodiments, computer system 1300 identifies Jane. In some embodiments, computer system 1300 identifies Jane in conjunction with receiving an image and/or a video of Jane and comparing the image and/or the video of Jane to previously captured images and/or videos of Jane and/or a profile of Jane. In some embodiments, the images and/or the videos are received from a camera within home 1304. In other embodiments, computer system 1300 identifies Jane through biometrics (e.g., voice recognition from previously captured audio samples of Jane and/or a finger or thumbprint previously recorded as belonging to Jane). In some embodiments, computer system 1300 identifies Jane through a recognition of personal belongings of Jane, such as a hat, a purse, a phone case, and/or a backpack. In other embodiments, computer system 1300 identifies Jane through communication with Jane's personal device, such as a smart phone and/or a smart watch. In some embodiments, a computer system external to computer system 1300 identifies Jane. For example, a speaker and/or a microphone external to computer system 1300 identifies Jane through vocal biometrics. In such embodiments, computer system 1300 receives an indication of the identity of Jane from the computer system.

At FIG. 13B, a determination is made that Jane is unable to be authenticated (e.g., Jane's identity is unable to be verified outside of identification). As illustrated in FIG. 13B, based on the determination that Jane is unable to be authenticated, computer system 1300 displays request 1302a, a request for Jane to authenticate herself via PIN (e.g., “Please enter your PIN to confirm your identity”). In some embodiments, computer system 1300 outputs a request for Jane to authenticate herself in a different manner. For example, computer system 1300 can request Jane to authenticate herself through an audio output (e.g., “Hello. Please enter your PIN to confirm your identity”).

In some embodiments, computer system 1300 outputs a request for an unauthenticated subject to authenticate themselves via different methods other than by entering a PIN. For example, computer system 1300 can request that an unauthenticated subject authenticate themselves using a face scan, using voice recognition, through fingerprints, by bringing their personal device up to computer system 1300, and/or by placing a physical credential (e.g., a badge and/or a license) within a field of view of one or more cameras of computer system 1300.

In some embodiments, if Jane does not authenticate herself within a predefined time (e.g., 30 seconds to two minutes) after computer system 1300 displays request 1302a to authenticate, computer system 1300 causes other accessories in home 1304 to perform an operation in order to escalate urgency of the request. For example, computer system 1300 can cause smart lightbulbs within home 1304 to begin flashing to signal to Jane that she has not been authenticated. For another example, computer system 1300 can cause a speaker within home 1304 to output an alarm to signal to Jane that she has not been authenticated. In such embodiments, computer system 1300 causes accessories within home 1304 to perform various operations to communicate to an unauthenticated subject within home 1304 that computer system 1300 is aware of their presence and if they do not authenticate themselves, security measures will be taken.

In some embodiments, if no authenticated subjects are within home 1304 when an identified but unauthenticated subject is detected within or as entering home 1304, computer system 1300 causes a personal device of a resident, the homeowner, and/or an administrator of home 1304 to display a notification that indicates that an unauthenticated subject is detected within home 1304. For example, the notification can read “An unauthenticated subject is in your home.” In some embodiments, the notification includes a user interface element that causes the personal device of the resident, the homeowner, and/or the administrator to initiate a process of authenticating the unauthenticated subject. In other embodiments, the notification includes a user interface element that causes an alarm within home 1304 to activate. In some embodiments, in response to detecting an unauthenticated subject within home 1304, computer system 1300 causes a personal device of every resident and/or administrator of home 1304 to display the notification that indicates that an unauthenticated subject is detected within home 1304.

In some embodiments, if no authenticated subjects are within home 1304 when an unauthenticated subject is detected within home 1304 or entering home 1304, computer system 1300 audibly outputs a request for the unauthenticated subject to authenticate themselves. For example, computer system 1300 can audibly output “Hello, please authenticate yourself” or “Welcome, please enter PIN to authenticate yourself.” For another example, if no authenticated subjects are within home 1304 when an unauthenticated subject is detected within home 1304 or entering home 1304, computer system 1300 can cause a personal device of the unauthenticated subject to output an indication, such as “Please authenticate yourself” or “Enter PIN.”

At FIG. 13B, based on the determination that Jane is not able to be authenticated, computer system 1300 causes speaker 1306 to output tone 1314. Tone 1314 is a specific tone selected to be output when a subject is detected within home 1304 who is identified but not authenticated. In some embodiments, computer system 1300 communicates with speaker 1306 to output a different tone if an authenticated subject is home when Jane is detected as entering home 1304 and/or within home 1304. In some embodiments, computer system 1300 causes speaker 1306 to output tone 1314 to increase the likelihood that Jane proceeds to authenticate herself and/or to alert the homeowner, an administrator, and/or a resident of home 1304 that an unauthenticated subject is present within home 1304. In some embodiments, if Jane is authenticated while speaker 1306 is outputting tone 1314, computer system 1300 causes speaker 1306 to cease output of tone 1314 based on Jane's successful authentication. In some embodiments, computer system 1300 causes the accessories within home 1304 to perform the one or more operations at the same time that computer system 600 causes speaker 1306 to output tone 1314. For example, computer system 1300 can cause smart lightbulbs within home 1304 to begin flashing while speaker 1306 outputs tone 1314 to signal to Jane that she has not been authenticated.

In some embodiments, computer system 1300 causes speaker 1306 to output tone 1314 based on a determination that speaker 1306 is the speaker closest to Jane. In some embodiments, if an authenticated subject is within home 1304 and is positioned closer to speaker 1310 than speaker 1306, computer system 1300 causes speaker 1310 to output tone 1314 (e.g., in addition to speaker 1306 or instead of speaker 1306) to alert the authenticated subject of the presence of an unauthenticated subject within home 1304. In such embodiments, computer system 1300 will not cause speaker 1308 to output tone 1314 (e.g., or any tone).

In some embodiments, based on the detection of an unauthenticated subject in home 1304 and/or entering home 1304, computer system 1300 causes different speakers to output tones differently or different tones based on the part of home 1304 that the speakers are located. For example, computer system 1300 can cause speaker 1306 to output a tone at a loud volume because speaker 1306 is at the entryway of home 1304 and cause speaker 1308 to output a tone at a quiet volume because speaker 1308 is in a nursery of home 1304. In such embodiments, computer system 1300 causes different speakers to output tones differently based on settings and/or preferences of the speakers. For example, computer system 1300 can cause speaker 1308 to output a tone at a quiet volume because John set speaker 1308 to output tones at a quiet volume.

In some embodiments, based on the detection of an unauthenticated subject in and/or entering home 1304, computer system 1300 does not cause certain speakers to output a tone based on the part of home 1304 that the speakers are located in. For example, in response to detecting Jane in the entryway of home 1304, computer system 1300 might not cause speaker 1308 to output a tone because speaker 1308 is not in close proximity to Jane.

In some embodiments, based on the detection of an unauthenticated subject in and/or entering home 1304, computer system 1300 does not cause certain speakers to output a tone based on a context of the environment of the speaker. For example, in response to detecting Jane within home 1304 and based on a determination that a baby is asleep in the room that speaker 1308 is positioned within, computer system 1300 might not cause speaker 1308 to output a tone.

Between FIGS. 13B and 13C, Jane has moved from the entryway of home 1304 to the nursery of home 1304. At FIG. 13C, a determination is made that two minutes have passed since Jane entered home 1304 and Jane is still unauthenticated. At FIG. 13C, based on the determination that that two minutes have passed since Jane entered home 1304 and Jane is still unauthenticated, computer system 1300 causes computer system 1316, a personal device of Jane, to display PIN user interface 1318. As illustrated in FIG. 13C, PIN user interface 1318 includes request 1318a, which is a request for Jane to enter a PIN code (e.g., “Enter PIN to confirm identity”) to authenticate herself. As part of causing computer system 1316 to display PIN user interface 1318, computer system 1300 causes computer system 1316 to output haptic output 1316a to alert Jane to display of request 1318a. In some embodiments, a request included within request 1318a can be a request for Jane to perform a different type of authentication process such as “Please present badge,” “Please face the camera for facial recognition,” and/or “Please enter PIN on hub device.” In some embodiments, at FIG. 13C, because Jane is still unauthenticated, computer system 1300 continues to cause speaker 1306 to output tone 1314.

As illustrated in FIG. 13C, computer system 1316 is a smart watch. In some embodiments, computer system 1316 is a different type of device, such as a smart phone or a tablet. In some embodiments, computer system 1300 causes computer system 1316 to display a request for Jane to authenticate herself after a different amount of time has passed since Jane is detected within home 1304. For example, computer system 1300 can cause computer system 1316 to display a request for Jane to authenticate herself after five minutes have passed since Jane was detected within home 1304. In some embodiments, computer system 1300 causes computer system 1316 to display a request for Jane to authenticate herself because computer system 1316 is detected within home 1304.

In some embodiments, computer system 1316 is detected within home 1304 via a camera within home 1304. In other embodiments, computer system 1316 is detected within home 1304 via a communication between computer system 1316 and computer system 1300. In other embodiments, computer system 1316 is detected within home 1304 based on a determination that computer system 1316 connected to a network (e.g., WiFi, Bluetooth, and/or Thread) corresponding to home 1304.

In some embodiments, computer system 1300 causes computer system 1316 to display a request for Jane to authenticate herself based on a determination that Jane is directing attention to computer system 1316. In some embodiments, computer system 1300 causes computer system 1316 to display a request for Jane to authenticate herself based on a determination that computer system 1316 is the closest computer system to Jane. For example, based on a determination that Jane is wearing computer system 1316, computer system 1300 can cause computer system 1316 to display a request for Jane to authenticate herself as opposed to a smart phone belonging to and/or associated with Jane that is positioned in a different room than Jane.

In some embodiments, if a determination is made that Jane does not authenticate herself within a predefined time (e.g., 30 seconds to two minutes) after computer system 1300 causes computer system 1316 to display a request for Jane to authenticate herself, computer system 1300 causes accessories in home 1304 to perform one or more operations to alert Jane that she needs to authenticate herself as soon as possible. For example, computer system 1300 can cause smart lightbulbs within home 1304 to begin flashing to alert Jane that she needs to authenticate herself as soon as possible. For another example, computer system 1300 can cause a speaker within home 1304 to output an alarm to alert Jane that she needs to authenticate herself as soon as possible.

At FIG. 13D, a determination is made that three minutes have elapsed since Jane entered home 1304 and Jane remains unauthenticated. At FIG. 13D, based on the determination that three minutes have elapsed since Jane entered home 1304 and that Jane remains unauthenticated, computer system 1300 causes speaker 1306 to output tone 1320 as a means of escalating the alert that an unauthenticated subject is present in home 1304. In some embodiments, tone 1320 is a louder, more intense tone, such as an alarm, than tone 1314 to increase the likelihood that Jane is alerted that she needs to authenticate herself. In some embodiments, computer system 1300 causes speaker 1308 to output tone 1320 based on a determination that speaker 1308 is the closest speaker to Jane.

In some embodiments, computer system 1300 causes speaker 1306 to output tone 1320 based on a determination that no PIN (e.g., and/or other authenticating credentials) has been received within a predefined time since computer system 1316 displayed PIN user interface 1318. In other embodiments, computer system 1300 causes speaker 1306 to output tone 1320 based on a determination that no PIN (e.g., and/or other authenticating credentials) has been received within a predefined time since computer system 1300 caused computer system 1316 to output PIN user interface 1318. In some embodiments, computer system 1300 causes speaker 1306 to output tone 1320 based on a determination that speaker 1306 has output tone 1314 for a predetermined period of time (e.g., 60-180 seconds). In some embodiments, computer system 1300 causes all the speakers within home 1304 to output tone 1320 based on determination that Jane has not authenticated herself within a predetermined period of time since being detected within home 1304.

As illustrated in FIG. 13D, computer system 1316 displays keypad 1318b. In some embodiments, computer system 1300 causes computer system 1316 to display keypad 1318b based on a determination that computer system 1316 has displayed PIN user interface 1318 for a predetermined amount of time (e.g., 15-90 seconds). In other embodiments, computer system 1316 displays keypad 1318b in response to detecting an input while computer system 1316 displays PIN user interface 1318. In some embodiments, computer system 1316 displays keypad 1318b in response to detecting computer system 1316 being brought within a predetermined distance of computer system 1300. For example, computer system 1316 can display keypad 1318b in response to detecting computer system 1316 being brought within twelve inches of computer system 1300.

In some embodiments, computer system 1300 causes computer system 1316 to display keypad 1318b based on a determination that a predetermined amount of time has elapsed since Jane was detected within home 1304 and that Jane remains unauthenticated. For example, computer system 1300 can cause computer system 1316 to display keypad 1318b based on a determination that it has been five minutes since Jane was detected as entering home 1304 and remains unauthenticated. In some embodiments, computer system 1316 displays keypad 1318b without computer system 1300 displaying request 1302a for Jane to authenticate herself via PIN.

At FIG. 13D, while displaying keypad 1318b, computer system 1316 detects inputs 1305d1-d4 on PIN buttons 1318b1-b4. Inputs 1305d1-d4 correspond to Jane entering her PIN. It should be recognized that inputs 1305d1-d4 are examples of tap inputs (e.g., selection inputs) but can be other inputs, such as a verbal input or an air gesture directed to computer system 1316. For example, a verbal input of, “My PIN is 1397”. For another example, air gestures directed to PIN buttons 1318b1-b4.

At FIG. 13E, Jane is authenticated based on entry of her PIN. In some embodiments, in response to detecting inputs 1305d1-d4, computer system 1316 authenticates Jane. In such embodiments, after authenticating Jane, computer system 1316 can send computer system 1300 a communication indicating that Jane is authenticated. In some embodiments, in response to detecting inputs 1305d1-d4, computer system 1316 sends an indication to computer system 1300 that computer system 1316 detects entry of Jane's PIN. In such embodiments, computer system 1300 can authenticate Jane in response to receiving the indication. In some embodiments, Jane is authenticated via a different authentication method. For example, computer system 1300 can authenticate Jane in response to computer system 1300 detecting a physical credential (e.g., a badge and/or a license) within a field of view of one or more cameras of computer system 1300. As an additional example, Jane is authenticated using through the biometrics of Jane, such as voice recognition, fingerprint analysis, and/or facial recognition.

At FIG. 13E, a determination is made that Jane is authenticated. As illustrated in FIG. 13E, because Jane is authenticated, computer system 1300 displays lock screen user interface 1302 without request 1302a and computer system 1316 displays ambient screen user interface 1322 (e.g., and ceases display of PIN user interface 1318). At FIG. 13E, because Jane is authenticated, computer system 1300 causes speaker 1306 to cease output of tone 1320.

In some embodiments, based on the authentication of Jane, computer system 1300 displays a notification of authentication of Jane. In other embodiments, based on the authentication of Jane, computer system 1300 causes the personal device of the resident, the homeowner, and/or the administrator to display a notification of the authentication of Jane. In such embodiments, the notification can include one or more indications of an identity of Jane, the time of which Jane was authenticated, and/or the methods used to authenticate Jane. For example, the notification can read “Jane authenticated herself via PIN at 8:38 AM.”

In some embodiments, based on the authentication of Jane, computer system 1300 initiates an automation that is preconfigured to execute upon Jane being detected within home 1304 and being authenticated. For example, based upon Jane being authenticated after entering home 1304, computer system 1300 can cause one or more lights within home 1304 to power on, when such an automation is preconfigured for Jane. In such embodiments, computer system 1300, a personal device of Jane (e.g., such as computer system 1316 and/or Jane's smartphone), and/or a personal device of the resident, the homeowner, and/or the administrator can output a notification of one or more operations in the automation once the automation has been initiated. For example, the notification can read “Jane is home, turning on living room lights.”

FIGS. 13F-13G illustrate an alternate scenario where a subject is authenticated upon entering home 1304. As illustrated in FIG. 13F, subject 1324 (referred to below as “Alphonse”) is outside the front door of home 1304.

At FIG. 13G, Alphonse is detected as entering home 1304. In some embodiments, computer system 1300 detects Alphonse as entering home 1304. For example, one or more cameras and/or one or more microphones included in and/or in communication with computer system 1300 detect that Alphonse is positioned within home 1304. In some embodiments, the one or more cameras and/or the one or more microphones are external to computer system. home 1304In such embodiments, the one or more cameras and/or the one or more microphones are external to computer system 1300. In such embodiments, computer system 1300 receives, from the one or more cameras and/or the one or more microphones, an indication that Alphonse has entered home 1304.

In some embodiments, Alphonse is detected as entering home 1304 in response to computer system 1300 receiving a signal from a personal device of Alphonse. For example, Alphonse is detected as entering home 1304 in response to computer system 1300 receiving a signal from a smart phone of Alphonse.

At FIG. 13G, after Alphonse is detected as entering home 1304, Alphonse is identified and authenticated. In some embodiments, computer system 1300 identifies and/or authenticates Alphonse. In some embodiments, a computer system other than computer system 1300 identifies and/or authenticates Alphonse. For example, a camera external to computer system 1300 can identify and/or authenticate Alphonse.

At FIG. 13G, a determination is made that Alphonse is authenticated after entering home 1304. In some embodiments, computer system 1300 receives an indication that Alphonse is authenticated after entering home 1304 from an external camera. In other embodiments, computer system 1300 receives the indication that Alphonse is authenticated after entering home 1304 from a motion sensor. In other embodiments, computer system 1300 receives the indication that Alphonse is authenticated after entering home 1304 from a smart lock attached to the front door, such as based on Alphonse entering a correct PIN or using a key on their personal phone to unlock the smart lock.

At FIG. 13G, based on the determination that Alphonse is authenticated after entering home 1304, computer system 1300 causes speaker 1306 to output tone 1326. Tone 1326 is a specific tone selected to be output when a subject is both identified and authenticated after being detected within home 1304, compared to tone 1314, which is a tone selected to be output when a subject is identified but not authenticated (or authenticated but not identified) upon being detected within home 1304. In some embodiments, computer system 1300 causes speaker 1306 to output tone 1326 to alert other subjects in home 1304 that an authenticated subject has entered home 1304 through the front door.

FIGS. 13H-13I illustrate an alternate scenario where a subject is authenticated after entering home 1304 through an area of home 1304 other than the entryway. As illustrated at FIG. 13H, Alphonse is outside of a back door of home 1304.

At FIG. 13I, Alphonse is detected entering a kitchen of home 1304. At FIG. 13I, after Alphonse is detected as entering home 1304, Alphonse is identified and authenticated. At FIG. 13I, a determination is made that Alphonse is authenticated after entering the kitchen of home 1304. In some embodiments, computer system 1300 receives an indication that Alphonse is authenticated after entering the kitchen of home 1304 from an external camera. In other embodiments, computer system 1300 receives the indication that Alphonse is authenticated after entering the kitchen of home 1304 from a motion sensor. In other embodiments, computer system 1300 receives the indication of the determination that Alphonse is authenticated after entering the kitchen of home 1304 from a smart lock attached to the back door (e.g., as described above).

At FIG. 13I, based on the determination that Alphonse is authenticated after entering the kitchen of home 1304, computer system 1300 causes speaker 1306 to output tone 1328. In some embodiments, computer system 1300 causes speaker 1306 to output tone 1328 to alert other subjects in home 1304 that an authenticated subject entered the kitchen from the back door. Tone 1328 is a specific tone selected to be output when an authenticated subject is detected as entering home 1304 through the back door and is in the kitchen. The contrast of FIGS. 13I and 13H highlight different tones that computer system 1300 causes speaker 1306 to output based on which area of home an identified and authenticated subject enters. More specifically, when a subject is identified and authenticated after entering home 1304 through the front door, computer system 1300 causes speaker 1306 to output tone 1326. To the contrary, when a subject is identified and authenticated after entering home 1304 through the back door, computer system 1300 causes speaker to output tone 1328. In some embodiments, computer system 1300 causes speaker 1310 to output tone 1328 based on a determination that speaker 1310 is closest to Alphonse in the kitchen.

FIGS. 13J-13K illustrate an alternate scenario where an authenticated subject is detected entering home 1304 in the evening. As illustrated at FIG. 13J, Alphonse is outside of home 1304 by the front door.

At FIG. 13K, Alphonse is detected as entering home 1304. In some embodiments, computer system 1300 detects Alphonse as entering home 1304. For example, one or more cameras and/or one or more microphones included in and/or in communication with computer system 1300 detect that Alphonse is positioned within home 1304. In some embodiments, the one or more cameras and/or the one or more microphones are external to computer system 1300. In such embodiments, computer system 1300 can receive, from the one or more cameras and/or the one or more microphones, an indication that Alphonse has entered home 1304. In some embodiments, Alphonse is detected as entering home 1304 in response to computer system 1300 receiving a signal from a personal device of Alphonse. For example, Alphonse is detected as entering home 1304 in response to computer system 1300 receiving a signal from a smart phone of Alphonse.

At FIG. 13K, after Alphonse is detected as entering home 1304, Alphonse is identified and authenticated. In some embodiments, computer system 1300 identifies and/or authenticates Alphonse. In some embodiments, a computer system other than computer system 1300 identifies and/or authenticates Alphonse. For example, a camera external to computer system 1300 identifies and/or authenticates Alphonse.

At FIG. 13K, a determination is made that Alphonse has entered home 1304 and is authenticated and identified. At FIG. 13K, based on the determination that Alphonse entered home 1304 and is authenticated and identified, computer system 1300 causes speaker 1306 to output tone 1330. Tone 1330 is a specific tone selected to be output when a subject is both identified and authenticated and has entered home 1304 in the evening. The contrast of FIGS. 13G and 13K highlight different tones that computer system 1300 causes speaker 1306 to output based on the time a day a subject is detected as entering home 1304 and is identified and authenticated. More specifically, when a subject is identified and authenticated after entering home 1304 in the morning, computer system 1300 causes speaker 1306 to output tone 1326 (e.g., as illustrated in FIG. 13G). To the contrary, when a subject is identified and authenticated after entering home 1304 in the evening, computer system 1300 causes speaker to output tone 1330. In some embodiments, when Alphonse is detected as entering home 1304 in the middle of the night (e.g., 12:00 AM-5:00 AM), computer system 600 causes speaker 1306 to output a tone different from tone 1326 and tone 1330.

FIG. 14 is a flow diagram illustrating a process (e.g., process 1400) for outputting audio in accordance with some embodiments. Some operations in process 1400 are, optionally, combined, the orders of some operations are, optionally, changed, and some operations are, optionally, omitted.

As described below, process 1400 provides an intuitive way for outputting audio in accordance with some embodiments. Process 1400 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by outputting a tone in response to receiving an indication that a subject has entered an environment) enhances the operability of the device by reducing accidental and mistaken inputs, reducing energy usage by the device. Reducing the number of inputs needed to perform an operation (such as by outputting different tones in response to receiving an indication that a subject has entered an environment) enhances the operability of the device by reducing the number of inputs and time required to perform a particular operation, reducing energy usage by the device. Providing additional control operations without cluttering the user interface with additional display controls (such as by outputting a tone in response to receiving an indication that a subject has entered an environment) enhances the operability of the device by reducing unnecessary inputs and/or steps to navigate through different user interfaces or sets of controls, reducing energy usage by the device. Performing an operation when a set of conditions has been met without requiring further user input (such as by outputting a particular tone based on what set of criteria is satisfied in response to receiving an indication that a subject has entered an environment) enhances the operability of the device by reducing unnecessary inputs and/or steps to navigate through different user interfaces or sets of controls, reducing energy usage by the device.

In some embodiments, process 1400 is performed at a computer system (e.g., 1300) that is in communication (e.g., wired or wirelessly) with (and/or includes) one or more audio components (e.g., a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

The computer system receives (1402) an indication (e.g., as described above with respect to FIGS. 13A-13K) that a subject (e.g., 1312 and/or 1324) has entered (e.g., currently entered or previously entered) an environment (e.g., a home, a room, an office, an environment of the computer system and/or an environment different from the environment of the computer system) (e.g., 1304). In some embodiments, the indication that the subject has entered the environment is received from a computer system that is positioned in the environment. In some embodiments, the indication that the subject has entered the environment is received after the subject is present in the environment for a predetermined period of time (e.g., 5 seconds to 2 minutes).

In response to (1404) receiving the indication that the subject has entered the environment, in accordance with a determination that a first set of one or more criteria is satisfied (e.g., that an authenticated subject is already in the environment, that an identity of the subject is not detected, that the identity of the subject is detected as an unidentified subject, and/or that the subject has been authenticated), the computer system outputs (1406), via the one or more audio components, a first tone (e.g., a beep, a continuous tone, a single beep, and/or a harmony) (e.g., 1314, 1320, 1326, 1328, and/or 1330).

In response to (1404) receiving the indication that the subject has entered the environment, in accordance with a determination that a second set of one or more criteria is satisfied (e.g., and the first set of one or more criteria is not satisfied), the computer system outputs (1408), via the one or more audio components, a second tone (e.g., a beep, a continuous tone, a single beep, and/or a harmony) (e.g., 1314, 1320, 1326, 1328, and/or 1330) different from the first tone (e.g., the first tone and the second tone have different audio characteristics, the first tone and the second tone have different durations, and/or the first tone and the second tone are output at different volumes), wherein the second set of one or more criteria is different from the first set of one or more criteria. In some embodiments, the first tone and/or the second tone are output until the subject is authenticated. In some embodiments, the first tone and/or the second tone are based on an identity of the subject. In some embodiments, the first tone and/or the second tone are output in a portion of the environment where the subject is detected. In some embodiments, the first tone and/or the second tone are output in a portion of the environment where the subject is not detected. In some embodiments, the first set of one or more criteria and second set of one or more criteria are based on a time of day. In some embodiments, in response to receiving an indication that the subject has entered the environment and in accordance with a determination that the subject is not recognized (e.g., identified), the computer system outputs (e.g., via another computer system external to the computer system) one or more representations of interactions between the subject and the computer system. In some embodiments, in response to receiving the indication that the subject has entered the environment and in accordance with a determination that the subject is recognized, the computer system does not output one or more representations of interactions between the subject and the computer system. In some embodiments, as part of configuring the computer system, the computer system displays a representation of one or more recognized subjects (e.g., identified and/or authenticated subjects) that are within a field of view of one or more cameras of the computer system. In some embodiments, the computer system ceases to display the representation of the one or more recognized subjects based on a determination that the one or more subjects cannot be recognized. In some embodiments, the computer system displays a representation of one or more unrecognized subjects based on a determination that the one or more subjects cannot be recognized. In some embodiments, the representation of the one or more unrecognized subjects is different from the representation of the one or more recognized subjects. In some embodiments, the representation of the one or more unrecognized subjects and/or the representation of the one or more recognized subjects move as subjects are detected as moving within the field of view of the one or more cameras of the computer system. In some embodiments, the computer system ceases display of the representation of the one or more recognized subjects based on a determination that the one or more subjects are not in the field of view of the of the one or more cameras of the computer system.

In some embodiments, the first set of one or more criteria includes a criterion that is satisfied when it is determined that the subject has a first authentication level (e.g., the subject is identified but not authenticated, the subject is identified and authenticated, the subject is not identified and not authenticated) (e.g., as described above with respect to FIGS. 13A-13B, 13F-13G, and/or 13J-13K). In some embodiments, the second set of one or more criteria includes a criterion that is satisfied when it is determined that the subject has a second authentication level (e.g., the subject is identified but not authenticated, the subject is identified and authenticated, the subject is not identified and not authenticated) different from the first authentication level (e.g., as described above with respect to FIGS. 13A-13B, 13F-13G, and/or 13J-13K).

In some embodiments, the first set of one or more criteria includes a criterion that is satisfied when it is determined that an authenticated subject is present in the environment (e.g., currently present and/or present in the environment within a predetermined period of time receiving the indication that the subject has entered the environment) (e.g., as described above with respect to FIGS. 13A-13B, 13F-13G, and/or 13J-13K). In some embodiments, the second set of one or more criteria includes a criterion that is satisfied when it is determined that an authenticated subject is not present in the environment (e.g., not currently present and/or left the environment within a predetermined period of time of receiving the indication that the subject has entered the environment) (e.g., as described above with respect to FIGS. 13A-13B, 13F-13G, and/or 13J-13K). In some embodiments, the authenticated subject is a resident and/or owner of the environment. In some embodiments, the authenticated subject is an administrator. In some embodiments, a computer system other than the computer system determines whether the subject is present in the environment.

In some embodiments, the first set of one or more criteria includes a criterion that is satisfied when it is determined that the subject has entered a first portion (e.g., living room, bedroom, bathroom, and/or basement) of the environment (e.g., as described above with respect to FIGS. 13A-13B, 13F-13G, and/or 13J-13K). In some embodiments, the second set of one or more criteria includes a criterion that is satisfied when it is determined that the subject has entered a second portion (e.g., living room, bedroom, bathroom, and/or basement) of the environment different from the first portion of the environment (e.g., as described above with respect to FIGS. 13A-13B, 13F-13G, and/or 13J-13K).

In some embodiments, the first set of one or more criteria includes a criterion that is satisfied when it is determined that the subject is authenticated (e.g., as described above with respect to FIGS. 13A-13B, 13F-13G, and/or 13J-13K). In some embodiments, the second set of one or more criteria includes a criterion that is satisfied when it is determined that the subject is not authenticated (e.g., as described above with respect to FIGS. 13A-13B, 13F-13G, and/or 13J-13K). In some embodiments, the subject is automatically authenticated. In some embodiments, the subject is manually authenticated. In some embodiments, the computer system authenticates the subject. In some embodiments, a computer system other than the computer system authenticates the subject.

In some embodiments, the computer system outputs (e.g., audibly and/or visually) the first tone while the subject is not authenticated (e.g., and/or identified). In some embodiments, while outputting the first tone (or the second tone), the computer system detects (and/or receives an indication) that the subject is authenticated (e.g., as described above with respect to FIGS. 13D-13E). In some embodiments, the computer system authenticates the subject. In some embodiments, another computer system different from the computer system authenticates the subject. In some embodiments, one or more cameras of the computer system and/or external to the computer system authenticate the subject. In some embodiments, the computer system authenticates the subject in response to receiving an indication from a personal computer system of the subject. In some embodiments, in response to detecting that the subject is authenticated, the computer system ceases output of, via the one or more audio components, the first tone (e.g., and/or any tone) (e.g., as described above with respect to FIG. 13E). In some embodiments, in response to detecting that the subject is authenticated, the computer system outputs an indication that the subject is authenticated. In some embodiments, the indication that the subject is authenticated includes a visual component, audible component, and/or the computer system moving itself. In some embodiments, the computer system continuously outputs the first tone or the second tone until the subject is authenticated. In some embodiments, the computer system outputs a request for the subject to authenticate themselves as part of outputting the first tone.

In some embodiments, detecting that the subject is authenticated includes detecting (and/or receiving an indication of) a physical credential (e.g., a badge and/or license) of the subject (e.g., as described above with respect to FIGS. 13A-13B, 13F-13G, and/or 13J-13K). In some embodiments, the computer system detects the physical credential of the subject via one or more cameras of the computer system. In some embodiments, one or more cameras external to the computer system detect the physical credential.

In some embodiments, in accordance with a determination that the subject has entered a first area of the environment (e.g., a bedroom, basement, kitchen, and/or living room), the first tone is output in the first area of the environment (e.g., as described above with respect to FIGS. 13A-13B, 13F-13G, and/or 13J-13K). In some embodiments, in accordance with a determination that the subject has entered a second area of the environment (e.g., a bedroom, basement, kitchen, and/or living room), the first tone is output in the second area of the environment (and not output in the first area of the environment) (e.g., as described above with respect to FIGS. 13A-13B, 13F-13G, and/or 13J-13K), wherein the first area of the environment is different than the second area of the environment. In some embodiments, the computer system outputs the first tone in the first area of the environment without outputting the first tone in the second area of the environment. In some embodiments, the computer system outputs the first tone with different or same audio characteristics (e.g., length, speed, tone, amount of bass, and/or amount of treble) when the computer system outputs the first tone in the first area of the environment than when the computer system outputs the first tone in the second area of the environment. In some embodiments, the computer system outputs the first tone in the second area of the environment after the computer system outputs the first tone in the first area of the environment based on a determination that the subject moves from the first area of the environment to the second area of the environment.

In some embodiments, in accordance with a determination that the subject has entered a first area of the environment (e.g., a bedroom, basement, kitchen, and/or living room), the first tone (or second tone) is output in a second area (and/or not the first area) of the environment (e.g., a bedroom, basement, kitchen, and/or living room) (e.g., as described above with respect to FIGS. 13A-13B, 13F-13G, and/or 13J-13K), wherein the second area of the environment is different from the first area of the environment. In some embodiments, the computer system does not output the first tone in the first area of the environment while the computer system outputs the first tone in the second area of the environment. In some embodiments, the first tone is output in the second area while the subject is not detected in the second area (e.g., the first tone is output in areas where the subject is not detected). In some embodiments, in accordance with a determination that the subject has entered the second area of the environment, the first tone (or second tone) is output in the first area (and/or not the second area) of the environment (e.g., as described above with respect to FIGS. 13A-13B, 13F-13G, and/or 13J-13K). In some embodiments, the computer system outputs the first tone in the first area of the environment without outputting the first tone in the second area of the environment. In some embodiments, the computer system outputs the first tone with different or same audio characteristics (e.g., length, speed, tone, amount of bass, and/or amount of treble) when the computer system outputs the first tone in the first area of the environment than when the computer system outputs the first tone in the second area of the environment. In some embodiments, the computer system outputs the first tone in the second area of the environment after the computer system outputs the first tone in the first area of the environment based on a determination that the subject moves from the first area of the environment to the second area of the environment. In some embodiments, the first tone is output in the first area while the subject is not detected in the first area (e.g., the first tone is output in areas where the subject is not detected).

In some embodiments, in accordance with a determination that an authenticated subject (e.g., an individual who is authenticated and/or identified) is positioned within a first area of the environment (e.g., a bedroom, basement, kitchen, and/or living room), the first tone (e.g., and/or the second tone) is output in the first area of the environment (e.g., as described above with respect to FIGS. 13A-13B, 13F-13G, and/or 13J-13K). In some embodiments, the authenticated subject is authenticated by the computer system. In some embodiments, the authenticated subject is authenticated by another computer system different from the computer system. In some embodiments, the authenticated subject is authenticated with respect to the computer system. In some embodiments, the authenticated subject is authenticated with respect to the environment. In some embodiments, in accordance with a determination that an authenticated subject (or any authenticated subject) is positioned within a second area of the environment (e.g., a bedroom, basement, kitchen, and/or living room), the first tone is output in the second area of the environment (and not the first area of the environment) (e.g., as described above with respect to FIGS. 13A-13B, 13F-13G, and/or 13J-13K), wherein the first area of the environment is different from the second area of the environment. In some embodiments, the computer system outputs the first tone in the first area and the second area of the environment in accordance with a determination that an authenticated subject is positioned within the first area of the environment. In some embodiments, the computer system outputs the first tone in the first area and the second area of the environment in accordance with a determination that an authenticated subject is positioned within the first area of the environment and another authenticated subject is positioned within the second area of the environment. In some embodiments, the computer system outputs the first tone in the first area of the environment without outputting the first tone in the second area of the environment. In some embodiments, the computer system outputs the first tone with different or same audio characteristics (e.g., length, speed, tone, amount of bass, and/or amount of treble) when the computer system outputs the first tone in the first area of the environment than when the computer system outputs the first tone in the second area of the environment. In some embodiments, the computer system outputs the first tone in the second area of the environment after the computer system outputs the first tone in the first area of the environment based on a determination that an authenticated subject moves from the first area of the environment to the second area of the environment.

In some embodiments, in response to receiving the indication that the subject has entered the environment and in accordance with a determination that a third set of one or more criteria is satisfied, wherein the third set of one or more criteria includes a criterion that is satisfied when multiple subjects are detected as entered the environment, the computer system outputs, via the one or more audio components, a third tone different from the first tone and the second tone. In some embodiments, the third tone corresponds to a primary subject of the multiple subjects. In such embodiments, the primary subject can be a subject that first entered the environment, a registered subject (e.g., even when one or more subjects are not registered with the computer system), or an unknown or unregistered subject (e.g., even when one or more subjects are registered with the computer system). In some embodiments, the third tone corresponds to the multiple subjects, such as a specific tone when there are multiple subjects. In some embodiments, the third tone corresponds to the multiple subjects, such as a combination of tones that correspond to different subjects of the multiple subjects.

In some embodiments, in accordance with the determination that an authenticated subject is positioned within the first area (and not the second area of the environment) of the environment, the computer system forgoes output of the first tone (and/or the second tone) in the second area of the environment (e.g., as described above with respect to FIGS. 13A-13B, 13F-13G, and/or 13J-13K). In some embodiments, in accordance with the determination that an authenticated subject is positioned within the second area of the environment, the computer system forgoes output of the first tone in the first area of the environment (e.g., as described above with respect to FIGS. 13A-13B, 13F-13G, and/or 13J-13K). In some embodiments, the computer system outputs the first tone in the first area of the environment and the second area of the environment in accordance with a determination that an authenticated subject is positioned within the first area of the environment and another authenticated subject is positioned within the second area of the environment. In some embodiments, the computer system outputs the first tone in the second area of the environment after the computer system outputs the first tone in the first area of the environment based on a determination that an authenticated subject moves from the first area of the environment to the second area of the environment.

In some embodiments, the computer system is in communication (e.g., wired and/or wireless communication) with (and/or includes) one or more output devices (e.g., a display component, an audio component, and/or a haptic component). In some embodiments, the one or more output devices are integrated into the computer system. In some embodiments, the one or more output devices are external to the computer system. In some embodiments, in response to receiving the indication that the subject has entered the environment, in accordance with a determination that an authenticated subject (e.g., a subject who is identified and/or authenticated) is not present in the environment, the computer system outputs (e.g. audibly and/or visually outputting), via the one or more output devices, a request to provide a credential (e.g., a PIN and/or a passphrase) (e.g., as described above with respect to FIG. 13B). In some embodiments, in response to receiving the indication that the subject has entered the environment, in accordance with a determination that an authenticated subject is present in the environment, the computer system forgoes output of, via the one or more output devices, the request to provide a credential (e.g., as described above with respect to FIGS. 13F-13G). In some embodiments, the request to provide a credential is repeated. In some embodiments, the request to provide a credential is output a single time. In some embodiments, the request to provide a credential is output while the first tone or second tone is output. In some embodiments, the request to provide a credential is output before or after the first tone or second tone. In some embodiments, the authenticated subject is authenticated via the computer system. In some embodiments, the authenticated subject is authenticated via another computer system.

In some embodiments, after (or while and/or in conjunction with) outputting the request to provide a credential, the computer system detects an expiration of a first predetermined period of time (e.g., 1-15 minutes) since the output of the request to provide a credential (e.g., as described above with respect to FIGS. 13B-13C). In some embodiments, in response to detecting the expiration of the first predetermined period of time since the output of the request to provide a credential and in accordance with a determination that the subject is not authenticated, the computer system outputs, via the one or more audio components, a third tone different (e.g., different audible characteristics and/or different duration) from the first tone and the second tone (e.g., as described above with respect to FIGS. 13B-13C). In some embodiments, the third tone is an escalation of the first tone and the second tone. In some embodiments, in response to detecting the expiration of the predetermined period of time since the output of the request to provide a credential and in accordance with a determination that the subject is authenticated, the computer system forgoes output of the third alarm tone or any alarm tone.

In some embodiments, the computer system is in communication (e.g., wireless communication and/or wired communication) with (and/or includes) one or more devices (e.g., television, telephone, speaker, one or more lights, one or more smart blinds, one or more windows, and/or one or more robot vacuums). In some embodiments, after (or while and/or in conjunction with) outputting the request to provide a credential, the computer system detects an expiration of a second predetermined period of time (e.g., 1-15 minutes) since the output of the request to provide a credential (e.g., as described above with respect to FIGS. 13B-13C). In some embodiments, the first predetermined period of time is different from the second predetermined period of time. In some embodiments, the first predetermined period of time is the same as the second predetermined period of time. In some embodiments, in response to detecting the expiration of the second predetermined period of time since the output of the request to provide a credential and in accordance with a determination that the subject is not authenticated, the computer system causes the one or more devices to perform one or more operations (e.g., output audio, power on, flash light, raise and/or lower curtains, change an operating state, change a security state, power off, output an alarm, place a phone call, place a video call, and/or display content) (e.g., as described above with respect to FIGS. 13B-13C). In some embodiments, the computer system causes the one or more devices to perform the one or more operations until the subject authenticates themselves. In some embodiments, the computer system causes the one or more devices to perform the one or more operations for a threshold amount of time. In some embodiments, the computer system ceases causing the devices to perform the one or more operations in response to detecting an input from an authenticated subject while the subject is not authenticated.

In some embodiments, the first tone (or second tone) is output in a first area (e.g., living room, bedroom, bathroom, and/or basement) of the environment. In some embodiments, in response to receiving the indication that the subject has entered the environment and in accordance with the determination that the first set of one or more criteria is satisfied, the computer system outputs, via the one or more audio components, a third tone different from the first tone (e.g., the third tone has different audible characteristic and/or duration than the first tone) in a second area of the environment (e.g., as described above with respect to FIGS. 13B-13D), wherein the first area is different from the second area. In some embodiments, the first tone and the third tone are concurrently output. In some embodiments, the first tone and the third tone are serially output. In some embodiments, the third tone is different from the second tone. In some embodiments, the first tone and the third tone are the same. In some embodiments, the third tone and the first tone are the same.

In some embodiments, in response to receiving the indication that the subject has entered the environment, in accordance with a determination that the subject entered the environment at a first time (e.g., the morning, afternoon, or evening) (and/or that the first set of one or more criteria is satisfied), the computer system outputs, via the one or more audio components, a third tone in an area (e.g., living room, bedroom, bathroom, and/or basement) of the environment (e.g., as described above with respect to FIGS. 13B-13K). In some embodiments, the first set of one or more criteria includes a criterion that is satisfied when the subject entered the environment at the first time. In some embodiments, in response to receiving the indication that the subject has entered the environment, in accordance with a determination that the subject entered the environment at a second time (and/or that the second set of one or more criteria is satisfied), the computer system forgoes output of the third tone in the area of the environment (e.g., as described above with respect to FIGS. 13B-13K), wherein the second time is different from the first time. In some embodiments, the third tone and the first tone are output in the same area of the environment. In some embodiments, the third tone and the first tone are output in different areas of the environment. In some embodiments, the third tone is concurrently output with the first tone or second tone. In some embodiments, the third tone is output by a different audio component than the audio component that outputs the first tone and/or second tone. In some embodiments, the third tone and the first tone (or second tone) are serially output by the same audio component or different audio components. In some embodiments, the third tone and the first tone are the same or different. In some embodiments, the second set of one or more criteria includes a criterion that is satisfied when the subject entered the environment at the second time.

In some embodiments, in response to receiving the indication that the subject has entered the environment, in accordance with a determination that an area (e.g., living room, bedroom, bathroom, and/or basement) of the environment has a first context (e.g., an authenticated subject is present in the area, a non-authenticated subject is present in the area, a subject not is sleeping in the area, and/or there is not an on-going conversation in the area) (and/or that the first set of one or more criteria is satisfied), the computer system outputs, via the one or more audio components, a third tone in the area of the environment (e.g., as described above with respect to FIGS. 13B-13K). In some embodiments, the first set of one or more criteria includes a criterion that is satisfied when the area of the environment has the first context. In some embodiments, in response to receiving the indication that the subject has entered the environment, in accordance with a determination that the area of the environment has a second context (e.g., an authenticated subject is not present in the area, a non-authenticated subject is not present in the area, a subject is sleeping in the area, and/or there is an on-going conversation in the area) different from the first context (and/or that the second set of one or more criteria is satisfied), the computer system forgoes output of the third tone in the area of the environment (e.g., as described above with respect to FIGS. 13B-13K). In some embodiments, the third tone is the same as the first tone or the second tone. In some embodiments, the third tone is different from the first tone and/or second tone. In some embodiments, the third tone is concurrently output with the first tone. In some embodiments, the third tone is serially output with the first tone. In some embodiments, the third tone is output by a different audio component than the audio component that outputs the first tone and/or second tone. In some embodiments, the computer system outputs the third tone in the area of the environment based on a determination that the context in the area changes. In some embodiments, the second set of one or more criteria includes a criterion that is satisfied when the area of the environment has the second context.

In some embodiments, the computer system is in communication (e.g., wired communication and/or wireless communication) with (and/or includes) a personal device (e.g., a cell phone, smartwatch, tablet, and/or head-mounted device) of a registered subject (e.g., a resident of the environment, a subject that is registered with the computer system, and/or a subject that is registered with the environment). In some embodiments, in response to receiving the indication that the subject has entered the environment and in accordance with a determination that the subject is identified (e.g., identified by the computer system, a personal device of the subject, one or more cameras of the computer system and/or one or more cameras external to the computer system) and not authenticated and that an authenticated subject is not present in the environment (and/or that the first set of one or more criteria is satisfied), the computer system causes the personal device of the registered subject to output an identification of the subject (e.g., as described above with respect to FIGS. 13B-13K). In some embodiments, the first set of one or more criteria includes a criterion that is satisfied when (1) the subject is identified and not authenticated and (1) an authenticated subject is not present in the environment. In some embodiments, in response to receiving the indication that the subject has entered the environment and in accordance with a determination that the subject is identified and not authenticated and that an authenticated subject is present in the environment (and/or that the second set of one or more criteria is satisfied), the computer system forgoes causing the personal device of the registered subject to output the identification of the subject. In some embodiments, the second set of one or more criteria includes a criterion that is satisfied when (1) the subject is identified and not authenticated and (2) an authenticated subject is present in the environment. In some embodiments, in response to receiving the indication that the subject has entered the environment and in accordance with a determination that the subject is identified and authenticated and that an authenticated subject is present in the environment (and/or that the second set of one or more criteria is satisfied), the computer system forgoes causing the personal device of the registered subject to output the identification of the subject. In some embodiments, the second set of one or more criteria includes a criterion that is satisfied when (1) the subject is identified and authenticated and (2) an authenticated subject is present in the environment.

In some embodiments, the subject is identified via a personal device (e.g., a cell phone, smart watch, tablet, and/or head mounted device) of the subject (e.g., as described above with respect to FIGS. 13A-13K).

In some embodiments, the subject is identified by one or more cameras (e.g., as described above with respect to FIGS. 13A-13K). In some embodiments, the one or more cameras are in communication with the computer system. In some embodiments, the one or more cameras are integrated into the computer system. In some embodiments, the one or more cameras are external to the computer system. In some embodiments, the computer system receives an indication of the identity of the subject from the one or more cameras.

Note that details of the processes described above with respect to process 1400 (e.g., FIG. 14) are also applicable in an analogous manner to other processes described herein. For example, process 1500 optionally includes one or more of the characteristics of the various processes described above with reference to process 1400. For example, the first audio of process 1400 can be output while sending the notification of process 1500. For brevity, these details are not repeated herein.

FIG. 15 is a flow diagram illustrating a process (e.g., process 1500) for assisting with authentication in accordance with some embodiments. Some operations in process 1500 are, optionally, combined, the orders of some operations are, optionally, changed, and some operations are, optionally, omitted.

As described below, process 1500 provides an intuitive way for assisting with authentication in accordance with some embodiments. Process 1500 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by sending to a personal device of a subject a notification to authenticate the subject after the identity of the subject is detected) enhances the operability of the device by reducing accidental and mistaken inputs, reducing energy usage by the device. Reducing a number of inputs needed to perform an operation (such as by sending to a personal device of a subject a notification to authenticate the subject after the identity of the subject is detected) enhances the operability of the device by reducing the number of inputs and time required to perform a particular operation, reducing energy usage by the device. Providing additional control options without cluttering the user interface with additional displayed controls (such as by sending to a personal device of a subject a notification to authenticate the subject after the identity of the subject is detected) enhances the operability of the device by reducing unnecessary inputs and/or steps to navigate through different user interfaces or sets of controls, reducing energy usage by the device. Performing an operation when a set of conditions has been met without requiring further user input (such as by sending to a personal device of a subject a notification to authenticate the subject when a non-zero period of time has expired since an identity of the subject is detected in the environment without authenticating the subject) enhances the operability of the device by reducing unnecessary inputs and/or steps to navigate through different user interfaces or sets of controls, reducing energy usage by the device.

In some embodiments, process 1500 is performed at a computer system (e.g., 1300) that is in communication (e.g., wired or wirelessly) with (and/or includes) one or more display components (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

The computer system detects (1502) an identity of a subject (e.g., a user, a person, and/or an animal) in an environment (e.g., a physical or virtual environment) (e.g., as described above with respect to FIGS. 13A-13K). In some embodiments, detecting the identity of the subject includes receiving, from a personal device of the subject, a communication. In some embodiments, detecting the identity of the subject includes detecting that the personal device of the subject is in proximity to and/or within a predefined distance of the computer system. In some embodiments, the communication includes an indication and/or an identification of the identity. In some embodiments, detecting the identity of the subject includes detecting that the personal device of the subject is in proximity to and/or within a predefined distance of the computer system. In some embodiments, the identity of the subject is detected via computer vision using media captured via one or more cameras in communication with and/or included in the computer system. In some embodiments, the identity of the subject is detected via computer vision using media captured via one or more cameras in communication with and/or included in the computer system. In some embodiments, the identity of the subject is detected via analysis of a voice of the subject. In some embodiments, the voice is captured via one or more microphones in communication with and/or included in the computer system. In some embodiments, the identity of the subject is detected via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) in communication with and/or included in the computer system. In some embodiments, the identity of the subject is detected based on a credential (e.g., a PIN, a passcode, a password, and/or a passphrase) being provided by the subject to the computer system. In some embodiments, detecting the identity of the subject includes receiving, from another computer system different from the computer system, an indication of the identity of the subject. In some embodiments, the other computer system is an accessory device, such as a camera, where the camera identifies the identity of the subject.

After (1504) detecting the identity of the subject in the environment, in accordance with a determination that a non-zero period of time (e.g., 5 seconds to 10 minutes) has expired since detecting the identity of the subject in the environment without authenticating the subject, the computer system sends (1506), to a personal device (e.g., a watch, a phone, a tablet, a fitness tracking device, a processor, a head-mounted display (HMD) device, a media device, an electronic device, and/or a personal computing device) of the subject, a notification (e.g., a prompt, a communication, a request, and/or a message) (e.g., 1318) to authenticate the subject (e.g., as described above with respect to FIG. 13C). In some embodiments, the subject is authenticated by the computer system separate from detecting the identity of the subject. In some embodiments, the subject is authenticated by two-factor authentication, a first factor of the two-factor authentication including detecting the identity of the subject in the environment. In some embodiments, authenticating the subject includes receiving, from a personal device of the subject, a communication. In some embodiments, authenticating the subject includes detecting that the personal device of the subject is in proximity to and/or within a predefined distance of the computer system. In some embodiments, the communication includes an indication and/or an identification of the identity. In some embodiments, authenticating the subject includes detecting that the personal device of the subject is in proximity to and/or within a predefined distance of the computer system. In some embodiments, the subject is authenticated via computer vision using media captured via one or more cameras in communication with and/or included in the computer system. In some embodiments, the subject is authenticated via computer vision using media captured via one or more cameras in communication with and/or included in the computer system. In some embodiments, the subject is authenticated via analysis of a voice of the subject. In some embodiments, the voice is captured via one or more microphones in communication with and/or included in the computer system. In some embodiments, the subject is authenticated via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) in communication with and/or included in the computer system. In some embodiments, the subject is authenticated based on a credential (e.g., a PIN, a passcode, a password, and/or a passphrase) being provided by the subject to the computer system. In some embodiments, authenticating the subject includes receiving, from another computer system different from the computer system, an indication of the identity of the subject. In some embodiments, the other computer system is an accessory device, such as a camera, where the camera identifies the identity of the subject.

After (1504) detecting the identity of the subject in the environment, in accordance with a determination that the non-zero period of time has not expired since detecting the identity of the subject in the environment without authenticating the subject, the computer system forgoes (1508) sending, to the personal device of the subject, the notification to authenticate the subject (e.g., as described above with respect to FIGS. 13A-13K). In some embodiments, the computer system displays a notification that the personal device of the subject is being remotely accessed. In some embodiments, the computer system updates display of the notification that the personal device of the subject is being remotely accessed based on a determination that another personal device of the subject is being remotely accessed.

In some embodiments, the computer system is in communication with (and/or includes) one or more speakers (e.g., 1306, 1308, and/or 1310). In some embodiments, in response to detecting the identity of the subject in the environment and in accordance with a determination that the subject is not authenticated, the computer system outputs, via the one or more speakers, audio (e.g., 1314, 1320, 1326, 1328, and/or 1330). In some embodiments, the audio includes a tone (e.g., a beep, a continuous tone, a single beep, and/or a harmony) and/or one or more words. In some embodiments, the audio is repeated until the subject is authenticated. In some embodiments, the audio is output once and not repeated until the subject is authenticated. In some embodiments, while outputting the audio, the computer system detects whether the subject is authenticated. In some embodiments, in response to detecting whether the subject is authenticated, in accordance with a determination that the subject is authenticated, the computer system ceases output of, via the one or more speakers, the audio (e.g., as described above with respect to FIG. 13E). In some embodiments, in response to detecting whether the subject is authenticated, in accordance with a determination that the subject is not authenticated, the computer system maintains output of, via the one or more speakers, the audio (e.g., as described above with respect to FIG. 13B-13E).

In some embodiments, the non-zero period of time is a first non-zero period of time. In some embodiments, the computer system is in communication with (and/or includes) one or more speakers (e.g., 1306, 1308, and/or 1310). In some embodiments, after detecting the identity of the subject in the environment, in accordance with a determination that the subject is not authenticated within a second non-zero period of time (e.g., 5 seconds to 10 minutes), the computer system outputs, via the one or more speakers, audio (e.g., in response to the second non-zero period of time expiring) (e.g., as described above with respect to FIGS. 13B-13D). In some embodiments, the audio includes a tone (e.g., a beep, a continuous tone, a single beep, and/or a harmony) and/or one or more words. In some embodiments, the audio is repeated until the subject is authenticated. In some embodiments, the audio is output once and not repeated until the subject is authenticated. In some embodiments, the second non-zero period of time is the first non-zero period of time. In some embodiments, the second non-zero period of time is different from the first non-zero period of time. In some embodiments, after detecting the identity of the subject in the environment, in accordance with a determination that the subject is authenticated within the second non-zero period of time, the computer system forgoes output of, via the one or more speakers, the audio (e.g., as described above with respect to FIGS. 13B-13D).

In some embodiments, before sending, to the personal device of the subject, the notification to authenticate the subject, the computer system detects the personal device of the subject in the environment (e.g., when another personal device of the subject is detected in the environment instead of the personal device of the subject, the computer system sends, to the other personal device of the subject, the notification to authenticate the subject) (e.g., as described above with respect to FIGS. 13B-13D). In some embodiments, the personal device of the subject is detected in the environment by the computer system receiving, from the personal device, a communication indicating presence of the personal device of the subject.

In some embodiments, the identity of the subject is detected via the personal device (e.g., the identity of the subject is detected by the personal device being in proximity to and/or within a predefined distance of the computer system) (e.g., as described above with respect to FIGS. 13A-13H). In some embodiments, the identity of the subject is detected by authenticating the subject with the personal device after the subject is detected in the environment. In some embodiments, the subject is authenticated via the personal device via one or more cameras and/or one or more microphones of the personal device. In some embodiments, the subject is authenticated via the personal device by the subject providing a credential (e.g., a PIN, a passcode, a password, and/or a passphrase) to the personal device.

In some embodiments, the identity of the subject is detected via one or more cameras in communication with but separate from the computer system (e.g., as described above with respect to FIGS. 13A-13H). In some embodiments, the one or more cameras are separate from the personal device of the subject. In some embodiments, the identity of the subject is detected using computer vision and/or some other identity detection technique on the one or more cameras. In some embodiments, the one or more cameras are included in the computer system.

In some embodiments, after sending the notification to authenticate the subject, the computer system detects an expiration of a predetermined period of time (e.g., 5-30 minutes) since sending the notification to authenticate the subject (e.g., as described above with respect to FIGS. 13B-13H). In some embodiments, in response to detecting the expiration of the predetermined period of time since sending the notification to authenticate the subject and in accordance with a determination that the subject is not authenticated, the computer system causes a set of one or more devices (e.g., smart vacuum, blinds, lights, television, thermostat, radio, and/or tablet) to perform one or more operations (e.g., as described above with respect to FIGS. 13B-13H). In some embodiments, in response to detecting the expiration of the predetermined period of time since sending the notification to authenticate the subject and in accordance with a determination that the subject is authenticated, the computer system does not cause the set of one or more devices to perform the one or more operations (e.g., or any operation). In some embodiments, performing an operation of the one or more operations includes moving the set of one or more devices, outputting audible content, outputting flashes of light, and/or changing a power state.

In some embodiments, the personal device of the subject is a respective personal device. In some embodiments, in accordance with a determination that an attention of the subject (e.g., a gaze of the subject, a reference by the subject, a body direction of the subject and/or what the subject is holding) is directed at a first personal device (e.g., a watch, a phone, a tablet, a fitness tracking device, a processor, a head-mounted display (HMD) device, a media device, an electronic device, and/or a personal computing device) when the non-zero period of time expires, the respective personal device is the first personal device (e.g., smart watch, tablet, laptop and/or head-mounted device) (e.g., as described above with respect to FIGS. 13B-13H). In some embodiments, in accordance with a determination that the attention of the subject is directed at a second personal device (e.g., a watch, a phone, a tablet, a fitness tracking device, a processor, a head-mounted display (HMD) device, a media device, an electronic device, and/or a personal computing device) when the non-zero period of time expires, the respective personal device of the subject is the second personal device (e.g., as described above with respect to FIGS. 13B-13H). In some embodiments, the second personal device is different from the first personal device. In some embodiments, the personal device switches from the first personal device to the second personal device based on a determination that the attention of the subject transitions from the first personal device to the second personal device. In some embodiments, the attention of the subject is directed at the first personal device for a predetermined period of time when the respective personal device is the first personal device. In some embodiments, the respective personal device of the subject is a third personal device in accordance with a determination that the attention of the subject has been directed at the third personal device for longer than the first personal device and/or second personal device when the non-zero period of time expires.

In some embodiments, the personal device of the subject is a respective personal device. In some embodiments, in accordance with a determination that the subject is within a predetermined distance (e.g., 0.5-60 inches) of a third personal device (e.g., a watch, a phone, a tablet, a fitness tracking device, a processor, a head-mounted display (HMD) device, a media device, an electronic device, and/or a personal computing device) when the non-zero period of time expires, the respective personal device is the third personal device (e.g., as described above with respect to FIGS. 13B-13H). In some embodiments, in accordance with a determination that the subject is within the predetermined distance of a fourth personal device (e.g., smart watch, tablet, laptop, and/or head-mounted device) when the non-zero period of time expires, the respective personal device of the subject is the fourth personal device (and not the third personal device) (e.g., as described above with respect to FIGS. 13B-13H). In some embodiments, the fourth personal device is different from the third personal device. In some embodiments, the personal device of the subject transitions from being the third personal device to the fourth personal device in accordance with a determination that the subject moves from being within the predetermined distance of the third personal device to being within the predetermined distance of the fourth personal device. In some embodiments, the respective personal device of the subject is the third personal device and the fourth personal device in accordance with a determination that the subject is within the predetermined distance of both the third personal device and the fourth personal device. In some embodiments, the third personal device is the respective personal device in accordance with a determination that the subject is closer to the third personal device than the fourth personal device when the non-zero period of time expires.

In some embodiments, after (e.g., in conjunction and/or while) sending the notification to authenticate the subject to the personal device of the subject, the computer system detects (or receives an indication) that the subject is authenticated (e.g., as described above with respect to FIGS. 13D-13E). In some embodiments, the subject authenticates themselves via the computer system. In some embodiments, the subject is authenticated via one or more cameras that are external to the computer system. In some embodiments, in response to detecting that the subject is authenticated, the computer system causes a set of one or more devices (e.g., air conditioning, smart lock, television, tablet, and/or speaker) to perform one or more predetermined operations (e.g., an automation) (e.g., as described above with respect to FIGS. 13D-13E). In some embodiments, different devices in the set one or more devices perform different types of operations. In some embodiments, different devices in the one or more devices perform the same type of operation. In some embodiments, the one or more predetermined operations are based on a time of day and/or context of an environment. In some embodiments, the one or more predetermined operations are selected by the subject. In some embodiments, the one or more predetermined operations are a default set of one or more operations.

In some embodiments, causing the set of one or more devices to perform the one or more predetermined operations includes causing a display (e.g., via the one or more display components or one or more display components external to the computer system) of one or more indications (e.g., textual indications and/or graphical indications) of the one or more predetermined operations being performed by the set of one or more devices (e.g., as described above with respect to FIGS. 13D-13E). In some embodiments, the computer system displays the one or more indications of the one or more predetermined operations being performed by the set of one or more devices. In some embodiments, the computer system causes a device, external to the computer system, to display the one or more indications of the one or more predetermined operations being performed by the set of one or more devices.

In some embodiments, the computer system is in communication with (and/or includes) one or more output devices (e.g., a display component, an audio component, and/or a haptic component). In some embodiments, after (e.g., or while or in conjunction with) sending the notification to authenticate the subject, the computer system detects (or receives an indication) that the subject is authenticated (e.g., as described above with respect to FIGS. 13D-13E). In some embodiments, the subject authenticates themselves via the computer system. In some embodiments, another computer system authenticates the subject. In some embodiments, in response to detecting that the subject is authenticated, the computer system outputs (or causes output of), via the one or more output devices, an indication that the subject is authenticated (e.g., as described above with respect to FIGS. 13D-13E). In some embodiments, the indication that the subject is authenticated is audibly output and/or visually output. In some embodiments, outputting the indication that the subject is authenticated includes the computer system audibly and/or visually outputting the indication. In some embodiments, outputting the indication that the subject is authenticated includes causing another computer system to audibly and/or visually output the indication.

In some embodiments, the indication that the subject is authenticated includes an indication (e.g., a textual indication and/or a graphical indication) of an identity (e.g., name, image, and/or video) of the subject (e.g., as described above with respect to FIGS. 13D-13E). In some embodiments, the indication of the identity of the subject includes a name of the subject. In some embodiments, the indication of the identity of the subject includes a video and/or image of the subject.

In some embodiments, the indication that the subject is authenticated includes a representation (e.g., textual and/or graphical representation) of a time (e.g., 2:25 μm and/or afternoon) when the subject was authenticated (e.g., as described above with respect to FIGS. 13D-13E). In some embodiments, the indication that the subject is authenticated includes a representation of how the subject was authenticated.

In some embodiments, after sending the notification to authenticate the subject, the computer system detects (or receives an indication) that the subject is authenticated (e.g., as described above with respect to FIGS. 13D-13E). In some embodiments, the subject authenticates themselves via the computer system. In some embodiments, another computer system authenticates the subject. In some embodiments, in response to detecting that the subject is authenticated, the computer system displays, via the one or more display components, an indication (e.g., a graphical indication and/or a textual indication) of the personal device of the subject (e.g., as described above with respect to FIGS. 13D-13E). In some embodiments, the subject authenticates themselves via the personal device of the subject. In some embodiments, the computer system displays the indication of the personal device of the subject for a predetermined period of time. In some embodiments, the computer system ceases display of the indication of the personal device of the subject in response to detecting an input. In some embodiments, the computer system causes another computer system to display the indication of the personal device of the subject in response to detecting that the subject is authenticated.

In some embodiments, the subject is authenticated via a physical credential (e.g., a badge and/or license) (e.g., as described above with respect to FIGS. 13B-13H). In some embodiments, the computer system authenticates the subject in response to detecting the physical credential within a predetermined distance of the computer system. In some embodiments, the computer system authenticates the subject in response to detecting the physical credential within a field of view of one or more cameras of the computer system.

In some embodiments, sending the notification to authenticate the subject includes causing the personal device of the subject to display content (e.g., instructions on how to authenticate and/or a number pad to enter a PIN) related to an authentication process (e.g., as described above with respect to FIG. 13B). In some embodiments, the computer system causes the personal device of the subject to display the content for a predetermined period of time.

Note that details of the processes described above with respect to process 1500 (e.g., FIG. 15) are also applicable in an analogous manner to other processes described herein. For example, process 1400 optionally includes one or more of the characteristics of the various processes described above with reference to process 1500. For example, the subject of process 1500 can be the subject of process 1400. For brevity, these details are not repeated herein.

FIGS. 16A-16I illustrate exemplary user interfaces for authenticating subjects in accordance with some embodiments. The user interfaces in these figures are used to illustrate the processes described below, including the processes in FIG. 17.

FIGS. 16A-16E illustrate a first scenario where an identified but unauthenticated subject is detected within home 1304 while no authenticated subjects are within home 1304. As illustrated in FIG. 16A, computer system 1300 displays lock screen user interface 1302 including an indication of the current time (e.g., 8:36 AM). As illustrated in FIG. 16A, subject 1600 (referred to below as “Michelle”) is positioned outside the front door of home 1304.

In between FIGS. 16A and 16B, Michelle entered home 1304. As illustrated in FIG. 16B, Michelle is positioned within home 1304 and is in the entryway. At FIG. 16B, Michelle is detected within home 1304. In some embodiments, computer system 1300 detects Michelle as entering home 1304. For example, one or more cameras and/or microphones included in and/or in communication with computer system 1300 detect that Michelle is positioned within home 1304. In some embodiments, the one or more cameras and/or the one or more microphones are external to computer system 1300. In such embodiments, computer system 1300 can receive, from the one or more cameras and/or the one or more microphones, an indication that Michelle has entered home 1304.

In some embodiments, Michelle is detected as entering home 1304 in response to computer system 1300 receiving a signal from a personal device of Michelle. For example, Michelle is detected as entering home 1304 in response to computer system 1300 receiving a signal from a smart phone of Michelle. At FIG. 16B, after Michelle is detected within home 1304, Michelle is identified but not authenticated. In some embodiments computer system 1300 identifies Michelle. In some embodiments, a computer system other than computer system 1300 identifies Michelle. For example, a camera external to computer system 1300 can identify Michelle.

In some embodiments, computer system 1300 identifies Michelle in response to receiving an image and/or video of Michelle and comparing the image and/or the video of Michelle to previously captured images and/or videos of Michelle and/or a profile of Michelle. In some embodiments, the images and/or the videos are received from a camera within home 1304. In other embodiments, computer system 1300 identifies Michelle through biometrics (e.g., a voice sample of Michelle and/or fingerprints of Michelle). In some embodiments, computer system 1300 identifies Michelle through recognition of Michelle's personal belongings, such as a hat, a purse, a phone case, and/or a backpack. In other embodiments, computer system 1300 identifies Michelle through communication with Michelle's personal device, such as a smart phone and/or a smart watch.

At FIG. 16B, a determination is made that Michelle is unable to be authenticated (e.g., Michelle's identity is unable to be verified) while an authenticated subject is not present within home 1304. As illustrated in FIG. 16B, based on the determination that that Michelle is unable to be authenticated while an authenticated subject is not present within home 1304, computer system 1300 displays request 1302a, a request for Michelle to authenticate herself via PIN (e.g., “Please enter your PIN to confirm your identity”). In some embodiments, computer system 1300 outputs a request for Michelle to authenticate herself in a different manner. For example, computer system 1300 can request Michelle to authenticate herself through an audio output (e.g., “Hello. Please enter your PIN to confirm your identity”).

In some embodiments, computer system 1300 outputs a request for Michelle to authenticate herself via a different method other than by entering a PIN. For example, computer system 1300 can request that Michelle authenticate herself using a face scan, using voice recognition, through fingerprints, by bringing her personal device near computer system 1300, and/or by placing a physical credential (e.g., a badge and/or a license) within a field of view of one or more cameras of computer system 1300. In some embodiments, if no authenticated subjects are within home 1304 when an identified but unauthenticated subject is detected within home 1304, computer system 1300 causes a personal device of the homeowner and/or administrator of home 1304 to display a notification that indicates that an unauthenticated subject is detected within home 1304. For example, the notification can read “An unauthenticated subject is in your home.” In some embodiments, the notification includes a user interface element that causes the personal device and/or computer system 1300 to initiate a process of authenticating the unauthenticated subject. In other embodiments, the notification includes a user interface element that causes an alarm within home 1304 to activate. In some embodiments, computer system 1300 causes the personal device of every resident of the home to display the notification that indicates that an unauthenticated subject is detected within home 1304.

At FIG. 16B, based on the determination that that Michelle is unable to be authenticated while an authenticated subject is not present in home 1304, computer system 1300 causes speaker 1306 to output tone 1602. Tone 1602 is a specific tone selected to be output when a subject that is identified but not authenticated is detected when there are no authenticated subjects within home 1304. In some embodiments, if Michelle does not authenticate herself within a predefined time after computer system 1300 displays request 1302a (e.g., 30 seconds to two minutes), computer system 1300 outputs a different request to increase the likelihood that Michelle authenticates herself. For example, the different request can be a tone different than (e.g., louder than, different melody and/or different duration) tone 1602. For another example, the different request can be a spoken audio output (e.g., “You must authenticate yourself or security measures will be taken”). For another example, the different request can be computer system 1300 causing one or more accessories in home 1304 to perform one or more operations (e.g., causing smart lightbulbs to flash, an alarm to sound, and/or curtains to open).

At FIG. 16C, Michelle remains unauthenticated after tone 1602 has been output for a minute. At FIG. 16C, because Michelle remains unauthenticated after tone 1602 has been output for a minute, computer system 1300 causes speaker 1306 to output audio content 1606 (e.g., “Please enter PIN to confirm your identity”). That is, when an unauthenticated subject is detected in home 1304 and/or entering home 1304 while an unauthenticated subject is not in home 1304, computer system 1300 will cause one or more speakers in home 1304 to output audio content 1606 after causing one or more speakers to output tone 1602 for a predetermined period of time. In some embodiments, computer system 1300 causes one or more speakers in home 1304 to output tone 1602 and audio content 1606 in a repeating serial manner. In some embodiments, computer system 1300 causes speaker 1306 to suspend the output of tone 1602 to output audio content 1606. Additionally, at FIG. 16C, because Michelle remains unauthenticated, computer system 1300 continues to cause speaker 1306 to output tone 1602.

At FIG. 16C, Michelle positions herself in front of computer system 1300. At FIG. 16C, determination is made that Michelle is positioned in front of (e.g., within a predefined distance away from) computer system 1300. In some embodiments, computer system 1300 determines that Michelle is positioned in front of computer system 1300. In some embodiments, computer system 1300 determines that Michelle is positioned in front of computer system 1300 in response to receiving images from a camera connected to and/or in communication with computer system 1300. In other embodiments, computer system 1300 determines that Michelle is positioned in front of computer system 1300 in response to receiving communication from a personal device corresponding to Michelle, such as a smart phone, a tablet, and/or a smart watch.

As illustrated in FIG. 16C, based on the determination that Michelle is positioned in front of computer system 1300, computer system 1300 displays PIN user interface 1604, which includes request 1302a and keypad 1604a for Michelle to enter her PIN. In some embodiments, computer system 1300 automatically displays PIN user interface 1604 after computer system 1300 has displayed request 1302a for a predetermined period of time. In other embodiments, computer system 1300 displays PIN user interface 1604 based on a determination that Michelle directs her attention to computer system 1300 for a predefined amount of time, such as the amount of time to read request 1302a. In some embodiments, computer system 1300 displays PIN user interface 1604 in response to detecting an input while computer system 1300 displays request 1302a. In some embodiments, computer system 1300 displays PIN user interface 1604 in response to receiving a communication indicating that Michelle has entered home 1304 (e.g., in FIG. 16B). In some embodiments, as part of displaying PIN user interface 1604, computer system 1300 animates request 1302a as scrolling up to make room for keypad 1604a.

At FIG. 16D, Michelle remains unauthenticated. Because Michelle remains unauthenticated, computer system 1300 continues to cause speaker 1306 to output tone 1602. At FIG. 16D, computer system 1300 detects inputs 1605d1-d4 on PIN buttons 1604a1-a4. Inputs 1605d1-d4 correspond to Michelle entering her PIN. It should be recognized that inputs 1605d1-d4 are examples of tap inputs (e.g., selection inputs) but can be other inputs, such as a verbal input or an air gesture directed at computer system 1300. For example, a verbal input of, “My PIN is 3907.” For another example, air gestures directed to PIN buttons 1604a1-a4. In some embodiments, based on a determination that Michelle remains unauthenticated after a predetermined period of time has elapsed since computer system 1300 initially displays PIN user interface 1604 (e.g., 30 seconds to two minutes), computer system 1300 ceases display of PIN user interface 1604.

At FIG. 16E, in response to detecting inputs 1605d1-d4, computer system 1300 authenticates Michelle. At FIG. 16E, as part of authenticating Michelle, computer system 1300 displays lock screen user interface 1302 without request 1302a and ceases display of PIN user interface 1604. In some embodiments, computer system 1300 authenticates Michelle via a different authentication process. For example, computer system 1300 can authenticate Michelle in response to detecting a physical credential, such as a badge or license, of Michelle. For another example, computer system 1300 can use one or more biometrics, such as voice, fingerprint, and/or face, of Michelle to authenticate Michelle. For another example, computer system 1300 can authenticate Michelle in response to receiving a signal from a personal device of Michelle (e.g., computer system 1300 is able to authenticate Michelle in response to receiving data related to a profile of Michelle from a personal device of Michelle). At FIG. 16E, in response to authenticating Michelle, computer system 1300 causes speaker 1306 to cease output of tone 1314.

In some embodiments, while detecting inputs 1605d1-d4, computer system 1300 causes the personal device of the resident, the homeowner, and/or the administrator to display a notification indicating a status of the authentication of Michelle. For example, the notification can read “Michelle is authenticating herself via PIN.” For another example, when computer system 1300 authenticates Michelle in response to detecting a badge of Michelle, the notification can read, “Michelle is authenticating herself using a badge.”

In some embodiments, based on a determination that Michelle is authenticated, computer system 1300 causes the personal device of the resident, the homeowner, and/or the administrator to display a notification of the successful authentication of Michelle. For example, the notification can read, “Michelle successfully authenticated herself at home.” In such embodiments, the notification can include a representation of an identity of the authenticated subject, the time at which the authenticated subject was authenticated, and/or the methods used for authenticating the subject. For example, the notification can read “Michelle authenticated herself via PIN at 8:38 AM.”

FIGS. 16F-16G illustrate a second scenario where an identified but unauthenticated subject is detected within home 1304 while an authenticated subject is also within home 1304. As illustrated in FIG. 16F, Michelle is outside the front door of home 1304 and Alphonse, a subject whose identity was previously authenticated, is within home 1304.

In between FIGS. 16F and 16G, Michelle entered home 1304. As illustrated in FIG. 16G, Michelle is positioned within home 1304 and is in the entryway. At FIG. 16G, Michelle is detected within home 1304. In some embodiments, computer system 1300 detects Michelle as entering home 1304. For example, one or more cameras and/or microphones included in and/or in communication with computer system 1300 detect that Michelle is positioned within home 1304. In some embodiments, the one or more cameras and/or the one or more microphones are external to computer system 1300. In such embodiments, computer system 1300 can receive, from the one or more cameras and/or the one or more microphones, an indication that Michelle has entered home 1304. In some embodiments, Michelle is detected as entering home 1304 in response to computer system 1300 receiving a signal from a personal device of Michelle. For example, Michelle can be detected as entering home 1304 in response to computer system 1300 receiving a signal from a smart phone of Michelle.

At FIG. 16G, after Michelle is detected within home 1304, Michelle is identified but not authenticated. In some embodiments, computer system 1300 receives a communication that Michelle has entered the home and is in the entryway. In some embodiments, computer system 1300 receives communication that Michelle has entered the home and is in the entryway from an accessory, such as a camera and/or a motion sensor. In other embodiments, computer system 1300 detects that Michelle has entered the home and is in the entryway.

At FIG. 16G, a determination is made that Michelle is not authenticated while an authenticated subject is present in home 1304. In some embodiments computer system 1300 identifies Michelle. In some embodiments, a computer system other than computer system 1300 identifies Michelle. For example, a camera external to computer system 1300 can identify Michelle.

At FIG. 16G, based on the determination that that Michelle is not authenticated while an authenticated subject is present in home 1304, computer system 1300 causes speaker 1306 to output tone 1608. Tone 1608 is a specific tone selected to be output when a subject that is identified but not authenticated is detected within home 1304 and/or entering home when an authenticated subject is within home 1304. That is, computer system 1300 causes speaker 1306 to output different tones when an unauthenticated subject is detected within home 1304 and an authenticated subject is positioned within home 1304 versus when an authenticated subject is not positioned within home 1304. More specifically, computer system 1300 causes speaker 1306 to output tone 1602 (e.g., as described above with respect to FIGS. 16B-16D) when an unauthenticated subject is detected within home 1304 and an authenticated subject is not detected within home 1304. To the contrary, computer system 1300 causes speaker 1306 to output tone 1608 when an unauthenticated subject is detected within home 1304 and an authenticated subject is detected within home 1304. Tone 1608 has different audible characteristics than tone 1602. For example, tone 1608 can be a soft chime to gently and unobtrusively notify an authenticated subject that an unauthenticated subject is detected within home 1304 while tone 1602 can be a strong chime. For another example, tone 1602 can be a rapid beeping tone to intently notify the unauthenticated that they are detected and need to be authenticated while tone 1608 can be a slow beeping tone. In some embodiments, computer system 1300 causes speaker 1306 to output a different audio output from tone 1208 if an unauthenticated subject is detected within home 1304 while an authenticated subject is detected within home 1304. For example, computer system 1300 can cause speaker 1306 to output “Alphonse, Michelle is home,” and/or “Alphonse, Michelle needs to be authenticated.”

At FIG. 16G, computer system 1300 does not display a request for Michelle to authenticate herself (e.g., such as those illustrated in FIGS. 13B-13C and 16B) based on the determination that an authenticated person, Alphonse, is within home 1304 when Michelle is detected within home 1304. In some embodiments, when an unauthenticated person is detected within home 1304 and/or entering home 1304 while an authenticated subject is detected within home 1304, computer system 1300 does not cause the personal device of the homeowner and/or administrator of home 1304 to display the notification that indicates that an unauthenticated subject is detected within home 1304.

FIGS. 16H-16I illustrate a third scenario where a subject who is unable to be identified or authenticated is detected within home 1304 while no authenticated subjects are detected within home 1304. As illustrated in FIG. 16H, computer system 1300 displays lock screen user interface 1302 including an indication of the current time (e.g., 2:37 PM). As illustrated in FIG. 16H, subject 1610 (referred to below as “Bobby”) is outside the front door of home 1304.

At FIG. 16I, Bobby enters home 1304 and, as illustrated in FIG. 16I, is positioned in the entryway of home 1304. At FIG. 16I, Bobby is not able to be identified. In some embodiments, computer system 1300 is unable to identify Bobby because Bobby is unknown to computer system 1300 (e.g., Bobby has never been within home 1304, Bobby has never interacted with computer system 1300, and/or Bobby is not registered with computer system 1300). In some embodiments, computer system 1300 is unable to be identified because one or more biometrics of Bobby cannot be detected. For example, Bobby is wearing a scarf or a large hat covering his face. In some embodiments, a computer system other than computer system 1300 is unable to identify Bobby for any of the various reasons explained above.

At FIG. 16I, a determination is made that Bobby cannot be identified. As illustrated in FIG. 16I, based on the determination that the Bobby cannot be identified, computer system 1300 displays request 1614. Request 1614 is a request for Bobby to identify (and/or authenticate) himself using his PIN (e.g., “You are unrecognized” and “Please enter your PIN to confirm your identity”).

Also at FIG. 16I, based on the determination that Bobby cannot be identified, computer system 1300 causes speaker 1306 to output tone 1612. Tone 1612 is a specific tone selected to be output when an unidentified subject is detected within home 1304. That is, computer system 1300 causes speaker 1306 to output a particular tone (e.g., tone 1612) when a subject who is not identified is detected within home 1304 and computer system 1300 causes speaker 1306 to output different tones (e.g., 1608 or 1602) when an identified but unauthenticated subject is detected within home 1304. In some embodiments, computer system 1300 causes speaker 1306 to output tone 1612 to alert the homeowner, the administrator, and/or the resident of home 1304 that an unidentified subject is within home 1304. In some embodiments, computer system 1300 causes speaker 1306 to output tone 1612 based on the determination that an unidentified subject is detected within home 1304 irrespective of whether an authenticated subject is detected within home 1304. In some embodiments, computer system 1300 causes speaker 1306 to output a tone different from tone 1612 based on the determination that an unidentified subject and an authenticated subject are detected within home 1304.

FIG. 17 is a flow diagram illustrating a process (e.g., process 1700) for outputting a request to authenticate in accordance with some embodiments. Some operations in process 1700 are, optionally, combined, the orders of some operations are, optionally, changed, and some operations are, optionally, omitted.

As described below, process 1700 provides an intuitive way for outputting a request to authenticate in accordance with some embodiments. Process 1700 reduces the cognitive burden on a user, thereby creating a more efficient human-machine interface. For battery-operated computing devices, enabling a user to interact with such devices faster and more efficiently conserves power and increases the time between battery charges.

The devices, methods, and/or computer-readable storage mediums described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. Providing improved feedback (such as by outputting a request to authenticate a new subject in response to detecting the identity of the new subject in the environment) enhances operability of the device by reducing accidental and mistaken inputs, reducing energy usage by the device. Reducing the number of inputs needed to perform an operation (such as by outputting a request to authenticate a new subject in response to detecting the identity of the new subject in the environment) enhances the operability of the device by reducing the number of inputs and time required to perform a particular operation, reducing energy usage by the device. Providing additional control options without cluttering the user interface with additional displayed controls (such as by outputting a request to authenticate a new subject in response to detecting the identity of the new subject in the environment) enhances the operability of the device by reducing unnecessary inputs and/or steps to navigate through different user interfaces or sets of controls, reducing energy usage by the device. Performing an operation when a set of conditions has been met without requiring further user input (such as by outputting a request to authenticate a new subject in response to detecting the identity of the new subject in the environment and when an authenticated subject is not already in the environment), enhances the operability of the device by reducing unnecessary inputs and/or steps to navigate through different user interfaces or sets of controls, reducing energy usage by the device.

In some embodiments, process 1700 is performed at a computer system (e.g., 1300) that is in communication (e.g., wired or wirelessly) with (and/or includes) one or more display components (e.g., a display screen, a projector, a head mounted display, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is a resident device (e.g., a device that is installed within a location and/or is part of a connected network at the location, a device that is actively connected to a network at the location and/or consistently part of a network at the location, an always-on device at the location, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device).

The computer system detects (1702) an identity (e.g., a user, a person, and/or an animal) of a new subject in an environment (e.g., a physical or virtual environment) (e.g., as described above with respect to FIGS. 16A-16I). In some embodiments, detecting the identity of the subject includes receiving, from a personal device of the subject, a communication. In some embodiments, detecting the identity of the subject includes detecting that the personal device of the subject is in proximity to and/or within a predefined distance of the computer system. In some embodiments, the communication includes an indication and/or an identification of the identity. In some embodiments, detecting the identity of the subject includes detecting that the personal device of the subject is in proximity to and/or within a predefined distance of the computer system. In some embodiments, the identity of the subject is detected via computer vision using media captured via one or more cameras in communication with and/or included in the computer system. In some embodiments, the identity of the subject is detected via computer vision using media captured via one or more cameras in communication with and/or included in the computer system. In some embodiments, the identity of the subject is detected via analysis of a voice of the subject. In some embodiments, the voice is captured via one or more microphones in communication with and/or included in the computer system. In some embodiments, the identity of the subject is detected via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) in communication with and/or included in the computer system. In some embodiments, the identity of the subject is detected based on a credential (e.g., a PIN, a passcode, a password, and/or a passphrase) being provided by the subject to the computer system. In some embodiments, detecting the identity of the subject includes receiving, from another computer system different from the computer system, an indication of the identity of the subject. In some embodiments, the other computer system is an accessory device, such as a camera, where the camera identifies the identity of the subject. In some embodiments, the new subject is not detected in the environment before (e.g., immediately before and/or within a predefined period of time before) detecting the identity of the new subject in the environment.

In response to (1704) detecting the identity of the new subject in the environment, in accordance with a determination that an authenticated subject (e.g., a subject that has been or is currently authenticated, such as via a two-factor authentication) is not already in the environment (e.g., while detecting the identity of the new subject in the environment), the computer system outputs (1706) a request (e.g., 1302a and/or 1614) to authenticate the new subject (e.g., as described above with respect to FIGS. 16B and/or 16I). In some embodiments, the two-factor authentication includes a first factor of the two-factor authentication including detecting an identity of the authenticated subject in the environment. In some embodiments, authenticating the authenticated subject includes receiving, from a personal device of the authenticated subject, a communication. In some embodiments, authenticating the authenticated subject includes detecting that the personal device of the authenticated subject is in proximity to and/or within a predefined distance of the computer system. In some embodiments, the communication includes an indication and/or an identification of an identity of the authenticated subject. In some embodiments, authenticating the authenticated subject includes detecting that the personal device of the authenticated subject is in proximity to and/or within a predefined distance of the computer system. In some embodiments, the authenticated subject is authenticated via computer vision using media captured via one or more cameras in communication with and/or included in the computer system. In some embodiments, the authenticated subject is authenticated via computer vision using media captured via one or more cameras in communication with and/or included in the computer system. In some embodiments, the authenticated subject is authenticated via analysis of a voice of the authenticated subject. In some embodiments, the voice is captured via one or more microphones in communication with and/or included in the computer system. In some embodiments, the authenticated subject is authenticated via one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) in communication with and/or included in the computer system. In some embodiments, the authenticated subject is authenticated based on a credential (e.g., a PIN, a passcode, a password, and/or a passphrase) being provided by the authenticated subject to the computer system. In some embodiments, authenticating the authenticated subject includes receiving, from another computer system different from the computer system, an indication of an identity of the authenticated subject. In some embodiments, the other computer system is an accessory device, such as a camera, where the camera identifies the identity of the authenticated subject. In some embodiments, outputting the request to authenticate the new subject includes displaying, via one or more display components that are in communication with and/or included in the computer system, a user interface to authenticate the new subject. In some embodiments, outputting the request to authenticate the new subject includes outputting, via one or more speakers that are in communication with and/or included in the computer system, audio including a request to authenticate the new subject. In some embodiments, outputting the request to authenticate the new subject includes sending, to a personal device of the new subject, a request to authenticate the new subject. In some embodiments, outputting the request to authenticate the new subject includes sending, to a personal device of a previously authenticated subject (and/or an administrator of the computer system and/or the environment), a request to authenticate the new subject.

In response to (1704) detecting the identity of the new subject in the environment, in accordance with a determination that an authenticated subject (e.g., a subject that has been or is currently authenticated, such as via a two-factor authentication) is already in the environment (e.g., while detecting the identity of the new subject in the environment), the computer system forgoes (1708) output of the request to authenticate the new subject (e.g., as described above with respect to FIGS. 16B-16I).

In some embodiments, the computer system is in communication with (and/or includes) one or more audio components (e.g., a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output). In some embodiments, in response to detecting the identity of the new subject in the environment, in accordance with the determination that an authenticated subject is not already in the environment (e.g., while detecting the identity of the new subject in the environment), the computer system outputs, via the one or more audio components, first audio while the request to authenticate is output (e.g., as described above with respect to FIGS. 16B-16I). In some embodiments, the first audio includes a tone (e.g., a beep, a continuous tone, a single beep, and/or a harmony) and/or one or more words. In some embodiments, the first audio is repeated until the new subject is authenticated. In some embodiments, the first audio is output once and not repeated until the new subject is authenticated. In some embodiments, in response to detecting the identity of the new subject in the environment, in accordance with the determination that an authenticated subject is already in the environment (e.g., while detecting the identity of the new subject in the environment), the computer system outputs, via the one or more speakers, second audio different from the first audio (e.g., as described above with respect to FIGS. 16B-16I). In some embodiments, the second audio includes a tone (e.g., a beep, a continuous tone, a single beep, and/or a harmony) and/or one or more words. In some embodiments, the second audio is output once and not repeated until the new subject is authenticated.

In some embodiments, the first audio continues to be output until the new subject is authenticated (e.g., unless a non-zero period of time, such as 30 seconds to 10 minutes, elapses) (e.g., as described above with respect to FIGS. 16B-16I). In some embodiments, the non-zero period of time corresponds to a period of time in which an alert corresponding to the new subject is output, such as an alert sent to an administrator of the computer system and/or the environment and/or an alert sent to emergency services (e.g., police, 911, and/or another service for emergency services). In some embodiments, the first audio continues to be output until the new subject is authenticated or the non-zero period of time elapses. In some embodiments, different non-zero periods of time are used depending on whether the new subject is identified or not (e.g., a longer non-zero period of time is used when the new subject identified than when the new subject is not identified). In some embodiments, the second audio is output once and does not continue to be output. In some embodiments, the second audio is output in an area corresponding to a location of the authenticated subject (e.g., and not an area corresponding to a location of the new subject). In some embodiments, the second audio is output in an area corresponding to a location of the new subject.

In some embodiments, the computer system is in communication with (and/or includes) one or more speakers (e.g., 1306, 1308, and/or 1310). In some embodiments, in response to detecting the identity of the new subject in the environment, in accordance with a determination that the identity of the new subject is known (e.g., by the computer system) and the determination that an authenticated subject is not already in the environment (e.g., while detecting the identity of the new subject in the environment), the computer system outputs, via the one or more speakers, third audio (e.g., as described above with respect to FIGS. 16B-16I). In some embodiments, the third audio includes a tone (e.g., a beep, a continuous tone, a single beep, and/or a harmony) and/or one or more words. In some embodiments, the third audio is repeated until the new subject is authenticated. In some embodiments, the third audio is output once and not repeated until the new subject is authenticated. In some embodiments, the third audio is the first audio. In some embodiments, in response to detecting the identity of the new subject in the environment, in accordance with a determination that the identity of the new subject is unknown (e.g., by the computer system) and the determination that an authenticated subject is already in the environment (e.g., while detecting the identity of the new subject in the environment), the computer system outputs, via the one or more speakers, fourth audio different from the third audio (e.g., as described above with respect to FIGS. 16B-16I). In some embodiments, the fourth audio includes a tone (e.g., a beep, a continuous tone, a single beep, and/or a harmony) and/or one or more words. In some embodiments, the fourth audio is output once and not repeated until the new subject is authenticated.

In some embodiments, the identity of the new subject is detected via one or more cameras in communication with but separate from the computer system (e.g., as described above with respect to FIGS. 16A-16I). In some embodiments, the one or more cameras are separate from the personal device of the subject. In some embodiments, the identity of the new subject is detected using computer vision and/or some other identity detection technique on the one or more cameras. In some embodiments, the one or more cameras are included in the computer system.

In some embodiments, the identity of the new subject is detected via a personal device of the new subject (e.g., the identity of the new subject is detected by the personal device being in proximity to and/or within a predefined distance of the computer system) (e.g., as described above with respect to FIGS. 16A-16I). In some embodiments, the identity of the new subject is detected by authenticating the new subject with the personal device after the new subject is detected in the environment. In some embodiments, the new subject is authenticated via the personal device via one or more cameras and/or one or more microphones of the personal device. In some embodiments, the new subject is authenticated via the personal device by the new subject providing a credential (e.g., a PIN, a passcode, a password, and/or a passphrase) to the personal device.

In some embodiments, the request to authenticate the new subject includes a request for the new subject to enter a personal identification number (PIN) (or a pass-phrase) (e.g., as described above with respect to FIGS. 16B-16C). In some embodiments, the computer system previously assigned the personal identification number to the new subject. In some embodiments, the new subject selects the personal identification number.

In some embodiments, the request to authenticate the new subject includes a request to bring a personal device (e.g., a smartwatch, smartphone, smart ring and/or tablet) of the new subject within a predetermined distance (e.g., 0.5-12 inches) of the computer system (e.g., as described above with respect to FIGS. 16B-16I). In some embodiments, the computer system authenticates the new subject in response to detecting the personal device within the predetermined distance of the computer system. In some embodiments, the computer system authenticates the new subject in response to detecting that the personal device of the new subject is within the predetermined distance of the computer system for a predetermined period of time. In some embodiments, another computer system different from the computer system authenticates the subject based on a determination that the personal device of the subject is within the predetermined distance of the computer system.

In some embodiments, in response to detecting the identity of the new subject and in accordance with the determination that the authenticated subject is not already in the environment, the computer system sends a notification to a personal device (e.g., smartphone, smartwatch, tablet, and/or head mounted device) of a registered subject (e.g., a subject who is registered with the computer system and/or a subject who is registered with the environment) (e.g., as described above with respect to FIGS. 16B-16I). In some embodiments, sending the notification to the personal device of the registered subject includes causing the personal device of the registered subject to display content related to the identity of the new subject. In some embodiments, sending the notification to the personal device of the registered subject includes causing the personal device of the registered subject to display content related to the identity of the new subject for a predetermined period of time.

In some embodiments, in response to detecting the identity of the new subject and in accordance with the determination that the authenticated subject is already in the environment, the computer system forgoes sending the notification to the personal device of the registered subject (e.g., as described above with respect to FIGS. 16B-16I). In some embodiments, the computer system sends the notification to the personal device of the registered subject in response to detecting the identity of the new subject and in accordance with the determination that the authenticated subject is already in the environment.

In some embodiments, after (or while or in conjunction with) outputting the request to authenticate the new subject, the computer system detects (or receives an indication) that the new subject is authenticated. In some embodiments, in response to detecting that the new subject is authenticated, the computer system sends an indication to a personal device of a registered subject (e.g., a subject who is registered with the computer system and/or a subject who is registered with an environment of the computer system) that the new subject is authenticated (e.g., as described above with respect to FIGS. 16B-16I). In some embodiments, sending the indication to the personal device of the registered subject causes the personal device of the registered subject to display content related to the identity of the new subject and/or content related to the manner in which the new subject authenticated themselves.

In some embodiments, the request to authenticate the new subject is output in at least a first modality (e.g., displayed and/or audible) and a second modality (e.g., displayed and/or audible) (e.g., as described above with respect to FIGS. 16B-16I). In some embodiments, the first modality is different from the second modality. In some embodiments, the request to authenticate the new subject is output in a single modality. In some embodiments, the request to authenticate the new subject is concurrently output in the first modality and the second modality. In some embodiments, the request to authenticate the new subject is output in the second modality after the request to authenticate the new subject is output in the first modality.

In some embodiments, while outputting the request to authenticate the new subject, the computer system detects an expiration of a first predetermined period of time (e.g., 1-30 minutes) since the request to authenticate the new subject was output (e.g., initially output) (e.g., as described above with respect to FIGS. 16B-16I). In some embodiments, the request to authenticate the new subject is looped. In some embodiments, the first predetermined period of time is dependent on the context present in the environment. In some embodiments, the first predetermined period of time is dependent on the identity of the new subject. In some embodiments, in response to detecting the expiration of the first predetermined period of time since the request to authenticate the new subject was output and in accordance with a determination that the new subject is not authenticated (e.g., remains unauthenticated and/or has not authenticated themselves), the computer system ceases output of the request to authenticate the new subject (e.g., as described above with respect to FIGS. 16B-16I). In some embodiments, the computer system continues to output the request to authenticate the new subject in response to detecting the expiration of the first predetermined period of time since the request to authenticate the new subject was output and in accordance with a determination that the new subject is not authenticated. In some embodiments, the computer system ceases to output the request to authenticate the new subject in response to detecting that the new subject is authenticated. In some embodiments, the computer system ceases to output the request to authenticate the new subject in response to detecting that the new subject is not in the environment.

In some embodiments, the request to authenticate the new subject is a first request to authenticate the new subject. In some embodiments, after (or while) outputting the first request to authenticate the new subject, the computer system detects (or receives an indication of) an expiration of a second predetermined period of time (e.g., 1-30 minutes) since the first request to authenticate the new subject was output (e.g., as described above with respect to FIGS. 16B-16I). In some embodiments, the second predetermined period of time is dependent on the context present in the environment. In some embodiments, the second predetermined period of time is dependent on the identity of the new subject. In some embodiments, in response to detecting the expiration of the second predetermined period of time since the first request to authenticate the new subject was output and in accordance with a determination that the new subject is not authenticated (e.g., remains unauthenticated and/or has not authenticated themselves), the computer system outputs a second request to authenticate the new subject (e.g., as described above with respect to FIGS. 16B-16I), wherein the first request to authenticate the new subject is different (e.g., different audio characteristics and/or different duration) from the second request to authenticate the new subject. In some embodiments, the second request is an escalation of the first request (e.g., the volume of the second request is louder than the volume of the first request or the intensity of the second request is greater than the intensity of the first request). In some embodiments, different audio components output the first request and the second request. In some embodiments, the same audio component outputs the first request and the second request. In some embodiments, in response to detecting the expiration of the second predetermined period of time since the first request to authenticate the new subject was output and in accordance with a determination that the new subject is authenticated, the computer system does not output the second request to authenticate the new subject.

In some embodiments, after (e.g., while and/or in conjunction with) outputting the request to authenticate the new subject, the computer system detects (and/or receives) (e.g., via one or more input devices of the computer system) one or more credentials (e.g., data corresponding to an image of the face of the new subject, a PIN code of the new subject, a passcode of the new subject, and/or a physical credential of the new subject) of the new subject (e.g., as described above with respect to FIGS. 16D-16E). In some embodiments, in response to detecting the one or more credentials of the new subject, the computer system authenticates the new subject (e.g., as described above with respect to FIGS. 16D-16E). In some embodiments, another computer system different from the computer system authenticates the new subject.

In some embodiments, while (or after or before) detecting the one or more credentials of the new subject, the computer system causes a personal device of a registered subject (e.g., registered with the environment and/or registered with the computer system) to output (e.g., visually and/or audibly output) an indication (e.g., a textual indication and/or graphical indication) that corresponds to (e.g., directed to, related to, and/or associated with) one or more actions of the new subject (e.g., the new subject is entering a PIN code, the new subject is positioning themselves for a face scan, and/or the new subject is placing a personal device in close proximity to the computer system) (e.g., as described above with respect to FIGS. 16B-16I).

In some embodiments, after (or before or while) outputting the request to authenticate the new subject, the computer system detects a physical credential (e.g., a badge and/or license) of the new subject (e.g., as described above with respect to FIGS. 16B-16I). In some embodiments, the computer system detects the physical credential via one or more cameras of the computer system. In some embodiments, the computer system detects the physical credential in response to receiving a signal (e.g. a RFID signal and/or a different near-field communication signal) from the physical credential. In some embodiments, in response to detecting the physical credential of the new subject, the computer system authenticates the new subject (e.g., as described above with respect to FIGS. 16B-16I). In some embodiments, the computer system receives an indication that another computer system different from the computer system authenticates the new subject using a physical credential.

Note that details of the processes described above with respect to process 1700 (e.g., FIG. 17) are also applicable in an analogous manner to the processes described herein. For example, process 1400 optionally includes one or more of the characteristics of the various processes described herein with reference to process 1700. For example, the request of process 1700 can be output while sending the first audio of process 1400 is output. For brevity, these details are not repeated herein.

The description above, has been described with reference to specific examples for the purpose of explanation. Such specific examples can be in the form of textual description above and/or in the accompanying drawings. However, such embodiments should not be interpreted as being exhaustive and/or limiting to the disclosure (e.g., limiting to the explicit manners described herein). Many modifications and variations are possible in view of the above teachings by one of ordinary skill in the art without departing from the scope of the present disclosure.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

Aspects of the technology described above can include gathering and/or using data from various sources. Such data can be used to improve interactions that a device has with its environment (e.g., interactions with users). In some scenarios, such data can include personal information that is usable to uniquely identify a specific person. Such personal information can include demographic data, telephone numbers, email addresses, location and/or location-related data, home addresses, work addresses, and/or any other identifying information. The use of such personal information can be utilized for the benefit of users of the device. For example, a user's personal information can be used to improve interactions that the device engages in with the user. Other benefits from the use for personal information data are also possible and within the scope of the present disclosure.

The use of personal information can require one or more entities handling such data. These entities can be involved in collecting, processing, disclosing, transferring, storing, or other functions that support the technologies described herein. The present disclosure expects that (e.g., does not preclude) that all use of personal information data complies with well-established privacy policies and/or privacy practices by such entities. As a general matter, such policies and practices should meet or exceed generally recognized industry standards and comply with all applicable data privacy and security-related governmental requirements. In particular, for example, entities should receive informed consent from users to collect and/or use such personal information, and such collection and/or use should only be for legitimate and reasonable uses. Further, personal information of a user should not be shared, disclosed, sold, and/or provided for uses other than legitimate and/or reasonable uses.

Various scenarios can arise in which personal information is not available, such as when a user selects not to share such information. For example, the user can withhold consent for collection and/or use of such data (e.g., “opt out” of sharing such data and/or not explicitly “opt in” during a registration process). The user can also employ the use of any of various hardware and/or software components that prevent collection and/or use of such data. While the use of personal information can benefit a user by improving the operation of the device, the present disclosure contemplates that embodiments of the present technology can be used without such data. For example, operations of the device can use non-personal information (e.g., instead of and/or in place of personal information). Other techniques include making inferences based on non-personal information data or a minimal amount of personal information.

What is claimed is:

1. A method, comprising:
at a computer system that is in communication with one or more output devices:
detecting an identity of a subject; and
in response to detecting the identity of the subject:
in accordance with a determination that the subject is not automatically authenticated:
outputting, via the one or more output devices, an indication corresponding to the identity of the subject; and
outputting, via the one or more output devices, a request to authenticate the subject; and
in accordance with a determination that that the subject is automatically authenticated, outputting, via the one or more output devices, an identification of the identity of the subject without outputting the request to authenticate the subject.

2. The method of claim 1, wherein outputting the request to authenticate the subject includes transmitting a request to a personal computer system of a subject that is registered with the computer system.

3. The method of claim 1, wherein outputting the request to authenticate the subject includes transmitting a request to a personal computer system of the subject.

4. The method of claim 1, wherein the computer system corresponds to a location, and wherein outputting the request to authenticate the subject includes transmitting a request to an accessory device that corresponds to the location.

5. The method of claim 1, wherein the computer system is in communication with one or more display components, wherein outputting the request to authenticate the subject includes displaying, via the one or more display components, an authentication user interface.

6. The method of claim 1, wherein outputting the request to authenticate the subject includes requesting, via the one or more output devices, that the subject speak.

7. The method of claim 1, wherein outputting the corresponding to the identity of the subject includes outputting, via the one or more output devices, audio content corresponding to the identity of the subject.

8. The method of claim 1, wherein the computer system is in communication with one or more display components, and wherein outputting the indication corresponding to the identity of the subject includes displaying, via the one or more display components, a user interface object.

9. The method of claim 1, wherein, in accordance with the determination that the subject is not automatically authenticated, the indication corresponding to the identity of the subject includes an indication that the subject is not authenticated.

10. The method of claim 1, further comprising:
in response to detecting the identity of the subject and in accordance with the determination that the subject is automatically authenticated, outputting, via the one or more output devices, a confirmation that the subject is automatically authenticated, wherein the confirmation that the subject is automatically authenticated and the identification of the identity of the subject are concurrently output.

11. The method of claim 1, wherein the computer system is in communication with one or more display components, the method further comprising:
in response to detecting the identity of the subject and in accordance with the determination the subject is not automatically authenticated, displaying, via the one or more display components, a set of one or more controls, wherein the set of one or more controls are displayed while the indication corresponding to the identity of the subject is output.

12. The method of claim 1, wherein the determination that the subject is automatically authenticated is made based on a verification that a personal computer system of the subject is positioned within a predetermined threshold distance of the computer system.

13. The method of claim 12, wherein the verification that the personal computer system of the subject is positioned within the predetermined threshold distance of the computer system is made within a predetermined amount time after the subject is detected.

14. The method of claim 1, wherein the determination that the subject is automatically authenticated is made based on receipt of a credential corresponding to the subject within a predetermined threshold of time of detecting the identity of the subject.

15. The method of claim 1, wherein the identity of the subject is detected in response to the subject being detected at a predefined location in an environment.

16. The method of claim 1, further comprising:
before detecting the identity of the subject, detecting a presence of the subject in an environment.

17. The method of claim 1, wherein the subject is a first subject, the method further comprising:
while detecting the identity of the first subject, detecting a second subject and a third subject without detecting identities of the second subject and the third subject.

18. The method of claim 1, wherein the identity of the subject is detected in response to the computer system receiving an indication of the identity of the subject from another computer system external to the computer system.

19. A non-transitory computer-readable storage medium storing one or more programs configured to be executed by one or more processors of a computer system that is in communication with one or more output devices, the one or more programs including instructions for:
detecting an identity of a subject; and
in response to detecting the identity of the subject:
in accordance with a determination that the subject is not automatically authenticated:
outputting, via the one or more output devices, an indication corresponding to the identity of the subject; and
outputting, via the one or more output devices, a request to authenticate the subject; and
in accordance with a determination that that the subject is automatically authenticated, outputting, via the one or more output devices, an identification of the identity of the subject without outputting the request to authenticate the subject.

20. A computer system configured to communicate with one or more output devices, the computer system comprising:
one or more processors; and
memory storing one or more programs configured to be executed by the one or more processors, the one or more programs including instructions for:
detecting an identity of a subject; and
in response to detecting the identity of the subject:
in accordance with a determination that the subject is not automatically authenticated:
outputting, via the one or more output devices, an indication corresponding to the identity of the subject; and
outputting, via the one or more output devices, a request to authenticate the subject; and
in accordance with a determination that that the subject is automatically authenticated, outputting, via the one or more output devices, an identification of the identity of the subject without outputting the request to authenticate the subject.
